(19) United States
(12) Patent Application Publication
(10) Pub. No.: US 2012/0191476 A1
(43) Pub. Date: Jul. 26, 2012

(54) SYSTEMS AND METHODS FOR COLLECTION, ORGANIZATION AND DISPLAY OF EMS INFORMATION

(76) Inventors: C. Shane REID, Denver, CO (US); Eric A. DEINES, Broomfield, CO (US); Charles DOWNING, Centennial, CO (US); Gary A. FREEMAN, Newton Center, MA (US); Richard A. HELKOWSKI, Redwood City, CA (US); Thomas E. KAIB, North Huntingdon, PA (US); Jeffrey R. RESNICK, Foster City, CA (US); Shane S. VOLPE, Saltsburg, PA (US)

(21) Appl. No.: 13/355,314

(22) Filed: Jan. 20, 2012

Related U.S. Application Data
(60) Provisional application No. 61/434,808, filed on Jan. 20, 2011.
(60) Provisional application No. 61/553,794, filed on Oct. 31, 2011.

(51) Int. Cl. G06Q 50/24

(52) U.S. Cl. 705/3

(57) ABSTRACT

A system for collecting and displaying emergency medical services information according to embodiments of the present invention includes a patient monitoring device configured to monitor a patient, a navigation device, a patient charting device, a database, a display device, and a processor communicably coupled to the defibrillator, the navigation device, the patient charting device, the database, and the display device. According to embodiments of the present invention, the processor is configured to receive emergency medical services information from the defibrillator device, the navigation device, and the patient charting device, store the emergency medical services information in the database, and display the emergency medical services information on the display device according to an information template. According to some embodiments, aggregated data feeds from one or more such processors are stored in a remote server and available to remote enterprise users via a secure web interface.

### CROSS-REFERENCE TO RELATED APPLICATIONS

This application claims the benefit of U.S. Provisional Patent Application Ser. No. 61/434,808, filed on Jan. 20, 2011, and of U.S. Provisional Patent Application Ser. No. 61/553,794, filed on Oct. 31, 2011, both of which are incorporated herein by reference in their entireties for all purposes.

### TECHNICAL FIELD

Embodiments of the present invention relate generally to emergency medical services information management, and more particularly to collection, organization, and display of information gathered from multiple different kinds of devices used in emergency medical services.

### BACKGROUND

When an ambulance or other emergency medical services (“EMS”) vehicle is dispatched to a medical emergency, the ambulance driver as well as the EMS technician typically rely on an array of devices in helping them locate, diagnose, treat, transport, chart information about, and deliver the patient. Although such devices typically facilitate particular aspects of the EMS experience, the manual interaction time for each device and the shifting of attention from device to device can in some cases increase transport time and/or shift valuable time away from patient care or can fail to give the crew a complete picture.

Sending certain data-intensive information from an ambulance to a hospital or other care provider often involves manually faxing or e-mailing such data between telephony devices. For example, an EMS technician attempting to convey 12-lead data from a defibrillator must often verbally describe her own assessment of the data, or spend the time e-mailing or faxing a snapshot of the 12-lead data to the hospital. This may delay patient care and/or result in the time-consuming transmission of a patient snapshot that may already be several minutes old by the time it reaches the hospital. In fact, transmission of information between an EMS technician in the back of an ambulance and a hospital emergency room (“ER”) nurse often involves a mobile phone “patch” or call during which the EMS technician attempts to verbally convey the patient's status and treatment, and the vehicle location, while manually sorting through various data sources including the patient's chart, the defibrillator visual data, and/or the ambulance location data (e.g. looking out the window). This often results in inefficient and sometimes inaccurate communication between the EMS technician and the hospital.

### SUMMARY

A system for collecting and displaying emergency medical services information according to some embodiments of the present invention includes an information system located in an emergency response vehicle, the information system comprising at least one display device, at least one processor, and at least one database, wherein the information system is configured to maintain an encounter record for a particular patient transported by the emergency response vehicle; a bar code scanner communicably coupled to the information system; wherein the processor is configured to receive bar code information from the bar code scanner, and update the encounter record based on the bar code information.

The system of paragraph [005], wherein the bar code information is driver's license bar code information from a driver's license of the patient, and wherein the processor is configured to update the encounter record with an identification of the patient based on the driver's license bar code information.

The system of paragraphs [005] or [006], wherein the bar code information is crew identification bar code information, and wherein the processor is configured to update the encounter record with an identification of a crew member based on the crew identification bar code information.

The system of any of paragraphs [005] to [007], wherein information system is further configured to maintain an active crew list for the emergency response vehicle, wherein the bar code information is crew identification bar code information, and wherein the processor is further configured to update the active crew list by adding a new crew member to the active crew list based on the crew identification bar code information.

The system of any of paragraphs [005] to [008], wherein the processor is further configured to set the new crew member as the currently active crew member for future interventions recorded by the information system for the encounter record.

The system of any of paragraphs [005] to [009], wherein the bar code information is medication identification bar code information, and wherein the processor is configured to update the encounter record with an identification of a medication based on the crew identification bar code information.

The system of any of paragraphs [005] to [010], wherein the information system is further configured to maintain a medication inventory record, and wherein the processor is further configured to update the medication inventory record based on the medication identification bar code information.

The system of any of paragraphs [005] to [011], wherein the bar code information is intervention identification bar code information, and wherein the processor is configured to update the encounter record with an identification of an intervention based on the intervention identification bar code information.

The system of any of paragraphs [005] to [012], wherein the bar code scanner is a two-dimensional bar code scanner.

The system of any of paragraphs [005] to [013], wherein the bar code scanner is configured to capture and transmit to the processor an image of a signature on a document, and wherein the processor is further configured to add the image of the signature to the encounter record.

The system of any of paragraphs [005] to [014], wherein the processor is further configured to add an identification of the document to the encounter record along with the image of the signature that is associated with the document.

The system of any of paragraphs [005] to [015], wherein the bar code scanner is configured to capture and transmit to the processor an image of an insurance card of a patient, and wherein the processor is further configured to add the image of the insurance card of the patient to the encounter record.

The system of any of paragraphs [005] to [016], wherein some or all of the encounter record is stored on a stationary server remote from the emergency response vehicle.

A method for collecting and displaying emergency medical services information according to some embodiments of the present invention includes mounting an information system in an emergency response vehicle, the information system comprising at least one display device, at least one processor, and at least one database; maintaining an encounter record for a particular patient transported by the emergency response vehicle; communicably coupling a bar code scanner to the information system; receiving bar code information from the bar code scanner; and updating the encounter record based on the bar code information.

The method of paragraph [018], wherein the bar code information is driver's license bar code information from a driver's license of the patient, and wherein updating the encounter record comprises updating the encounter record with an identification of the patient based on the driver's license bar code information.

The method of paragraphs [018] or [019], wherein the bar code information is crew identification bar code information, and wherein updating the encounter record comprises updating the encounter record with an identification of a crew member based on the crew identification bar code information.

The method of any of paragraphs [018] to [020], further comprising maintaining an active crew list for the emergency response vehicle, wherein the bar code information is crew identification bar code information, the method further comprising updating the active crew list by adding a new crew member to the active crew list based on the crew identification bar code information.

The method of any of paragraphs [018] to [021], further comprising setting the new crew member as the currently active crew member for future interventions recorded by the information system for the encounter record.

The method of any of paragraphs [018] to [022], wherein the bar code information is medication identification bar code information, and wherein updating the encounter record comprises updating the encounter record with an identification of a medication based on the crew identification bar code information.

The method of any of paragraphs [018] to [023], further comprising maintaining a medication inventory record, the method further comprising updating the medication inventory record based on the medication identification bar code information.

The method of any of paragraphs [018] to [024], wherein the bar code information is intervention identification bar code information, and updating the encounter record comprises updating the encounter record with an identification of an intervention based on the intervention identification bar code information.

The method of any of paragraphs [018] to [025], wherein the bar code scanner is a two-dimensional bar code scanner.

The method of any of paragraphs [018] to [026], further comprising capturing and transmitting to the processor an image of a signature on a document, and wherein updating the encounter record comprises adding the image of the signature to the encounter record.

The method of any of paragraphs [018] to [027], further comprising adding an identification of the document to the encounter record along with the image of the signature that is associated with the document.

The method of any of paragraphs [018] to [028], further comprising capturing and transmitting to the processor an image of an insurance card of a patient, and wherein updating the encounter record comprises adding the image of the insurance card of the patient to the encounter record.

The method of any of paragraphs [018] to [029], further comprising storing some or all of the encounter record on a stationary server remote from the emergency response vehicle.

A system for collecting and displaying emergency medical services information according to some embodiments of the present invention includes an information system located in an emergency response vehicle, the information system comprising at least one display device, at least one processor, and at least one database, wherein the information system is configured to maintain an active crew list for a particular emergency response vehicle; an identification reader communicably coupled to the information system, wherein the identification reader is configured to automatically sense the presence of a crew identification device; wherein the processor is configured to receive crew identification information from the identification reader in the presence of the crew identification device, and automatically update the active crew list based on the crew identification information.

The system of paragraph [031], wherein the identification reader is an RFID reader.

The system of paragraphs [031] or [032], further comprising an RFID tag worn by a potential crew member, wherein the RFID tag is the crew identification device.

The system of any of paragraphs [031] to [033], wherein the processor is further configured to prompt a user for confirmation to proceed with automatically updating the active crew list based on the crew identification information.

A system for collecting and displaying emergency medical services information according to embodiments of the present invention includes an information system located in an emergency response vehicle, the information system comprising at least one display device, at least one processor, and at least one database, wherein the information system is configured to maintain an encounter record for an encounter with a particular patient transported by the emergency response vehicle, a wearable cardioverter defibrillator (WCD) communicably coupled to the information system, the WCD worn by the particular patient before the encounter, wherein the processor is configured to receive patient information from the WCD, and update the encounter record based on the patient information.

The system of paragraph [035], wherein the patient information is patient identification information, and wherein the processor is configured to update the encounter record with an identification of the patient based on the patient identification information.

The system of any of paragraphs [035] to [036], wherein the patient information is patient medical history information, and wherein the processor is configured to update the encounter record with the patient medical history information.

The system of any one of paragraphs [035] to [037], wherein the patient information is a patient historical electrocardiogram, and wherein the processor is configured to update the encounter record with the patient historical electrocardiogram.

The system of any one of paragraphs [035] to [038], wherein the processor is further configured to display on the at least one display device the patient historical electrocardiogram.

The system of any one of paragraphs [035] to [039], wherein the patient historical electrocardiogram is a first patient historical electrocardiogram, wherein a non-wearable defibrillator is communicably coupled to the information system, wherein the processor is configured to receive a second patient historical electrocardiogram taken during the encounter from the non-wearable defibrillator and to display on the at least one display device the second patient historical electrocardiogram.

The system of any one of paragraphs [035] to [040], wherein the processor is further configured to simultaneously display the first and second patient historical electrocardiograms on the at least one display device.

The system of any one of paragraphs [035] to [041], wherein some or all of the encounter record is stored on a stationary server remote from the emergency response vehicle.

The system of any one of paragraphs [035] to [042], further comprising a non-invasive cardiac support pump communicably coupled to the information system.

A method for collecting and displaying emergency medical services information according to embodiments of the present invention includes mounting an information system in an emergency response vehicle, the information system comprising at least one display device, at least one processor, and at least one database, maintaining an encounter record for an encounter with a particular patient transported by the emergency response vehicle, communicably coupling a wearable cardioverter defibrillator (WCD) to the information system, the WCD having been worn by the particular patient before the encounter, receiving patient information from the WCD, and updating the encounter record based on the patient information.

The method of paragraph [044], wherein the patient information is patient identification information, the method further comprising updating the encounter record with an identification of the patient based on the patient identification information.

The method of any of paragraphs [044] or [045], wherein the patient information is patient medical history information, the method further comprising updating the encounter record with the patient medical history information.

The method of any of paragraphs [044] to [046], wherein the patient information is a patient historical electrocardiogram, the method further including updating the encounter record with the patient historical electrocardiogram.

The method of any of paragraphs [044] to [047], further comprising displaying on the at least one display device the patient historical electrocardiogram.

The method of any of paragraphs [044] to [048], wherein the patient historical electrocardiogram is a first patient historical electrocardiogram, the method further comprising communicably coupling a non-wearable defibrillator to the information system, receiving a second patient historical electrocardiogram taken during the encounter from the non-wearable defibrillator, and displaying on the at least one display device the second patient historical electrocardiogram.

The method of any of paragraphs [044] to [049], further comprising simultaneously displaying the first and second patient historical electrocardiograms on the at least one display device.

The method of any of paragraphs [044] to [050], wherein some or all of the encounter record is stored on a stationary server remote from the emergency response vehicle.

A system for collecting and displaying emergency medical services information according to embodiments of the present invention includes an information system located in an emergency response vehicle, the information system comprising at least one display device, at least one processor, and at least one database, wherein the information system is configured to maintain an encounter record for an encounter with a particular patient transported by the emergency response vehicle, and a non-invasive cardiac support pump (NICSP) communicably coupled to the information system, wherein the processor is configured to receive patient information from the NICSP, and update the encounter record based on the patient information.

The system of paragraph [052], wherein the patient information is chest compression information about chest compressions applied to the patient prior to the encounter, and wherein the processor is configured to update the encounter record with the chest compression information.

The system of any of paragraphs [052] and [053], wherein the chest compression information includes a time when chest compression with the NICSP began.

The system of any of paragraphs [052] to [054] wherein the chest compression information includes a tally of chest compressions applied to the patient by the NICSP.

The system of any of paragraphs [052] to [055], wherein the chest compression information includes timing information about chest compressions applied to the patient by the NICSP.

The system of any of paragraphs [052] to [056] wherein the processor is further configured to receive battery information from the NICSP.

The system of any of paragraphs [052] to [057], wherein the battery information comprises a predicted battery charge time remaining.

The system of any of paragraphs [052] to [058], further comprising a navigation system communicably coupled to the information system; wherein the processor is further configured to determine a time remaining to destination from the navigation system and compare the time remaining to destination with the predicted battery charge time remaining.

The system of any of paragraphs [052] to [059], wherein the processor is further configured to generate an alert if the time remaining to destination is less than the predicted battery charge time remaining.

The system of any of paragraphs [052] to [060], wherein the battery information comprises one or both of the time of the last calibration cycle and the time of the last full charge.

The system of any of paragraphs [052] to [061], further comprising a patient skin color sensor; wherein the processor is configured to receive a skin color from the patient skin color sensor, determine a level of perfusion based on the skin color, and display an indication of the level of perfusion on the at least one display device.

The system of any of paragraphs [052] to [062], wherein some or all of the encounter record is stored on a stationary server remote from the emergency response vehicle.

The system of any of paragraphs [052] to [063], further comprising a defibrillator communicably coupled to the information system, wherein the processor is configured to control chest compressions applied by the NICSP based on information received from the defibrillator.

A system for collecting and displaying emergency medical services information according to embodiments of the present invention includes an information system located in an emergency response vehicle, the information system comprising at least one display device, at least one processor, and at least one database, wherein the information system is configured to maintain an encounter record for a particular patient transported by the emergency response vehicle, at least one temperature sensing device communicably coupled to the information system, the at least one temperature sensing device including a patient temperature sensor configured to generate patient temperature data, wherein the processor is configured to receive the patient temperature data from the at least one temperature sensing device, and update the encounter record during the encounter based on the patient temperature data.

The system of paragraph [065], wherein the patient temperature data comprises patient core temperature data, and wherein the encounter record includes the patient core temperature data for at least two points in time.

The system of any of paragraphs [065] and [066], wherein the processor is configured to display on the at least one display device a visual depiction of the patient core temperature data over time.

The system of any of paragraphs [065] to [067], wherein the at least one database comprises a target patient core temperature profile, and wherein the processor is further configured to display the target patient core temperature profile simultaneously with the visual depiction of the patient core temperature data over time.

The system of any of paragraphs [065] to [068], further comprising a patient charting device communicably coupled to the information system, wherein the processor is further configured to receive an indication from the patient charting device of time and dosage information for administration of an anti-shivering drug.

The system of any of paragraphs [065] to [069], wherein the processor is further configured to update the encounter record based on the time and dosage information.

The system of any of paragraphs [065] to [070], further comprising a patient charting device communicably coupled to the information system, wherein the processor is further configured to receive an indication from the patient charting device of time information for an administration of adjunctive surface temperature management.

The system of any of paragraphs [065] to [071], wherein the adjunctive surface temperature management comprises placing a warming blanket on the particular patient.

The system of any of paragraphs [065] to [072], wherein some or all of the encounter record is stored on a stationary server remote from the emergency response vehicle.

A method for collecting and displaying emergency medical services information according to embodiments of the present invention includes mounting an information system in an emergency response vehicle, the information system comprising at least one display device, at least one processor, and at least one database, maintaining an encounter record for an encounter with a particular patient transported by the emergency response vehicle, communicably coupling at least one temperature sensing device to the information system, the at least one temperature sensing device comprising a patient temperature sensor configured to generate patient temperature data, receiving patient temperature data from the at least one temperature sensing device, and updating the encounter record based on the patient temperature data.

The method of paragraph [074], wherein the patient temperature data comprises patient core temperature data, and wherein the encounter record is updated with the patient core temperature data for at least two points in time.

The method of any of paragraphs [074] or [075], further comprising displaying on the at least one display device a visual depiction of the patient core temperature data over time.

The method of any of paragraphs [074] to [076], wherein the at least one database comprises a target patient core temperature profile, the method further comprising displaying the target patient core temperature profile simultaneously with the visual depiction of the patient core temperature data over time.

The method of any of paragraphs [074] to [077], further comprising communicably coupling a patient charting device to the information system; and receiving an indication from the patient charting device of time and dosage information for administration of an anti-shivering drug.

The method of any of paragraphs [074] to [078], further comprising updating the encounter record based on the time and dosage information.

The method of any of paragraphs [074] to [079], further comprising communicably coupling a patient charting device to the information system; and receiving an indication from the patient charting device of time information for an administration of adjunctive surface temperature management.

The method of any of paragraphs [074] to [080], wherein the adjunctive surface temperature management comprises placing a warming blanket on the particular patient.

The method of any of paragraphs [074] to [081], comprising cooling the particular patient.

The method of any of paragraphs [074] to [082], comprising warming the particular patient.

A method for remote control of a remote temperature management system according to embodiments of the present invention includes mounting an information system in an emergency response vehicle, the information system comprising at least one display device, at least one processor, and at least one database, wherein the remote temperature management system is remote from the emergency response vehicle, maintaining an encounter record for an encounter with a particular patient transported by the emergency response vehicle, confirming with the information system that the particular patient is experiencing a condition that may be treated with the remote temperature management system, and based on the confirmation, activating the remote temperature management system with a command from the processor.

The method of paragraph [084], further including monitoring patient core temperature with the information system, adding patient core temperature data to the encounter record based on the monitoring, and sending the patient core temperature data to the remote temperature management system.

The method of paragraphs [084] or [085], further comprising deactivating the remote temperature management system.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a system for mobile and enterprise user real-time display of medical information collected from multiple different EMS devices, according to embodiments of the present invention.

FIG. 2 illustrates one example of a menu template for the display of a “back of ambulance” (“BOA”) device, according to embodiments of the present invention.

FIG. 3 illustrates a display and graphical user interface displayed when the user selects the navigation button of the menu template, according to embodiments of the present invention.

FIG. 4 illustrates a display and graphical user interface displayed when the user selects the patient monitoring button of the menu template, according to embodiments of the present invention.

FIG. 5 illustrates a display and graphical user interface displayed when the user selects the patient charting button of the menu template, according to embodiments of the present invention.

FIG. 6 illustrates a display and graphical user interface displayed when the user selects the “patch notes” button of the menu template, according to embodiments of the present invention.

FIG. 7 illustrates a display and graphical user interface displayed when the user selects the protocols button of the menu template, according to embodiments of the present invention.

FIG. 8 illustrates an enterprise display and graphical user interface shown when the enterprise user selects the patient monitoring button, according to embodiments of the present invention.

FIG. 9 illustrates an enterprise display and graphical user interface shown when the enterprise user selects the navigation button, according to embodiments of the present invention.

FIG. 10 illustrates an enterprise display and graphical user interface shown when the enterprise user selects the patient charting button, according to embodiments of the present invention.

FIG. 11 illustrates a treatment domain system overview for real-time display of medical information collected from multiple different EMS devices, according to embodiments of the present invention.

FIG. 12 illustrates a device adapter/communication engine and medical device interface, according to embodiments of the present invention.

FIG. 13 illustrates an exemplary pipe, according to embodiments of the present invention.

FIG. 14 illustrates a method performed by a pipe of the device adapter that uses discovery supporting transport, according to embodiments of the present invention.

FIG. 15 illustrates a method performed by a pipe of the device adapter that uses non-discovery supporting transport, according to embodiments of the present invention.

FIG. 16 illustrates a method performed by a BOA module, according to embodiments of the present invention.

FIG. 17 illustrates a method performed by a BOA module, according to embodiments of the present invention.

FIG. 18 illustrates an exemplary computer system, according to embodiments of the present invention.

FIG. 19 illustrates a system for mobile and enterprise user real-time display of medical information collected from multiple different EMS devices, according to embodiments of the present invention.

FIG. 20 illustrates a carrier board design for an EMS communication interface device, according to embodiments of the present invention.

FIG. 21 illustrates a system overview for an EMS communication interface device, according to embodiments of the present invention.

FIG. 22 illustrates another system overview for an EMS communication interface device, according to embodiments of the present invention.

FIG. 23 illustrates a software logic diagram for an EMS communication interface device, according to embodiments of the present invention.

FIG. 24 illustrates a conventional mesh network.

FIG. 25 illustrates an indoor geolocation system.

FIG. 26 illustrates an example explanation of differential diagnosis of acute dyspnea in adults.

FIG. 27 illustrates an example explanation of clues to differential diagnosis of dyspnea.

FIG. 28 illustrates an example listing of physical exam findings in the diagnosis of acute dyspnea.

FIG. 29 shows an example treatment protocol for asthma, COPD, and acute decompensated heart failure.

FIG. 30 illustrates a data transmission interface, according to embodiments of the present invention.

FIG. 31 illustrates an EMS communication interface transmission processing block diagram, according to embodiments of the present invention.

FIG. 32 illustrates a EMS communications interface device client architecture, according to embodiments of the present invention.

FIG. 33 illustrates an enterprise display and graphical user interface shown when the enterprise user selects the patient monitoring button, according to embodiments of the present invention.

FIG. 34 illustrates an enterprise display and graphical user interface shown when the enterprise user selects the patient charting button, according to embodiments of the present invention.

FIG. 35 illustrates an enterprise display and graphical user interface shown when the enterprise user selects the navigation button, according to embodiments of the present invention.

FIG. 36 illustrates an alternative enterprise display and graphical user interface shown when the enterprise user selects the navigation button, according to embodiments of the present invention.

FIG. 37 illustrates an enterprise display and graphical user interface shown when the enterprise user selects the patch notes button, according to embodiments of the present invention.

FIG. 38 illustrates a display and graphical user interface displayed when the user selects the patient charting button of a BOA menu template, according to embodiments of the present invention.

FIG. 39 illustrates a display and graphical user interface displayed when the user selects the patient monitoring button of a BOA menu template, according to embodiments of the present invention.

FIG. 40 illustrates a display and graphical user interface displayed when the user selects the navigation button of a BOA menu template, according to embodiments of the present invention.

FIG. 41 illustrates an alternative display and graphical user interface displayed when the user selects the navigation button of a BOA menu template, according to embodiments of the present invention.

FIG. 42 illustrates a display and graphical user interface displayed when the user selects the shift start button of a BOA menu template, according to embodiments of the present invention.

FIG. 43 illustrates an alternative display and graphical user interface displayed when the user selects the navigation button of a BOA menu template, according to embodiments of the present invention.

FIG. 44 illustrates a display and graphical user interface displayed when the user selects the patch notes button of a BOA menu template, according to embodiments of the present invention.

FIG. 45 illustrates a display and graphical user interface displayed when the user selects a live patient data button of a BOA menu template, according to embodiments of the present invention.

FIG. 46 illustrates a start screen for a role-based EMS technician mobile device in communication with a BOA device, according to embodiments of the present invention.

FIG. 47 illustrates a role selection screen for a role-based EMS technician mobile device in communication with a BOA device, according to embodiments of the present invention.

FIG. 48 illustrates a lead medic quick log screen for a role-based EMS technician mobile device in communication with a BOA device, according to embodiments of the present invention.

FIG. 49 illustrates a lead medic ECG graph screen for a role-based EMS technician mobile device in communication with a BOA device, according to embodiments of the present invention.

FIG. 50 illustrates a lead medic patient data screen for a role-based EMS technician mobile device in communication with a BOA device, according to embodiments of the present invention.

FIG. 51 illustrates a lead medic chief complaint screen for a role-based EMS technician mobile device in communication with a BOA device, according to embodiments of the present invention.

FIG. 52 illustrates a drug medic quick log screen for a role-based EMS technician mobile device in communication with a BOA device, according to embodiments of the present invention.

FIG. 53 illustrates a drug medic ECG graph screen for a role-based EMS technician mobile device in communication with a BOA device, according to embodiments of the present invention.

FIG. 54 illustrates a role selection screen for a role-based EMS technician mobile device in communication with a BOA device, according to embodiments of the present invention.

FIG. 55 illustrates an airway medic ECG graph screen for a role-based EMS technician mobile device in communication with a BOA device, according to embodiments of the present invention.

FIG. 56 illustrates an airway medic quick log screen for a role-based EMS technician mobile device in communication with a BOA device, according to embodiments of the present invention.

FIG. 57 illustrates a CPR medic quick log screen for a role-based EMS technician mobile device in communication with a BOA device, according to embodiments of the present invention.

FIG. 58 illustrates a CPR medic ECG graph screen during idle for a role-based EMS technician mobile device in communication with a BOA device, according to embodiments of the present invention.

FIG. 59 illustrates a CPR medic ECG graph screen during administration of compressions for a role-based EMS technician mobile device in communication with a BOA device, according to embodiments of the present invention.

FIG. 60 illustrates a CPR medic ECG graph screen during administration of compressions for a role-based EMS technician mobile device in communication with a BOA device, according to embodiments of the present invention.

FIG. 61 illustrates a CPR medic ECG graph screen during administration of compressions for a role-based EMS technician mobile device in communication with a BOA device, according to embodiments of the present invention.

FIG. 62 illustrates a system for role-based data feeds from a BOA device to EMS technician mobile devices, according to embodiments of the present invention.

FIG. 63 illustrates a system for mobile and enterprise user collection and display of medical information collected from multiple different EMS devices, including a bar code scanner, according to embodiments of the present invention.

FIG. 64 illustrates a treatment domain system overview for real-time display of medical information collected from multiple different EMS devices, including a bar code scanner, according to embodiments of the present invention.

FIG. 65 illustrates a flow chart describing a method for handling bar code data received from a bar code scanner, according to embodiments of the present invention.

FIG. 66 illustrates a flow chart describing a method for handling image data received from a bar code scanner, according to embodiments of the present invention.

FIG. 67 illustrates a flow chart describing a method for handling bar code XML records received, according to embodiments of the present invention.

FIG. 68 illustrates a flow chart describing a method for handling bar code image XML records received, according to embodiments of the present invention.

FIG. 69 illustrates a system for mobile and enterprise user collection and display of medical information collected from multiple different EMS devices, including an RFID reader, according to embodiments of the present invention.

FIG. 70 illustrates a system for mobile and enterprise user collection and display of medical information collected from multiple different EMS devices, including a wearable cardioverter defibrillator and a non-invasive cardiac support pump, according to embodiments of the present invention.

FIG. 71 illustrates a treatment domain system overview for real-time display of medical information collected from multiple different EMS devices, including a wearable cardioverter defibrillator and a non-invasive cardiac support pump, according to embodiments of the present invention.

FIG. 72 illustrates a flow chart describing a method for handling data received from a wearable cardioverter defibrillator, according to embodiments of the present invention.

FIG. 73 illustrates a flow chart describing a method for handling data received from a non-invasive cardiac support pump, according to embodiments of the present invention.

FIG. 74 illustrates a user interface screen for a device communicably coupled to a defibrillator with twelve-lead historical snapshot information, according to embodiments of the present invention.

FIG. 75 illustrates a system for mobile and enterprise user collection and display of medical information collected from multiple different EMS devices, including a patient warming and/or cooling device and one or more temperature sensing devices, according to embodiments of the present invention.

FIG. 76 illustrates a treatment domain system overview for real-time display of medical information collected from multiple different EMS devices, including a patient warming and/or cooling device, according to embodiments of the present invention.

FIG. 77 illustrates a system in which a back of ambulance device is communicably coupled over a network to an in-hospital temperature management system, according to embodiments of the present invention.

FIG. 78 illustrates a graph of patient temperature data over time, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

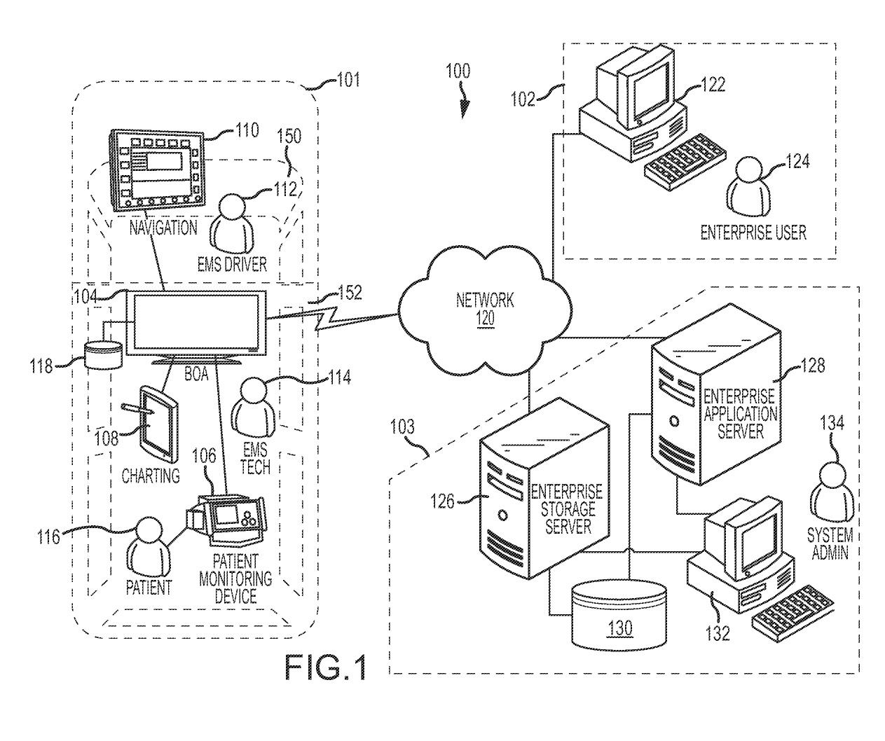

As illustrated in FIG. 1, a system 100 according to embodiments of the present invention performs advanced data management, integration and presentation of EMS data from multiple different devices. System 100 includes a mobile environment 101, an enterprise environment 102, and an administration environment 103. Devices within the various environments 101, 102, 103 may be communicably coupled via a network 120, such as, for example, the Internet.

As used herein, the phrase “communicably coupled” is used in its broadest sense to refer to any coupling whereby information may be passed. Thus, for example, communicably coupled includes electrically coupled by, for example, a wire; optically coupled by, for example, an optical cable; and/or wirelessly coupled by, for example, a radio frequency or other transmission media. “Communicably coupled” also includes, for example, indirect coupling, such as through a network, or direct coupling.

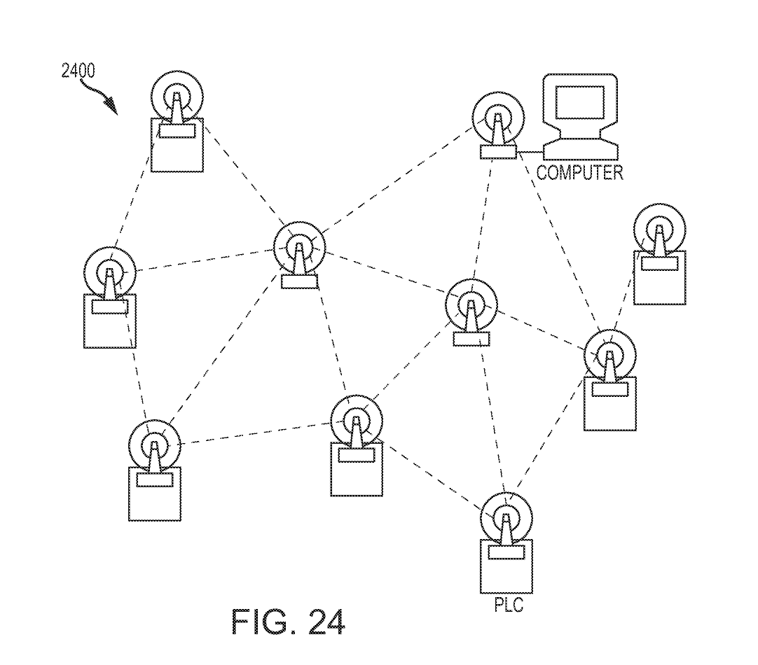

The network 120 may also take the form of an ad hoc, self-configuring, self-healing network 2400 such as a MESH network, as illustrated in FIG. 24, according to embodiments of the present invention. FIG. 24, as well as the following information about MESH networks in paragraphs [00109] to [00117], is taken directly from Poor, Robert; WIRELESS MESH NETWORKS; Sensors (Feb. 1, 2003), available at http://www.sensorsmag.com/networking-communications/standards-protocols/wireless-mesh-networks-968, which is incorporated herein by reference. Wireless systems for industry conventionally use cellular phone-style radio links, using point-to-point or point-to-multipoint transmission. But research at MIT's Media Lab in Cambridge, Mass., indicated that traditional wireless formats have limitations in industrial applications. These include rigid structure, meticulous planning requirements, and dropped signals. This can pose an acute challenge in an EMS or mass casualty environment in which existing infrastructure may be either sparse (e.g. a rural environment) or dysfunctional (e.g. a mass casualty or disaster situation).

In contrast, wireless mesh networks 2400 are multihop systems in which devices assist each other in transmitting packets through the network, especially in adverse conditions. Such ad hoc networks may be implemented with minimal preparation, and they provide a reliable, flexible system that can be extended to thousands of devices, according to embodiments of the present invention.

The wireless mesh network topology developed at MIT for industrial control and sensing is a point-to-point-to-point, or peer-to-peer, system called an ad hoc, multihop network. A node can send and receive messages, and in a mesh network, a node also functions as a router and can relay messages for its neighbors. Through the relaying process, a packet of wireless data will find its way to its destination, passing through intermediate nodes with reliable communication links, as illustrated in FIG. 24.

In a wireless mesh network 2400, multiple nodes cooperate to relay a message to its destination. The mesh topology enhances the overall reliability of the network, which is particularly important when operating in harsh industrial environments. Like the Internet and other peer-to-peer router-based networks, a mesh network offers multiple redundant communications paths throughout the network. If one link fails for any reason (including the introduction of strong RF interference), the network automatically routes messages through alternate paths. In a mesh network 2400, the distance between nodes can be shortened, which dramatically increases the link quality. Reducing the distance by a factor of two, the resulting signal is at least four times more powerful at the receiver. This makes links more reliable without increasing transmitter power in individual nodes. The reach of a mesh network may be extended, redundancy added, and general reliability improved simply by adding more notes.

Network 2400 may be a self-configuring and self-healing network, according to embodiments of the present invention. According to embodiments of the present invention, a network 2400 does not require a system administrator to tell it how to get a message to its destination. A mesh network 2400 is self-organizing and does not require manual configuration. Because of this, adding new gear or relocating existing gear is as simple as plugging it in and turning it on, according to embodiments of the present invention. The network discovers the new node and automatically incorporates it into the existing system, according to embodiments of the present invention.

A mesh network 2400 is not only inherently reliable, it is also highly adaptable, according to embodiments of the present invention. For example, if a tank-level sensor and data logger are placed too far apart for a robust RF communications link, one or more repeater nodes may be added to fill the gaps in the network 2400.

On the Internet, if one router goes down, messages are sent through an alternate path by other routers. Similarly, if a device or its link in a mesh network fails, messages are sent around it via other devices. Loss of one or more nodes does not necessarily affect the network's operation. A mesh network is self-healing because human intervention is not necessary for re-routing of messages. Such networks 2400 provide redundancy and scalability, according to embodiments of the present invention.

In a mesh network, the degree of redundancy is essentially a function of node density. A network can be deliberately over-designed for reliability simply by adding extra nodes, so each device has two or more paths for sending data. This is a simpler way of obtaining redundancy than is possible in most other types of systems. A mesh network is also scalable and can handle hundreds or thousands of nodes. Because the operation of network 2400 does not depend on a central control point, adding multiple data collection points or gateways may be convenient.

Reliability, adaptability, and scalability are notable attributes of a wireless network for industrial control and sensing applications, according to embodiments of the present invention. Point-to-point networks provide reliability, but they are often challenging to scale to handle more than one pair of end points. Point-to-multipoint networks can handle more end points, but their reliability may depend on placement of the access point and end points. Mesh networks are inherently reliable, adapt easily to environmental or architectural constraints, and can scale to handle thousands of end points.

According to embodiments of the present invention, the mobile environment 101 is an ambulance or other EMS vehicle—for example a vehicular mobile environment (VME). The mobile environment may also be the local network of data entry devices as well as diagnostic and therapeutic devices established at time of treatment of a patient or patients in the field environment—the “At Scene Patient Mobile Environment” (ASPME). The mobile environment may also be a combination of one or more of VMEs and/or ASPMEs. The mobile environment may include a navigation device 110 used by the driver 112 to track the mobile environment's position 101, locate the mobile environment 101 and/or the emergency location, and locate the transport destination, according to embodiments of the present invention. The navigation device 110 may include a Global Positioning System (“GPS”), for example. The navigation device 110 may also be configured to perform calculations about vehicle speed, the travel time between locations, and estimated times of arrival. According to embodiments of the present invention, the navigation device 110 is located at the front of the ambulance to assist the driver 112 in navigating the vehicle. The navigation device 110 may be, for example, a RescueNet® Navigator onboard electronic data communication system available from Zoll Data Systems of Broomfield, Colo.

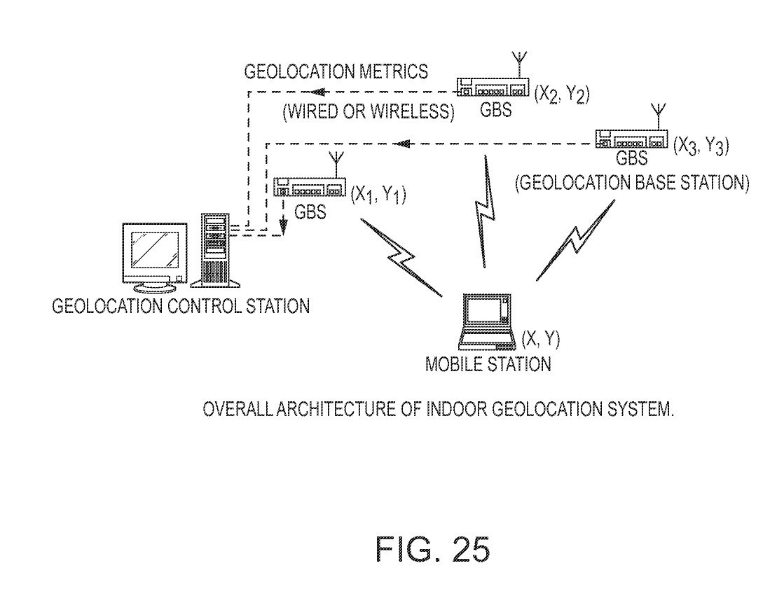

FIG. 25, as well as the following information about geolocation in paragraphs [00119] through [00120], is taken directly from K. Pahlavan, et al., “An Overview of Wireless Indoor Geolocation,” Mobile and Wireless Communications Networks IFIP-TC6/European Commission NETWORKING 2000 International Workshop, MWCN 2000 Paris, France, May 16-17, 2000, which is incorporated herein by reference. More generally, the mobile environment may include a geolocation sensor in one or more of the devices in the VME or ASPME. The geolocation sensor may be of a common type such as, for example, a Global Positioning System (GPS). GPS, though, may be subject to certain limitations: 1) line of sight to more than one GPS satellite, which may limit its performance in indoor environments; 2) in some urban environments, location accuracy is reduced due to signal reflections off of buildings; and 3) normal accuracy may be insufficient in the case of a mass casualty in which accuracies of better than +/−5 feet may be required when there are multiple casualties and the locations of each victim needs to be integrated into a software mapping environment, according to embodiments of the present invention.

Therefore, additional locator base stations may be deployed on-scene outdoors, or within buildings, that may augment or replace the conventional GPS-based geolocator systems, according to embodiments of the present invention. Similar to the cellular geolocation system, the architecture of indoor geolocation systems may fall within one of two main categories: mobile-based architecture and network-based architecture. Most conventional indoor geolocation applications have been focused on network-based system architecture as shown in FIG. 25. The geolocation base stations (GBS) extract location metrics from the radio signals transmitted by the mobile station and relay the information to a geolocation control station (GCS). The connection between GBS and GCS can be either wired or wireless, according to embodiments of the present invention. Then the position of the mobile station may be estimated, in an indoor environment. As a result, dedicated indoor geolocation systems provide accurate indoor geolocation services. This may be applied as well to a mobile environment such as a battlefield or other mass casualty situation in which base stations with better known accuracy based on landmarks or more sophisticated GPS systems such as differential GPS (DGPS) can be deployed to provide highly accurate and complete information about the patient status integrated into the navigation software or other mapping software, such as, for example, Google maps.

As illustrated in FIG. 1, a patient monitoring device 106 and a patient charting device 108 are also often used for patient care in the mobile environment 101, according to embodiments of the present invention. The EMS technician 114 attaches the patient monitoring device 106 to the patient 116 to monitor the patient 116. The patient monitoring device 106 may be, for example, a defibrillator device with electrodes and/or sensors configured for attachment to the patient 116 to monitor heart rate and/or to generate electrocardiographs (“ECG's”), according to embodiments of the present invention. The patient monitoring device 106 may also include sensors to detect or a processor to derive or calculate other patient conditions. For example, the patient monitoring device 106 may monitor, detect, treat and/or derive or calculate blood pressure, temperature, respiration rate, blood oxygen level, end-tidal carbon dioxide level, pulmonary function, blood glucose level, and/or weight, according to embodiments of the present invention. The patient monitoring device 106 may be a Zoll E-Series® defibrillator available from Zoll Medical Corporation of Chelmsford, Mass., according to embodiments of the present invention. A patient monitoring device may also be a patient treatment device, or another kind of device that includes patient monitoring and/or patient treatment capabilities, according to embodiments of the present invention.

The patient charting device 108 is a device used by the EMS technician 114 to generate records and/or notes about the patient's 116 condition and/or treatments applied to the patient, according to embodiments of the present invention. For example, the patient charting device 108 may be used to note a dosage of medicine given to the patient 116 at a particular time. The patient charting device 108 and/or patient monitoring device 106 may have a clock, which may be synchronized with an external time source such as a network or a satellite to prevent the EMS technician from having to manually enter a time of treatment or observation (or having to attempt to estimate the time of treatment for charting purposes long after the treatment was administered), according to embodiments of the present invention. The patient charting device 108 may also be used to record biographic and/or demographic and/or historical information about a patient, for example the patient's name, identification number, height, weight, and/or medical history, according to embodiments of the present invention. According to embodiments of the present invention, the patient charting device 108 is a tablet PC, such as for example the TabletPCR component of the RescueNet® ePCR Suite available from Zoll Data Systems of Broomfield, Colo. According to some embodiments of the present invention, the patient charting device 108 is a wristband or smart-phone such as an Apple iPhone or iPad with interactive data entry interface such as a touch screen or voice recognition data entry that may be communicably connected to the BOA device 104 and tapped to indicate what was done with the patient 116 and when it was done.

The navigation device 110, the charting device 108, and the monitoring device 106 are each separately very useful to the EMS drivers 112 and technicians 114 before, during, and after the patient transport. A “back of ambulance” (“BOA”) device 104 receives, organizes, stores, and displays data from each device 108, 110, 112 to further enhance the usefulness of each device 108, 110, 112 and to make it much easier for the EMS technician 114 to perform certain tasks that would normally require the EMS technician 114 to divert visual and manual attention to each device 108, 110, 112 separately, according to embodiments of the present invention. In other words, the BOA device centralizes and organizes information that would normally be de-centralized and disorganized, according to embodiments of the present invention.

Although device 104 is referred to herein as a “back of ambulance” device because the EMS technician 114 would normally benefit the most from having such a display device mounted in the back 152 of an ambulance, one of ordinary skill in the art, based on the disclosure provided herein, will recognize that some or all of the BOA device 104 may be located in any part of a mobile environment 101, EMS vehicle, and/or anywhere else useful to an EMS technician 114. For example, the BOA device 104 may be located in the front 150 of an ambulance, and/or may include components that are portable and can be carried into a patient residence, according to embodiments of the present invention.

The BOA device 104 is communicably coupled to the patient monitoring device 106, the patient charting device 108, and the navigation device 110, according to embodiments of the present invention. The BOA device 104 is also communicably coupled to a storage medium 118. The BOA device 104 may be a touch-screen, flat panel PC, and the storage medium 118 may be located within or external to the BOA device 104, according to embodiments of the present invention. The BOA device 104 may include a display template serving as a graphical user interface, which permits the user (e.g. EMS tech 114) to select different subsets and/or display modes of the information gathered from and/or sent to devices 106, 108, 110, according to embodiments of the present invention.

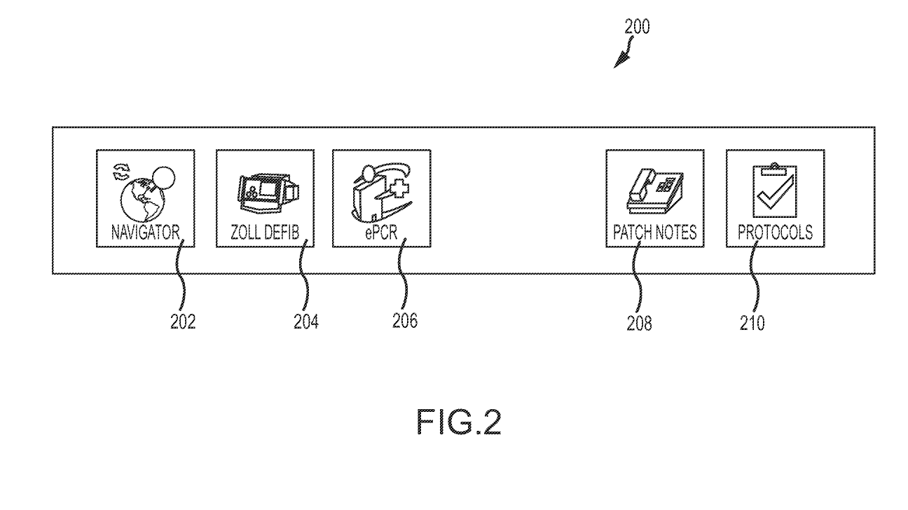

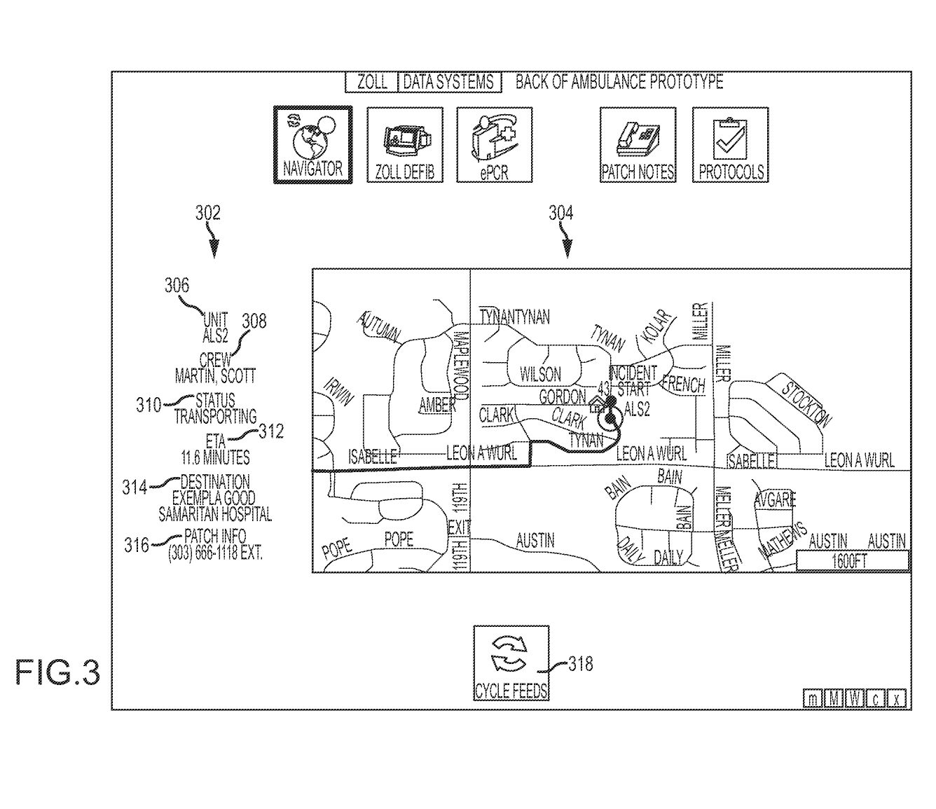

FIG. 2 illustrates one example of a menu template 200 for the display of BOA device 104, according to embodiments of the present invention. The menu template 200 includes a navigation button 202, a patient monitoring device button 204, a patient charting device button 206, a “patch notes” button 208, and a protocols button 210, according to embodiments of the present invention. Pressing one of the buttons takes the user (e.g. EMS tech 114) to a particular page displaying all or a subset of information from devices 106, 108, 110. FIGS. 3-7 illustrate examples of particular information templates according to which information from the one or more EMS devices 106, 108, 110 is displayed, according to embodiments of the present invention. Based on the disclosure provided herein, one of ordinary skill in the art will recognize various other information templates according to which such information may be displayed.

FIG. 3 illustrates a graphical user interface displayed when the user selects the navigation button 202, according to embodiments of the present invention. One part of the display includes a status section 302 and another part of the display includes a map section 304, according to embodiments of the present invention. The status section 302 includes one or more fields identifying information about the EMS vehicle trip, according to embodiments of the present invention. For example, the fields of the status section 302 may include one or more of a Unit field 306 identifying the name of the EMS vehicle for which information is displayed, a Crew unit 308 identifying one or more crew members of the EMS vehicle, a Status unit 310 identifying the status of the trip (e.g. “transporting” or “en route to patient”), an ETA field 312 identifying an estimated time of arrival at the destination, a Destination field 314 identifying the destination of the EMS vehicle (e.g. the hospital), and a Patch Info field 316 identifying a phone number or other information for contacting the EMS vehicle destination (e.g. the hospital), according to embodiments of the present invention.

The map section 304 may display street information along with the origin, destination, route identification, and/or progress information, according to embodiments of the present invention. The navigation device 110 may also supply vehicle status information for display, which may also be useful when a transport has not yet begun. A user may select a Cycle Feeds button 318 in order to continuously transition the display between one or more of the various displays of FIGS. 3-7, according to embodiments of the present invention. The information illustrated in FIG. 3 would normally be available only to the driver 112 in the front of the ambulance 101, but because BOA device 104 is communicably coupled to the navigation device 110, the BOA device 104 can display all or a selected subset of the information available to the navigation device 110.

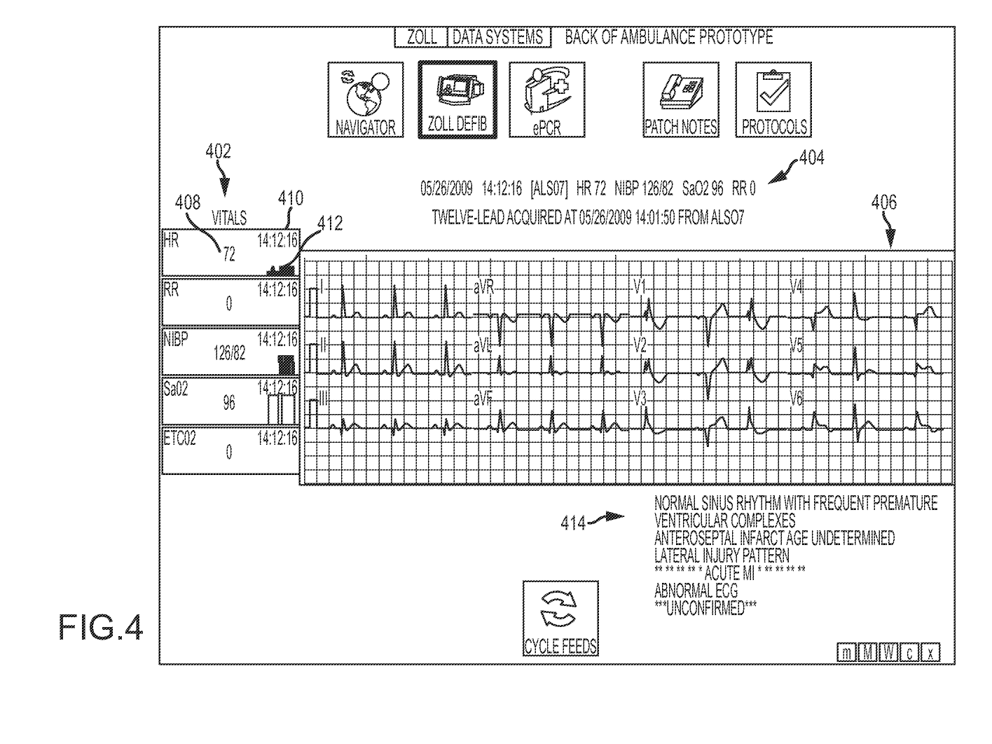

FIG. 4 illustrates a graphical user interface displayed when the user selects the patient monitoring button 204 of the menu template, according to embodiments of the present invention. FIG. 4 displays information received by the BOA device 104 from a patient monitoring device 106 that is a Zoll E-Series® defibrillator. The display includes a vertical vital signs section 402, a horizontal vital signs summary section 404, a graphical section 406, and interpretation section 414, according to embodiments of the present invention. The vertical vital signs section 402 includes one or more fields indicating a condition of the patient 116 to which the device 106 is attached. For example, the vital signs section 402 includes a heart rate field, a respiration rate field, a blood pressure field, a blood oxygen level field, and an end-tidal carbon dioxide level field. Each field may include a visual indication of a further subset of information. For example, the heart rate field may include a numerical indication 408 of the heart rate, a time indication 410 reflecting the time that the measurement was taken or derived, and a historical graph 412 indicating generally how the heart rate has increased or decreased since the first measurement or a predetermined time, according to embodiments of the present invention. Other fields may include similar indicators, according to embodiments of the present invention. Vital sign trending may also be displayed.

A horizontal vital signs summary section 404 indicates, for example, the numerical values represented simultaneously in the vertical vital signs section 402, according to embodiments of the present invention. The graphical section 406 includes a visual representation of an electrocardiograph, such as that acquired from a twelve-lead sensor placement on the patient 116, according to embodiments of the present invention. Just above the ECG is an indication of when the ECG was acquired. As new vital signs information and/or new ECG information becomes available, the display of FIG. 4 is automatically refreshed to show the most recent data from the patient monitoring device 106, according to embodiments of the present invention. The interpretation section 414 includes automatically-generated information from the device 106, for example, indicating potential causes of the symptoms observed by the device 106, according to embodiments of the present invention.

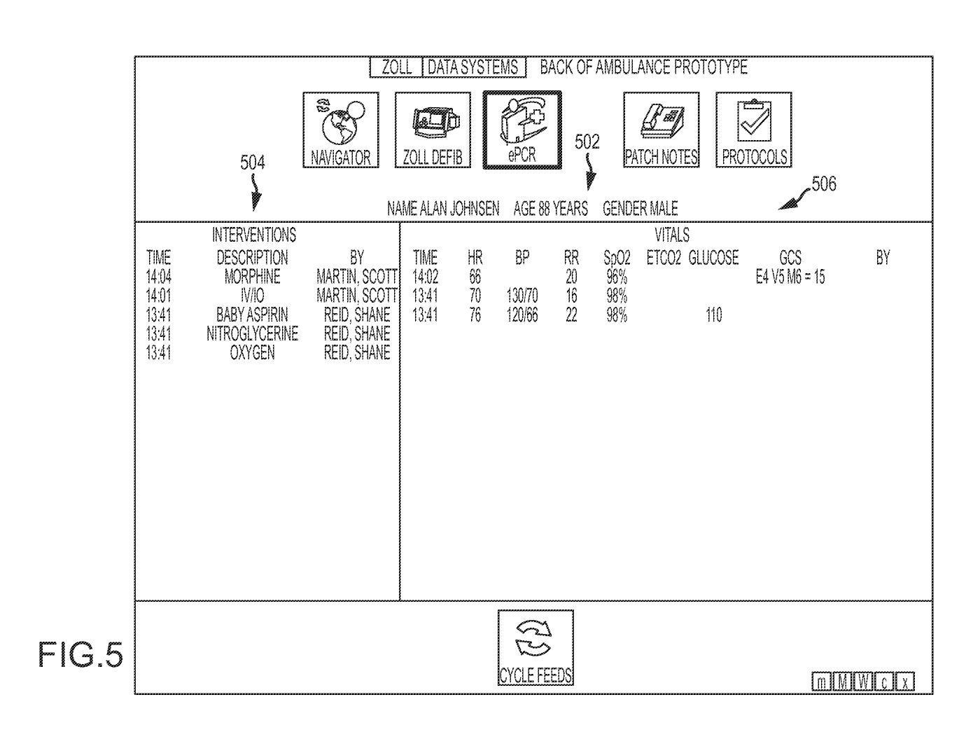

FIG. 5 illustrates a graphical user interface displayed when the user selects the patient charting button 206 of the menu template, according to embodiments of the present invention. The display of FIG. 5 includes a biographical summary 502, an interventions section 504, and a vital signs section 506, according to embodiments of the present invention. The biographical summary 502 may display the patient's name, age, and gender as recorded by the EMS technician 114 with the patient charting device 108, according to embodiments of the present invention. The interventions section 504 displays the patient 116 interventions (e.g. treatments administered) recorded with the patient charting device 108, according to embodiments of the present invention. For example, the interventions section 504 includes a listing of each intervention made, the time of the intervention, a description of the intervention (e.g. name of the drug administered), and the name of the person administering the treatment, according to embodiments of the present invention.

The vital signs section 506 includes a historical listing of certain vital signs data observed by the EMS technician 114 and recorded in the patient charting device 108, and stored in the patient charting device 108 and/or the database 118, according to embodiments of the present invention. The historical listing of vital signs data in the vital signs section 506 includes a time stamp, heart rate, blood pressure, respiration rate, blood oxygen level, end-tidal carbon dioxide level, blood glucose level, Glasgow Coma Scale rating (“GCS”), and the name of the technician or device that observed or recorded the vital sign, according to embodiments of the present invention.

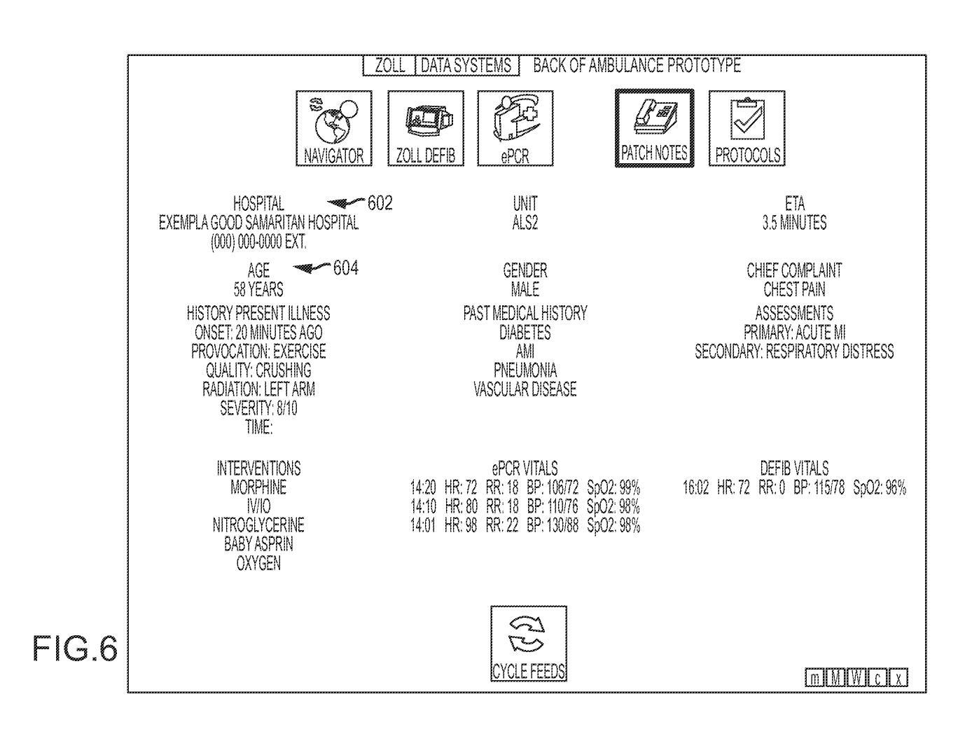

FIG. 6 illustrates a graphical user interface displayed when the user selects the “patch notes” button 208 of the menu template, according to embodiments of the present invention. Patch notes are notes used by an EMS technician 114 to place a call to a hospital or other treatment facility to confirm that the hospital will accept the patient 116 and/or to provide information about the patient 116 to help the hospital or treatment facility prepare for admission. Because time is typically of the essence for such phone calls (because placing the call can temporarily divert the EMS technician's 114 attention away from patient 116 care), the EMS technician typically consults and interacts with several different devices 106, 108, 110 and/or informal data sources to compile a list of notes to convey to the nurse or other responsible party at the hospital or treatment facility. Such patch notes often take considerable time to assemble, and are often hastily written on a glove, for example, which also results in inaccuracy and in some of the patch notes representing old information by the time the call is placed and the information conveyed to the hospital.

The BOA device 104, on the other hand, automatically creates a display of several different fields that would typically comprise patch notes, according to embodiments of the present invention. The display of FIG. 6 includes fields representing information from multiple different devices, such as, for example, devices 106, 108, 110. The patch notes display may organize the information into a predefined template, and/or may organize the information into a customized template associated with a particular EMS technician 114, according to embodiments of the present invention. Not only does the BOA device 104 automatically receive and display information from multiple different devices 106, 108, 110 in a single display summarized to function as patch notes, but it also automatically refreshes the display to reflect the most recent information, thus permitting real-time conveyance of patient information, according to embodiments of the present invention.

For example, without the BOA device 104, if a patient's heart rate rose from 75 to 115 over the course of three minutes, and if an EMS technician 114 wrote “HR 75” on his glove before consulting his patient chart for name and background information and the driver 112 for location information before calling the hospital three minutes later, the EMS technician 114 might report a heart rate of 75 to the hospital. With the BOA device 104, however, the patch notes are generated automatically and displayed as in FIG. 6, and the Defib Vitals section would list the current heart rate of 115 when the EMS technician 114 conveyed the patient status to the hospital.

In addition to one or more of a Hospital field 602 identifying the name and phone number of the hospital to which the patient 116 is en route and an age field 604 identifying the patient's age, the display of FIG. 6 may also include one or more of a History Present Illness field, an Interventions field, a Unit identification field (e.g. identifying the particular EMS vehicle), a Gender field, a Past Medical History Field, a patient charting device vital signs field, an Expected Time of Arrival field, a Chief Complaint field, an Assessments field, and a patient monitoring device vital signs field, according to embodiments of the present invention.

Each of the fields may be configured to display either past or current or derived content from one or more of the EMS devices (e.g. devices 106, 108, 110) which are communicably coupled with the BOA device 104, according to embodiments of the present invention. For example, the Hospital, Unit, and ETA fields may be based on information received from the navigation unit 110. The Age, Gender, Chief Complaint, History Present Illness, Past Medical History, and Interventions fields may be based on information received from the patient charting unit 108. The patient charting device vital signs field may be based on information received from the patient charting unit 108 (e.g. GCS score), and the patient monitoring device vital signs field may be based on information received from the patient monitoring device 106 (e.g. ECG), according to embodiments of the present invention. According to embodiments of the present invention, a BOA device 104 may be located in the front of the ambulance to permit the driver 112 or another EMS technician to place the call to the hospital based on the real-time patch notes, thereby providing the attending EMS technician 114 more time and attention for direct patient care.

According to embodiments of the present invention, the BOA device 104 receives information from at least one patient monitoring EMS device and at least one non-patient monitoring EMS device. The patch notes screen of FIG. 6 illustrates one example of EMS information (e.g. information related to an emergency medical encounter or transport) from at least one patient monitoring device and at least one other device that does not directly monitor a patient (e.g. a navigation device and/or a patient charting device) on the same display, according to embodiments of the present invention. Similarly, in another embodiment of the present invention, the BOA device 104 receives information from at least one patient clinical device and at least one non-clinical device, and analyzes, combines, stores, displays, and/or transmits the clinical and non-clinical information in a format useful to the user. As used herein, the term “clinical” is used in its broadest sense to refer to that which is directly implicated in monitoring or treatment or diagnosis of a patient. As used herein, the term “non-clinical” is used in its broadest sense to refer to that which is not directly implicated in monitoring or treatment or diagnosis of a patient. For example, a defibrillator is a clinical device, and a navigation device is a non-clinical device. As another example, a patient's ECG information or heart rate is clinical information, while a patient's address is non-clinical information.

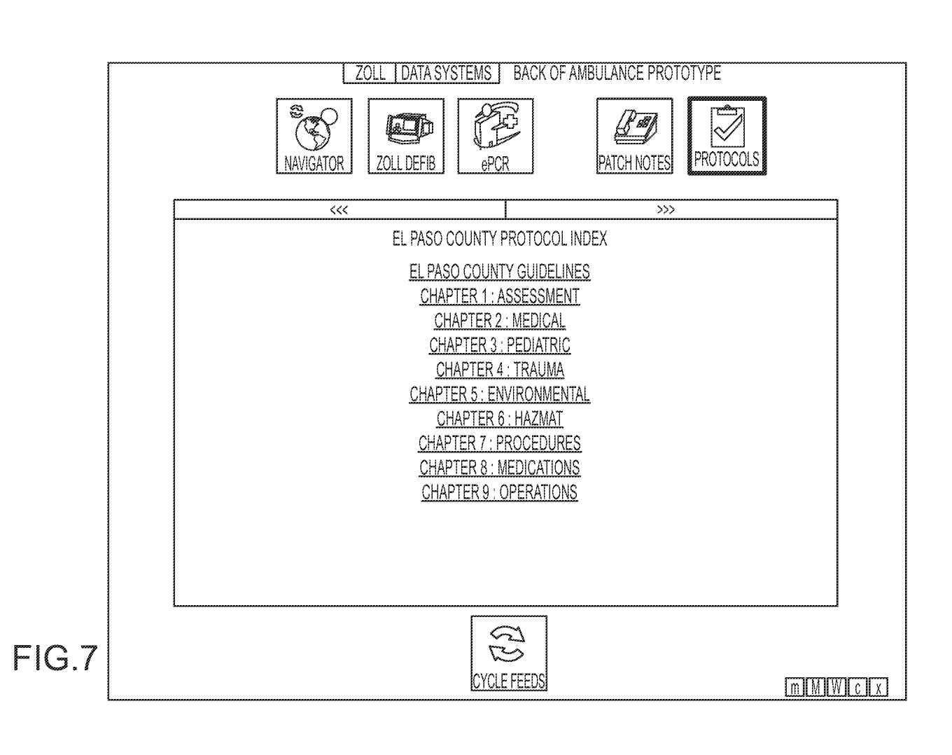

FIG. 7 illustrates a graphical user interface displayed when the user selects the protocols button 210 of the menu template, according to embodiments of the present invention. The display of FIG. 7 includes an interactive guidelines manual for the particular locale where the medical emergency occurred, where the treatment occurs, and/or where the patient is delivered, according to embodiments of the present invention. Alternatively, the protocols button 210 may link to a manual or guideline document for the use of a particular device and/or the administration of a particular technique and/or information about a drug. For example, the display of FIG. 7 may include an interactive page listing of chapters in a county's protocol index, which may be a locally-stored protocol index and/or a protocol index accessed through an Internet connection. Clicking on one or more of the chapters or links opens a page containing more detail about the particular chapter or subject selected, for example.

Based on the disclosure provided herein, one of ordinary skill in the art will appreciate that the BOA device 104 may be configured to display additional or different subsets of information from one or more EMS devices and/or external data sources. According to embodiments of the present invention, the BOA device 104 not only seamlessly integrates information from a patient monitoring device 106, a patient charting device 108, and a navigation device 110 for display in mobile environment 101, but it also does so for display in a remote environment such as, for example, enterprise environment 102. Enterprise environment 102 may be a hospital and/or dispatch environment, for example.

Data from the BOA device 104 (and therefore data from the devices 106, 108, 110 communicably coupled with the BOA device 104) may be received by one or more enterprise storage servers 126 in an administration environment 103 and stored in an enterprise database 130, and the same information may be accessed and provided by one or more enterprise application servers 128 to a workstation 122 of an enterprise user 124, according to embodiments of the present invention. According to embodiments of the present invention, the BOA device 104 is communicably coupled to the storage server 126 which is communicably coupled to the database 130, and the application server 128 is communicably coupled to the database and to the enterprise workstation 122. Such devices may be communicably coupled via a network 120 such as, for example, the Internet.

When the BOA device 104 receives updated information from one or more of the devices (e.g. devices 106, 108, 110) to which it is communicably coupled, the BOA device 104 sends the updated information to the enterprise storage server 126, which stores the updated information in a database which may be contained on a storage medium 130, according to embodiments of the present invention. Hence, information from one or more devices (e.g. devices 106, 108, 110) may be stored in mobile database 118, remote enterprise database 130, or both, according to embodiments of the present invention. An enterprise user 124, who may be an emergency room nurse monitoring and/or preparing for ambulance arrivals, an emergency room physician, and/or a medical director at home, for example, may access information similar to information displayed by the BOA device 104 by requesting the information via an enterprise workstation 122. For example, the enterprise workstation 122 accesses a web interface and/or thin client web browser application which requests the information over the network 120 from application server 128. Application server 128 queries the database 130 for the information, and returns a display to enterprise workstation 122 that looks the same as or similar to what the EMS technician 114 is currently seeing on the BOA device 104 display, according to embodiments of the present invention.

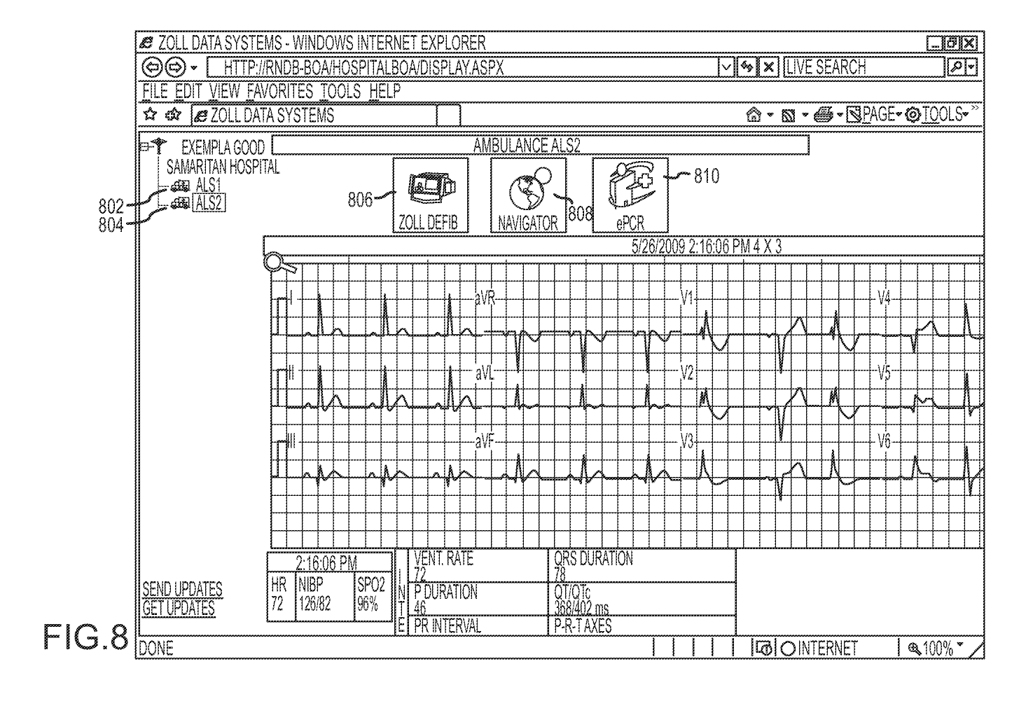

FIGS. 8-10 illustrate examples of user interface and display screens available to the enterprise user 124 via the enterprise workstation 122, according to embodiments of the present invention. FIG. 8 illustrates a web browser based client interface including, in one portion of the display, a list of available EMS vehicles 802, 804 for which EMS device data is available, according to embodiments of the present invention. Clicking on ALS2 804, for example, brings up a screen similar to FIG. 8 which allows the enterprise user 124 to select one of the buttons, including but not limited to the patient monitoring button 806, the navigation button 808, and/or the patient charting button 810. When user 124 clicks on the patient monitoring button 806, the screen display of FIG. 8 is presented and includes current information from the patient monitoring device 106 of ambulance ALS2, according to embodiments of the present invention. According to embodiments of the present invention, the patient monitoring display of FIG. 8 is automatically updated continuously or semi-continuously; according to other embodiments of the present invention, the user 124 selects “get updates” or the browser's “refresh” button in order to obtain the most current information available. The enterprise display of FIG. 8 contains information similar to the mobile display of FIG. 4, according to embodiments of the present invention.

According to embodiments of the present invention, the website display in the enterprise environment 102 is accessed via a generic internet browser by a doctor waiting in the emergency room for the patient to arrive by ambulance. The website may be secured by logon username and password, for example. Each ambulance may be identified by a vehicle name; the doctor chooses from a list of incoming vehicle, after which the data for that patient is displayed. The data may be shown just as it appears on the mobile screen, also in “clinical time.” According to embodiments of the present invention, the enterprise environment 102 website displays data only for those patients whose destination is the same as the destination logged on the user's facility.

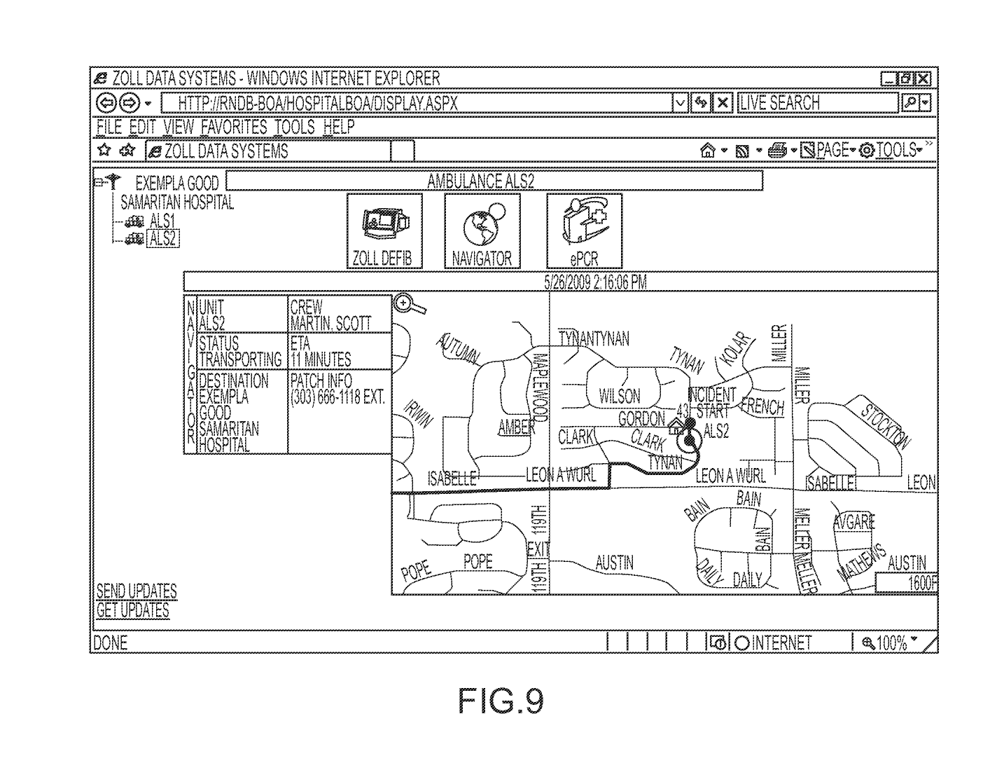

When the user 124 clicks on the navigator button 808, the screen display of FIG. 9 is presented and includes current information from the navigation device 110 of ambulance ALS2, according to embodiments of the present invention. The enterprise display of FIG. 9 contains information similar to the mobile display of FIG. 3, according to embodiments of the present invention.

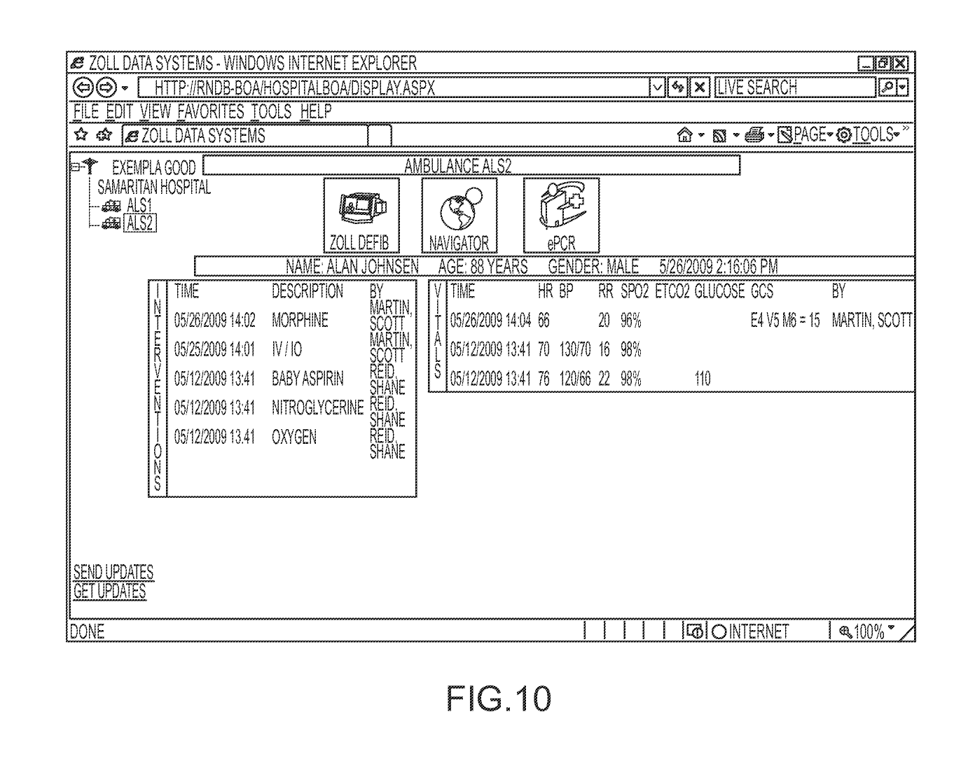

When the user 124 clicks on the patient charting button 810, the screen display of FIG. 10 is presented and includes current information from the patient charting device 108 of ambulance ALS2, according to embodiments of the present invention. The enterprise display of FIG. 10 contains information similar to the mobile display of FIG. 5, according to embodiments of the present invention.

Although FIG. 1 depicts a single BOA device 104 in the mobile environment 101, more than one BOA device 104 may be used in the mobile environment 101 to communicably connect to the same or a different set of devices 106, 108, 110. And although FIG. 1 depicts one mobile environment 101, more than one mobile environment 101 and/or more than one BOA device 104 may be communicably coupled with the administration environment 103 and/or the enterprise storage server 126, according to embodiments of the present invention. According to embodiments of the present invention, the enterprise storage server 126 receives EMS device information from BOA device 104 and stores it in database 130 along with an authenticated time stamp and an identifier associating the information with a particular EMS device and/or a particular EMS vehicle. In this way, data from multiple vehicles and/or multiple devices may be accessed by the enterprise user 124.

Also, the enterprise storage server 130 may securely store the information received from one or more BOA devices 104 for longer periods of time to permit later use of the information. For example, the BOA device 104 may receive patient-identifying information such as name, address, and/or social security number via the patient charting device 108 or directly through the BOA device 104, and then may convey some or all of the patient-identifying information to enterprise storage server 126 with a request for the enterprise storage server 126 to query the database 130 for past records involving the same patient 116. The enterprise storage server 126 may then forward any such records or portions of such records back to the BOA device 104 (e.g. for display in the patient charting screen or the Past Medical History in the patch notes screen) to assist the EMS technician 114 with the current emergency. Similarly, such past EMS encounter record information may also be accessed by the enterprise user 124, according to embodiments of the present invention. A system administrator 134 may access and/or monitor the data in database 130 and/or modify the instructions of the servers 126, 128 via administration workstation 132, which may be communicably coupled to the servers 126, 128, according to embodiments of the present invention.

According to some embodiments of the present invention, the BOA device 104 may connect with (e.g. automatically or manually or selectively) a wearable medical device, such as, for example, a Lifevest® wearable defibrillator, to receive and display patient monitoring information therefrom. The BOA device 104 may also be configured to receive patient-identifying information from such a wearable device, to permit the BOA device 104 to query an external database, for example across network 120, to retrieve additional information about the patient. The BOA device 104 may also be configured to connect with an implantable cardioverter-defibrillator (“ICD”) in a similar fashion, according to embodiments of the present invention.

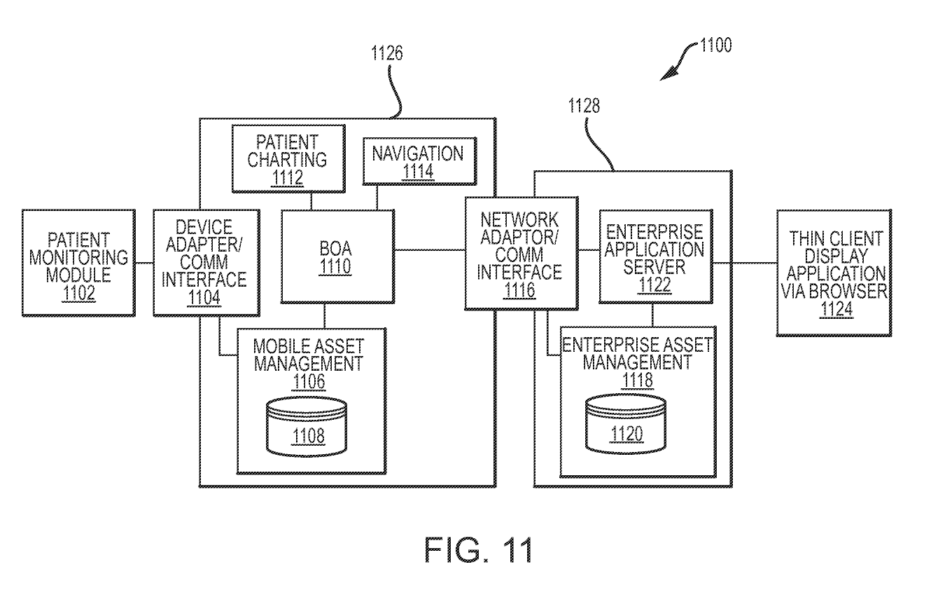

FIG. 11 illustrates a treatment domain system 1100 overview for real-time display of medical information collected from multiple different EMS devices, according to embodiments of the present invention. System 1100 includes a patient monitoring device module 1102 communicably coupled with mobile domain modules 1126 communicably coupled with remote or enterprise domain modules 1128 communicably coupled with a thin client display module 1124, according to embodiments of the present invention. According to embodiments of the present invention, the database 130 may be accessed by multiple hospitals throughout a region, state, country, and/or the world.

The mobile domain modules 1126 includes the device adapter 1104, a mobile asset management module 1106 which may access a mobile database 1108, a BOA module 1110, a patient charting module 1112, a navigation module 1114, and a network adapter 1116, according to embodiments of the present invention. The remote/enterprise modules 1128 include the network adapter 1116, an enterprise asset management module 1118 which may access an enterprise database 1120, and an enterprise application server module 1122, according to embodiments of the present invention.

The patient monitoring device module 1102 operates the patient monitoring device 106 and generates one or more data pipes containing information about a patient 116 condition. The device adapter/communication interface module 1104 manages data communications between a computing device and one or more medical devices such as, for example, between the patient monitoring device module 1102 and the mobile asset management module 1106 and/or BOA module 1110. The device adapter module 1104 includes one or more of the following attributes, according to embodiments of the present invention:
Supports multiple communications transports (e.g., devices can use Bluetooth, 802.11, Ethernet, Serial cable).
Supports multiple data transfer protocols.
Supports multiple medical device types.
Supports multiple data storage profiles (e.g., storage to file system, storage by asset management module 1106 to database 1108).
Allows administrator or user to associate transport, protocol, device and multiple storage profiles together to represent a communication “pipe” over which data can be exchanged with medical devices.
Supports multiple pipes at the same time.
Allows administrators or users to specify one or more specific medical devices to which it communicates in which case the module 1104 will use transport specific discovery protocols to find and attach to the devices.
Allows administrators or users to specify ANY as a medical device in which case it will use transport specific discovery protocols to find and attach to any compatible medical device found.
When a pipe is configured to use a protocol which does not support discovery (e.g. serial cable), module 1104 will allow the device to initiate the connection and then allow or deny it based on whether the specific medical device is selected or not.
Supports multiple client applications (local or remote) by allowing them to connect to module 1104 and receive asynchronous notification of data arrival from medical devices and a means to retrieve the data.
Maintains a communications ‘pipe’ should the medical device have a data asset to communicate, regardless of whether any application is running or ready to receive the data asset.
A user may configure the medical device(s) applications communicate with, and such configuration may be persistent and easily changed.
Communications policies may be configurable. For instance, Bluetooth may require pairing with a device before communications occur. A user may configure whether the pairing is ‘automatic’ or ‘manual’ or ‘continuously reacquired’, for example.
Applications may access previously received data assets via a relatively simple, expressive API.
Applications may be notified of newly received assets and may filter those notifications based on specific devices and/or asset type.
Applications may query the communications layer for status, available devices, and the like, for customizable user interface elements.
The communications layer may be controllable from a notification icon which also indicates status.
Configurable items may be protected from malicious or erroneous alteration by common users through the use of a privileged ‘admin’ mode and a common user mode in the notification area icon applet.
Configuration may be ‘portable’ and ‘distributable,’ such that one configuration may be created and copied to each device rather than having to actually configure each device through a notification applet.
Particular features or limitations of the communications ‘pipe’ may be hidden from the application by default.
The communications layer may itself be layered and support multiple plug-in style transport drivers for managing different communications transports and multiple plug-in style protocol drivers for handling the receipt of data assets from different devices and different asset types. This may allow for the rapid extension of the communications layer to new transports or to new protocols as they are developed.

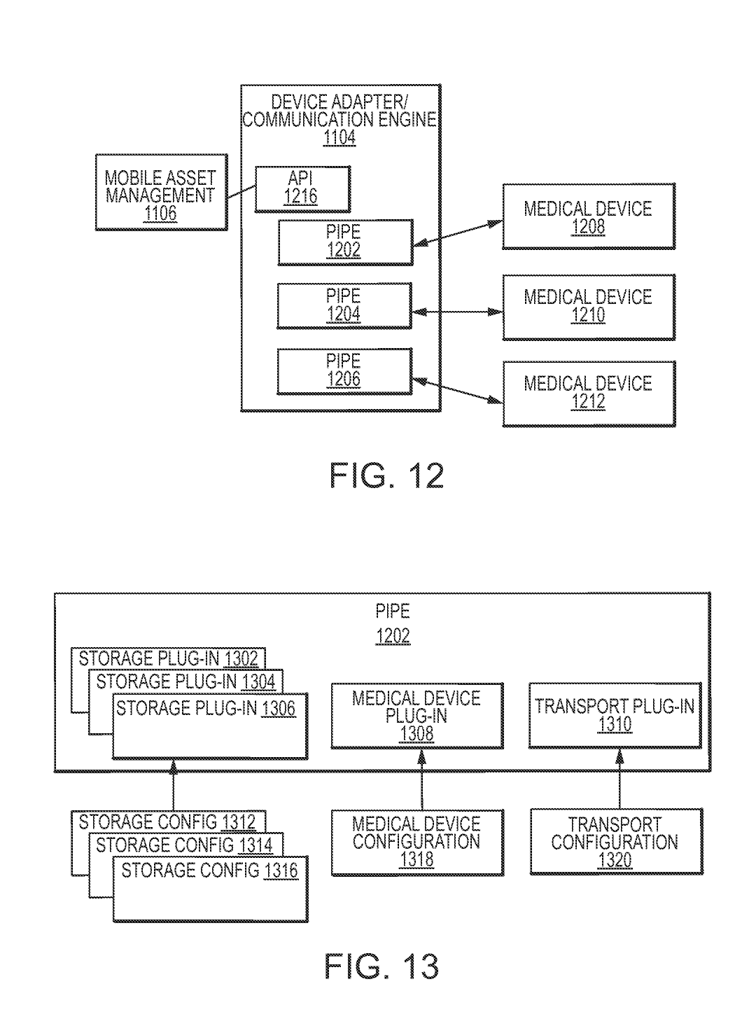

FIG. 12 illustrates a diagram of the device adapter/communication module 1104, which includes one or more pipes 1202, 1204, 1206 each associated with a medical device 1208, 1210, 1212. The communication module 1104 may be a PELICAN™ communication interface available from Zoll Data Systems of Broomfield, Colo., according to embodiments of the present invention. According to embodiments of the present invention, the communication engine 1104 is an “always on” operating system service which implements the communications pipes 1202, 1204, 1206 and handles the incoming data from medical devices 1208, 1210, 1212. Communication engine 1104 also includes an API 1216, which is a collection of objects and methods exposed by the communications engine 1104 which can be used by an application to configure and interact with the engine 1104 for tasks like getting data assets and configuring the engine 1104, according to embodiments of the present invention. For example, the mobile asset management module 1106 may interact with the API 1216 to receive medical device data.

FIG. 13 illustrates a diagram of pipe 1202, according to embodiments of the present invention. Pipe 1202 includes one or more storage plug-ins 1302, 1304, 1306 associated with one or more storage configurations 1312, 1314, 1316 of the medical device; a medical device plug-in 1308 associated with a medical device configuration 1318 of the medical device, and a transport plug-in 1310 associated with a transport configuration 1320 of the medical device, according to embodiments of the present invention. As used herein, a “transport” is an operating system supported underlying communications medium, for example TCP/IP, Bluetooth, and Serial. Some transports are packet oriented (e.g. TCP) while others are stream oriented (e.g. Serial). Some support discovery, some do not. Some support pairing, some do not. Each transport may include unique configurations.

A transport plug-in may be a .NET assembly that is dynamically loaded by the communications engine 1104 and which provides data communications support for a specific transport (e.g. Serial Port, Bluetooth, TCP/IP, and File System). The communications engine 1104 may be configured for auto-pairing (e.g. for transports that support pairing, the engine 1104 uses rules specific to the transport to automatically create and maintain pairings with medical devices depending on configuration and user preference) and/or for auto-discovery (e.g. for transports that support discovery, the engine 1104 may be configured to automatically find new medical devices and enter them into the known device list), according to embodiments of the present invention.

A medical device plug-in may be a .NET assembly that is dynamically loaded by the communications engine 1104 which provides transport independent data communications services for a particular type of medical device, for example ZOLL M/E-Series ZOLLModem or ZOLL E-Series DUN. A storage plug-in may be a .NET assembly that is dynamically loaded by the communications engine 1104 which provides storage services to the engine.

As shown in FIG. 13, a pipe may be a combination of transport, medical device, and storage configurations which represent a medical device from which the user has indicated data will be received, and which allows communications to occur. Pipes may be configured by the user and/or may be predefined. For example, a pipe may specify Transport Serial Port with configuration (COM1, Baud=9600), Medical Device E/M Series ZOLLModem (Any Medical Device) and Storage (Local File System). This configuration would accept data assets from any device connected to COM1 at 9600 baud and store them to the local file system. As another example, a pipe may specify Transport Bluetooth (Baud=115200, Auto-Pair), Medical Device E/M Series ZollModem (ZOLL005611), Storage (Local File System) and Storage (Asset Management). This configuration would cause Bluetooth to pair to ZOLL005611, maintain that pairing even when broken and accept any data assets from that specific device and store them both to the local file system and submit them to Asset Management (e.g. mobile asset management module 1106 and/or enterprise asset management module 1118).

As yet another example, a pipe may specify Transport Bluetooth (Baud=115200, Auto-Pair), Medical Device E/M Series ZOLLModem (Any Device). This configuration would cause Bluetooth to automatically pair with any medical device found during periodic discovery and accept any data assets from any paired device and store them via all loaded and enabled storage plug-ins. As yet another example, a pipe may specify Transport TCP/IP (LocalIP=192.168.1.20, Port=7743), Medical Device E/M Series DUN (Any Device), Storage (Asset Management). This configuration would cause the engine 1104 to start listening on the specified IP address and port for DUN traffic and store it via Asset Management (e.g. by sending it to mobile asset management module 1106 and/or enterprise asset management module 1118), according to embodiments of the present invention.

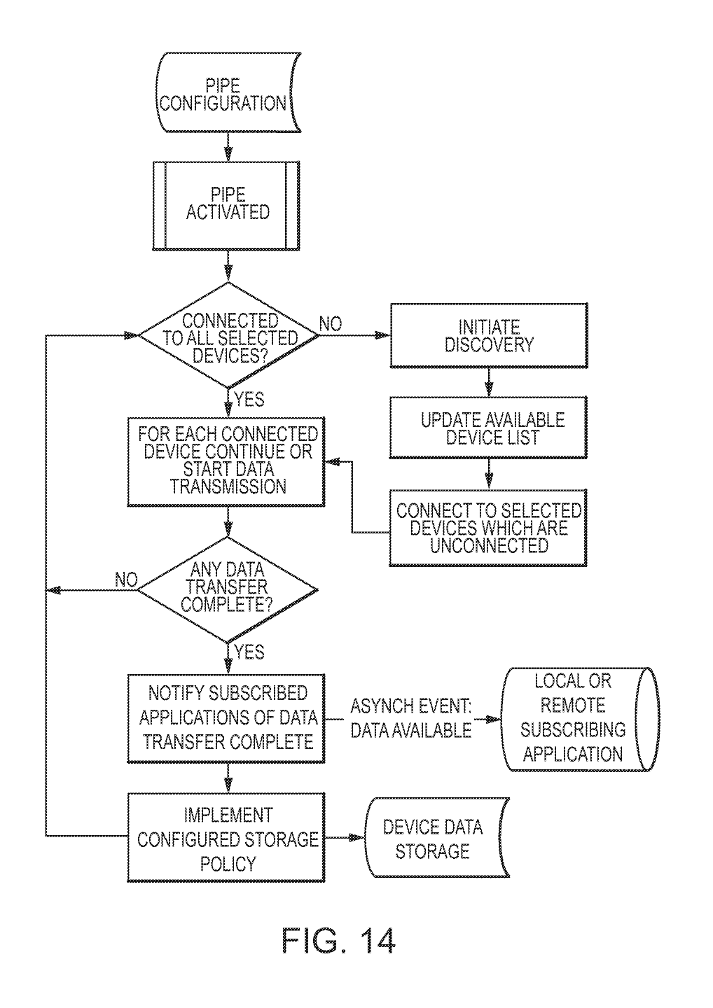

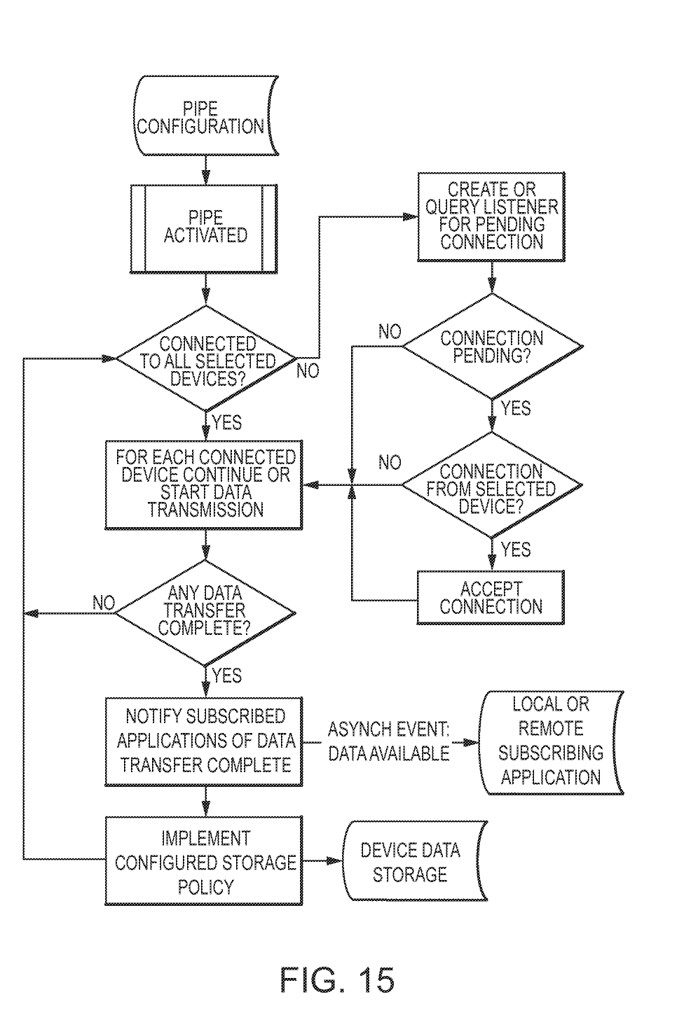

For each “pipe” of device adapter 1104 that uses Discovery Supporting Transport, the adapter 1104 performs the method outlined in FIG. 14, and for each pipe of device adapter 1104 that uses Non-Discovery Supporting Transport, the adapter 1104 performs the method illustrated in FIG. 15, according to embodiments of the present invention.

As described above, the mobile asset management module 1106 receives medical device data from the device adapter and communications interface 1104, according to embodiments of the present invention. The mobile asset management module 1106 performs the secure storage, retrieval and management of medical device data together with asynchronous events informing other applications of the storage or modification of these data assets. The mobile asset management module 1106 supports local or remote service oriented API to store, retrieve and modify medical device data, and provides local or remote asynchronous message-based notification of events to applications which subscribe for them, according to embodiments of the present invention. These events may include notification of the arrival of medical device data.

The BOA module manages data feeds from multiple data providers (including but not limited to, the device adapter 1104, the patient charting module 1112, and the navigation module 1114) and presents these feeds on a touch-screen flat panel, according to embodiments of the present invention. The BOA module 1110 also communicates these aggregated data elements to a back-office module (e.g. the enterprise asset management module 1118). The patient charting module 1112 controls the patient charting device 108 and the information sent and received by it, and the navigation module 1114 controls the navigation device 110 and the information sent and received by it, according to embodiments of the present invention. The BOA module 1110 includes one or more of the following attributes, according to embodiments of the present invention:
Allows the user to configure the device adapter/communication interface module 1104, including but not limited to selection of a medical device.
Allows the user to select a patient charting device from which it will receive a data feed containing medical record information as it is entered in patient charting device.
Allows the user to select a navigation device from which it will receive a data feed containing navigational and dispatch information on a periodic basis.
Receives notification from the communication interface module 1104 and/or the mobile asset management module 1106 about the arrival of new medical device data including but not limited to 12-lead ECG and vital trend records.
Receives asynchronous messages from a selected patient charting device which contain data about the currently open patient record including but not limited to: patient demographics, medical history, current assessments, interventions performed and/or vital signs.
Receives asynchronous messages from a selected navigation device which contains data about the current dispatch state, destination, crew, location, route and/or map of current position.
Cyclically presents a graphic display of each of the received data feeds for viewing in the back of the ambulance on the flat panel, or elsewhere on another display device.
Allows the caregiver or EMS technician 114 to temporarily freeze the cycling display on a feed for more careful examination of that particular data in that particular information template.
Aggregates the data feeds into a data construct which is sent periodically to the enterprise asset management module 1118.
Presents a customer customizable view of the aggregated data feed for the purpose of facilitating a verbal report to the receiving facility (e.g. a report in the Patch Notes information template displayed on the BOA device 104).
Presents the user with the ability to view the regional EMS protocols for reference.

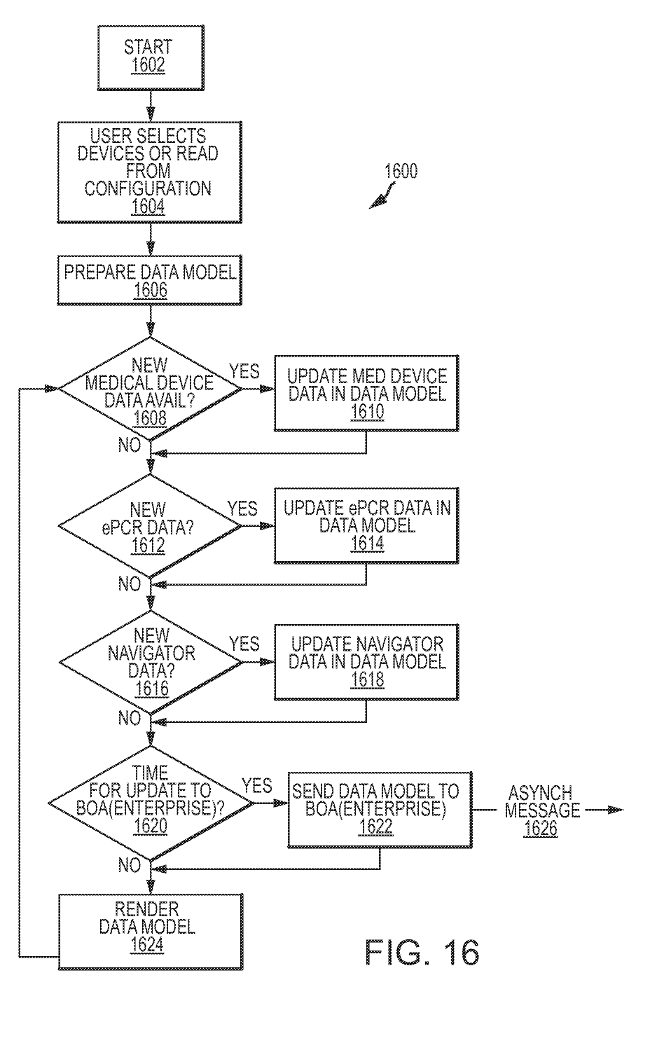

FIG. 16 illustrates a logic flow chart 1600 executed by the BOA module 1110, according to embodiments of the present invention. The logic flow chart 1600 starts at block 1602. A user selects particular devices or selects a “read from” configuration to determine which devices' data will be read and displayed by the BOA device 104 (block 1604). A data model is prepared (block 1606), for example the current state of the system that will be displayed on the BOA device 104 and which may eventually be communicated to the enterprise environment 102 and/or enterprise application server 128. The data model may expand to contain other data elements as feeds are added, and may contract to eliminate container properties for unused data feeds (e.g. installations that do not include a patient charting device 108), according to embodiments of the present invention. The BOA module 1110 queries the mobile asset management module 1106 to determine whether new medical device data is available (block 1608) and, if so, updates the medical device data in the data model (block 1610). The BOA module 1110 queries the mobile asset management module 1106 to determine whether new patient charting data is available (block 1612) and, if so, updates the patient charting data in the data model (block 1614).

The BOA module 1110 queries the mobile asset management module 1106 to determine whether new navigation data is available (block 1616) and, if so, updates the navigation data in the data model (block 1618). The BOA module 1110 determines whether it is time to send updated information to the enterprise asset management module 1118 (block 1620) and, if so, sends the data model to the enterprise asset management module (block 1622) and generates an asynchronous message (block 1626). According to embodiments of the present invention, the asynchronous message generated at block 1626 is destined for the enterprise application server 128; according to alternative embodiments of the present invention, the asynchronous message generated at block 1626 is destined for the enterprise storage server 126 which, in turn, stores the data and notifies the enterprise application server 128 of the data's availability. The data model is then rendered (block 1624), for example in the form of a display update on the BOA device 104, according to embodiments of the present invention. According to embodiments of the present invention, the procedures indicated by blocks 1608, 1612, 1616, and 1620 are not executed as “stages” but are instead each events which trigger a different thread of execution that modifies a data model, which in turn triggers the update of the BOA device 104 display.

The network adapter/communication interface module 1116 is a communications channel that includes one or more of the following attributes, according to embodiments of the present invention:
General purpose and data format independent. Each application may be responsible for the format of its messages.
Message addressing may be by name rather than transport address (IP address for instance) so that messages can be sent to entities for which no route currently exists (e.g. when the sender is disconnected from the Internet). Name resolution into actual machine address may be deferred until a route actually exists.
Tree relationship between entities that use communication interface module 1116, in which name information may be “percolated” up the tree but not down. As such, each node has a simple routing choice: if the name is the current device or below, route there, otherwise route to the current device's parent. The root of the tree may be the primary message broker and it accumulates all name information. The primary message broker is the unique node in the communications tree which contains all name information and thus can perform routing from one sub-tree to another, according to embodiments of the present invention.
Message delivery may be deferred until the recipient actually appears. Messages may be stored until the recipient becomes routable.
Messages may be stored in a transaction safe database at each node so that even a node unexpectedly failing does not risk message loss.
Full encryption of messages may be maintained until the recipient actually receives them. While stored in databases, the messages may remain encrypted.
Robust operation over intermittently connected wireless connections.

Messages may be stored until a connection is resumed. Within certain time-limits, if the connection is restored, message transmission may continue from where it left off rather than starting anew.
Messages intended for machines or applications that are ‘local’ may be routed locally even when that segment of the tree is disconnected from the primary message broker.
Messages may be sent with an expiration time after which the message will not be delivered and the sender may be notified of the expiration.

The communications interface 1116 may be a MERCURY™ communication interface available from Zoll Data Systems of Broomfield, Colo., according to embodiments of the present invention.

The messaging components for the BOA module 1110 may be implemented using the communication interface module 1116 as a channel. These messaging components implement one or more of the following characteristics, according to embodiments of the present invention:
Publish-Subscribe Model: The data feed consumers (e.g. the BOA mobile module 1110) subscribe with the providers (e.g. the patient charting module 1112) to receive the data feed. The subscription request includes the duration of the subscription. As the providers modify the data feed items, the data feed items are sent to all subscribers. According to embodiments, the BOA module 1110 is a data feed consumer for feeds from the patient charting module 1112 and the navigation module 1114 but a data feed provider for the aggregated feed going to the enterprise asset management module 1118.
Message Queue Throttling: Using the message expiration feature of the communications interface module 1116, all messages may be sent with a short expiration time and then a new, current copy is sent upon expiration notification. This keeps the system from having a large queue of stale data feed messages when components are disconnected; at most, one current message is in the system.
Complex message format: The data feed messages include graphical, textual and binary data which may be turned into objects by the recipient for ease of use.

The enterprise asset management module 1118 receives an aggregated data feed from multiple BOA modules 1110 and provides presentation of those aggregated data feeds on displays remote from the originating ones. For example, such aggregated data feeds may be fetched from the database 1120 associated with the enterprise asset management module 1118 by the enterprise application server module 1122 and displayed to an enterprise user via a thin client display application module 1124 running on a web browser, according to embodiments of the present invention. Such a web page may be secured, encrypted, password-protected, and/or HIPAA compliant, according to embodiments of the present invention. The enterprise asset management module 1118 includes one or more of the following attributes, according to embodiments of the present invention:
Receives asynchronous messages from multiple BOA modules 1110 containing aggregated data feeds including but not limited to data feeds from patient charting modules 1112, navigation modules 1114, and medical devices.
Uses destination data from the BOA module 1110, set either by the navigation module 1114 or manually by the user on the flat panel BOA device 104, creates a web page for each hospital destination containing the feeds from each BOA module 1110 with that hospital as the destination.
Asynchronously updates the web page as new versions of the aggregated data feeds arrive for each BOA module 1110 sending data regarding a patient 116 en route to the hospital or treatment facility.
Renders the aggregated data feeds with diagnostic resolution of the 12-Lead data.
Prevents unauthorized access by employing hospital specific logins to the secured EMS data feed web page module 1124.

Although FIG. 1 illustrates the BOA device 104 communicably coupled with a patient monitoring device 106, a patient charting device 108, and a navigation device 110, in alternative embodiments of the present invention the BOA device 104 is communicably coupled with additional EMS-related devices not shown in FIG. 1, and/or is communicably coupled with multiple devices of the kind shown in FIG. 1, and/or is communicably coupled with different models or versions of the devices of the kind shown in FIG. 1. For example, the BOA module 1110 may be configured to communicate EMS-related device data to and from, either directly and/or indirectly via a device adapter/communication interface module 1104, one or more of the following devices: a defibrillator, a patient charting device, a navigation device, a GPS device, a pulse oximeter, an automatic cardiopulmonary resuscitation device (e.g. Autopulse® non-invasive cardiac support pump), a driver safety monitoring system, a standalone blood pressure monitor, a blood glucose measurement device, an inventory control system, a blood alcohol monitor, a breathalyzer instrument, and a crew scheduling system. A defibrillator or patient monitoring device may be one of a broad range of defibrillators or patient monitoring devices made and/or sold by a number of different manufacturers, according to embodiments of the present invention. The BOA device 104 may also be communicably coupled with, and configured to aggregate with patient data, data obtained from a CodeNet Writer™ device manufactured by Zoll Medical Corporation, or the like, according to embodiments of the present invention.

According to embodiments of the present invention, the BOA device 104 is communicably coupled to only one or two of the patient monitoring device 106, the patient charting device 108, and the navigation device 110, and is configured to organize and display EMS information from only the one or two such devices.

Although the modules and applications described with respect to FIG. 11 can roughly correspond to the hardware devices with similar designations in FIG. 1, one of ordinary skill in the art, based on the disclosure provided herein, will understand that the various modules and/or instructions for performing the described procedures may be located on different and various hardware devices and/or on hardware devices not depicted, in different combinations, according to embodiments of the present invention. For example, although the BOA device 104 may be a touch-screen PC including and configured to perform the tasks of the BOA module 1110, the BOA device 104 may alternatively be a simple display device such as a monitor, with the computational functions of the BOA module 1110 and/or mobile asset management module 1106 performed by other hardware, such that only the display information is communicated to the BOA device 104, according to embodiments of the present invention.

The BOA device 104 according to embodiments of the present invention may be configured to facilitate data entry via a touch screen device with software that permits rapid and easy data entry, similar to the Quicklog capability of the Zoll Data Systems RescueNet® ePCR Suite. In addition, the BOA device 104 may be configured to permit selection and display of patient monitoring data (e.g. 12-lead ECG data) from prior transports and/or other agencies retrieved from mobile database 118 and/or enterprise database 130, according to embodiments of the present invention. Such historical and/or shared patient data may also be made available to hospitals, and/or stored by hospitals or other care institutions as part of a data management program. The BOA device 104 may also be configured to display streaming ECG information similar to the “live” display of such information by a defibrillator device, for example. The BOA device 104 may also be configured to display feedback to the EMS technician 114 about cardiopulmonary resuscitation being performed, to evaluate the CPR technique during and/or after it is administered. According to embodiments of the present invention, the BOA device 104 may be configured to communicably couple with and receive information from an accelerometer and/or other CPR evaluation device, such as a device configured to detect the presence of and/or the timing of and/or the depth/displacement of and/or the velocity of and/or the acceleration of chest compressions, for example the devices and methods described or referenced in U.S. Pat. No. 6,390,996 issued on May 21, 2002, U.S. Pat. No. 6,827,695 issued on Dec. 7, 2004, U.S. Pat. No. 7,122,014 issued on Oct. 17, 2006, and U.S. Pat. App. Pub. No. 2006/0009809 published on Jan. 12, 2006, which are incorporated by reference herein in their entireties.

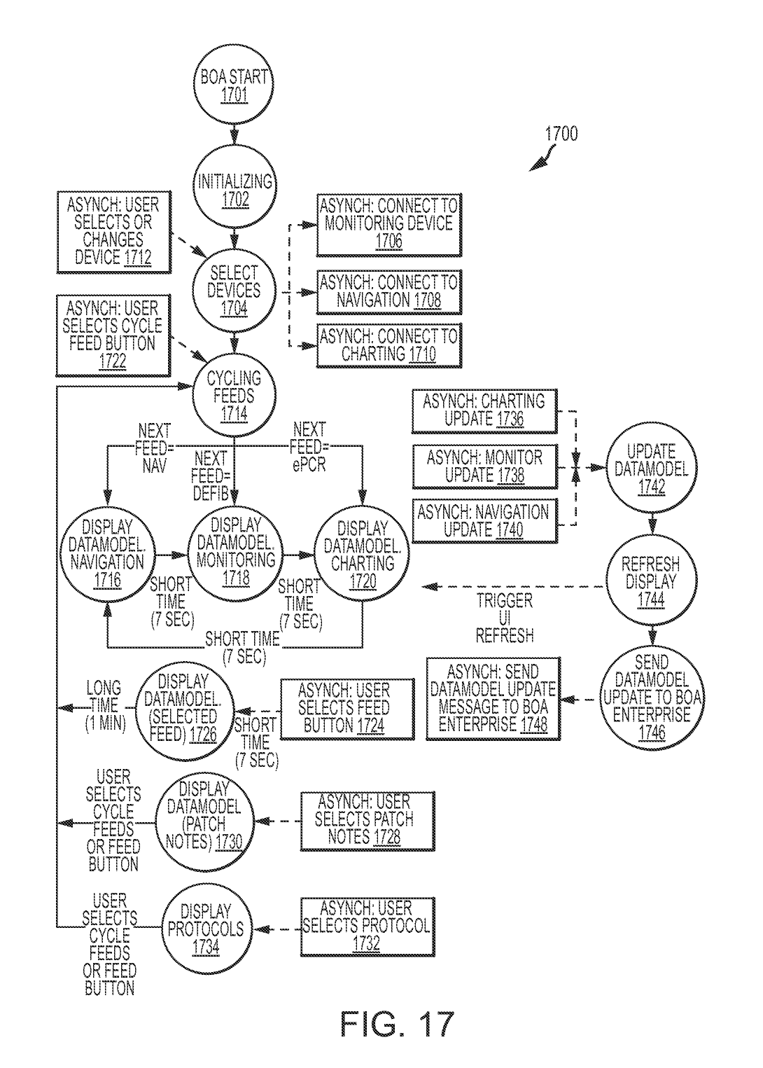

FIG. 17 depicts a flow chart 1700 illustrating a method performed by BOA module 1110, according to embodiments of the present invention. The process begins at block 1701. The BOA module 1110 is initialized (block 1702), and the user may then select devices (block 1704) from which medical and/or EMS information will be received. For example, such device selection may involve generating an asynchronous message to be received by the patient monitoring module 1102 for establishing a connection (block 1706), an asynchronous message to be received by the navigation module 1114 for establishing a connection (block 1708), and/or an asynchronous message to be received by the patient charting module 1112 for establishing a connection (block 1710). A different subset of devices (different devices, fewer devices, or more devices) may be selected at any time when the user initiates an asynchronous event to select or change devices (block 1712).

Once devices have been selected, the BOA device 104 cycles through a series of different displays (block 1714). This cycling may be programmed to occur at preset intervals; for example, the BOA device 104 may be configured to cycle the display between different data models every seven seconds. For example, a navigation device data model may be displayed (block 1716), which may be similar to the data model depicted in FIG. 3, for example. After a preset time, the display may be switched to a patient monitoring device data model (block 1718), similar to the data model depicted in FIG. 4, for example. After another preset time, the display may be switched to a patient charting device data model (block 1720), similar to the data model depicted in FIG. 5, for example. Once the display has cycled through each data model, it may return to the first data model displayed and repeat the cycle, according to embodiments of the present invention. Such a cycling may be initiated or re-initiated during other tasks when the user initiates an asynchronous event (block 1722) by selecting the cycle feed button (similar to the button 318 of FIG. 3), for example.

When a user selects one of the “feed” buttons (block 1724), an asynchronous event is generated causing the data model corresponding to that feed to displayed (block 1726) for a longer predetermined period of time, for example one minute. As an example, if the user selects the patient charting button 206 (see FIG. 2), the patient charting data model similar to FIG. 5 will immediately be displayed and will remain displayed for a period of time longer than the default cycle time. When a user selects the patch notes button 208 (block 1728), an asynchronous event is generated causing the patch notes data model similar to FIG. 6 to be displayed (block 1730) until the user next selects the cycle feeds button 318 or a particular feed button 202, 204, 206, according to embodiments of the present invention. When a user selects the protocols button (block 1732), an asynchronous event is generated causing the protocols data model similar to FIG. 7 to be displayed (block 1734) until the user next selects the cycle feeds button 318 or a particular feed button 202, 204, 206, according to embodiments of the present invention.

When one of the EMS devices receives or generates new data, it may be configured to generate an asynchronous notification to be received by the BOA module 1110, according to embodiments of the present invention. For example, the patient charting module 1112 may generate an asynchronous message when it has new information to share (block 1736), the patient monitoring module 1102 may generate an asynchronous message when it has new information to share (block 1738), and the navigation module 1114 may generate an asynchronous message when it has new information to share (block 1740), according to embodiments of the present invention. These asynchronous messages may include within them the new or updated data itself. When the BOA module 1110 receives one or more of these notifications, it updates the data model or data models that correspond to the particular device and/or information received (block 1742). For example, if new patient charting information is received from the patient charting module 1112 (which may be running on the patient charting device 108), the BOA module 1110 will update the patient charting data model to reflect the most recent data. The BOA module 1110 then refreshes its display (block 1744), which results in the currently displayed data model being replaced with the new data model immediately if any data in the data model was updated in block 1742. The data model update may then be sent to the BOA enterprise module which may reside on enterprise application server 128 (block 1746), which may result in an asynchronous message being generated to the BOA enterprise module (block 1748), according to embodiments of the present invention.

Some embodiments of the present invention include various steps, some of which may be performed by hardware components or may be embodied in machine-executable instructions. These machine-executable instructions may be used to cause a general-purpose or a special-purpose processor programmed with the instructions to perform the steps. Alternatively, the steps may be performed by a combination of hardware, software, and/or firmware. In addition, some embodiments of the present invention may be performed or implemented, at least in part (e.g., one or more modules), on one or more computer systems, mainframes (e.g., IBM mainframes such as the IBM zSeries, Unisys ClearPath Mainframes, HP Integrity NonStop servers, NEC Express series, and others), or client-server type systems. In addition, specific hardware aspects of embodiments of the present invention may incorporate one or more of these systems, or portions thereof.

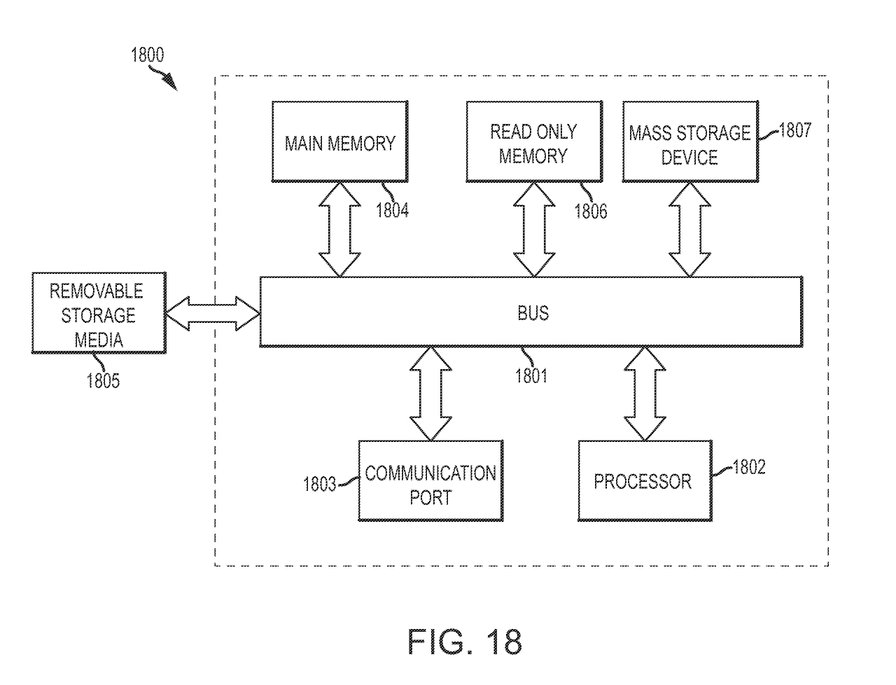

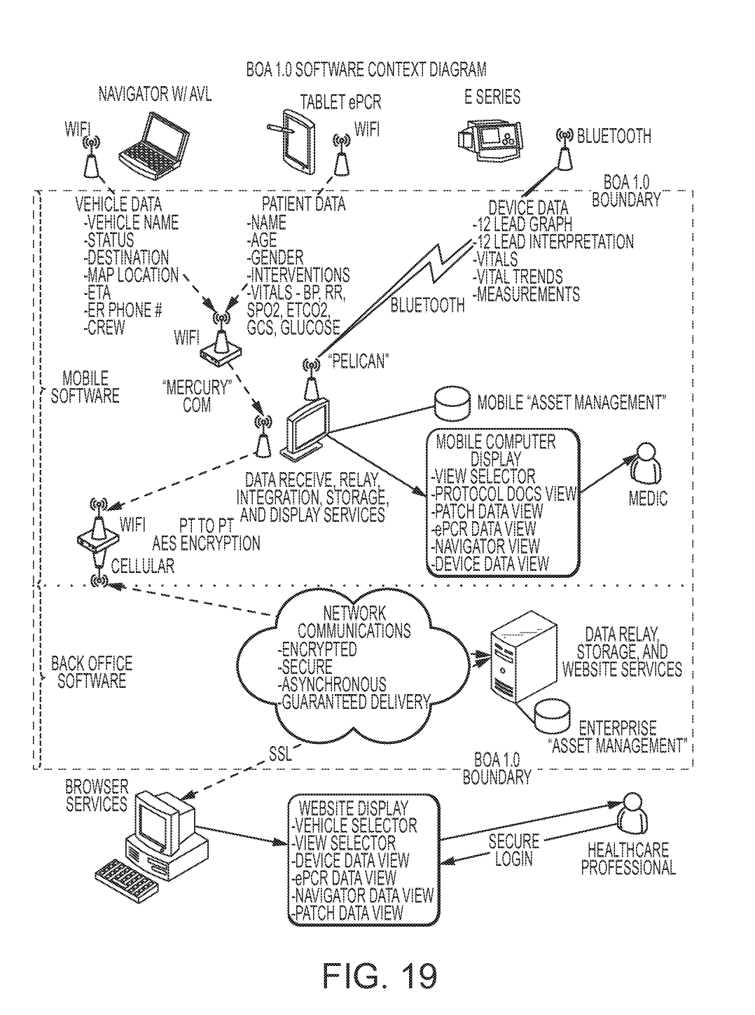

As such, FIG. 18 is an example of a computer system 1800 with which embodiments of the present invention may be utilized. According to the present example, the computer system includes a bus 1801, at least one processor 1802, at least one communication port 1803, a main memory 1804, a removable storage media 1805, a read only memory 1806, and a mass storage 1807.

Processor(s) 1802 can be any known processor, such as, but not limited to, an Intel® Itanium® or Itanium 2® processor(s), or AMD® Opteron® or Athlon MP® processor(s), or Motorola® lines of processors. Communication port(s) 1803 can be any of an RS-232 port for use with a modem based dialup connection, a 10/100 Ethernet port, or a Gigabit port using copper or fiber, for example. Communication port(s) 1803 may be chosen depending on a network such a Local Area Network (LAN), Wide Area Network (WAN), or any network to which the computer system 1800 connects. Main memory 1804 can be Random Access Memory (RAM), or any other dynamic storage device(s) commonly known to one of ordinary skill in the art. Read only memory 1806 can be any static storage device(s) such as Programmable Read Only Memory (PROM) chips for storing static information such as instructions for processor 1802, for example.

Mass storage 1807 can be used to store information and instructions. For example, hard disks such as the Adaptec® family of SCSI drives, an optical disc, an array of disks such as RAID (e.g. the Adaptec family of RAID drives), or any other mass storage devices may be used, for example. Bus 1801 communicably couples processor(s) 1802 with the other memory, storage and communication blocks. Bus 1801 can be a PCI/PCI-X or SCSI based system bus depending on the storage devices used, for example. Removable storage media 1805 can be any kind of external hard-drives, floppy drives, flash drives, IOMEGA® Zip Drives, Compact Disc-Read Only Memory (CD-ROM), Compact Disc-Re-Writable (CD-RW), or Digital Video Disk-Read Only Memory (DVD-ROM), for example. The components described above are meant to exemplify some types of possibilities. In no way should the aforementioned examples limit the scope of the invention, as they are only exemplary embodiments.

Embodiments of the present invention may be configured to achieve various other solutions in an emergency medical services environment. For example, the BOA device 104, in communication with the navigation device 110, may be configured to provide additional mapping and/or navigation information. The BOA device 104 may display status information about a hospital destination, and may indicate diversion or alternative destinations to direct the ambulance 101 to an appropriate destination, according to embodiments of the present invention. The BOA device 104 may also display characteristics about hospitals and/or other destinations, such as the hospital's capabilities (e.g. heart specialty, burn specialty), insurance accepted, patient capacity and current patient capacity status, according to embodiments of the present invention. The BOA device 104 may also be in communication with the enterprise workstation 122 of the hospital or other destination to permit preregistration or partial preregistration of the patient 116. According to embodiments of the present invention, a hospital without availability shows up for the ambulance driver 112 as not available. The BOA device 104 may be configured to display such information simultaneously with a map and/or during navigation, to facilitate destination selection. This information may be obtained over the network 120 from an enterprise server 126 or 128 and/or from an enterprise workstation 122 and/or from the navigation device 110, according to embodiments of the present invention.

The BOA device 104 may also be configured to communicate in various ways with the user, including with the EMS driver 112 and/or the EMS technician 114, according to embodiments of the present invention. For example, the BOA device 104 may be configured to provide audio prompts, alarms, scheduling, timing, and/or audio streams to EMS users. The BOA device 104 may be configured with Bluetooth® connectivity or capability, such that a user may connect or pair a unique Bluetooth® device with BOA 104 to receive audio information and/or to communicate voice prompts. An alarm may be configured to sound or to display visually upon a triggering event, for example upon receipt by the BOA device 104 of an asynchronous event signal from a sensor indicating that a detected parameter is outside an acceptable range or value, according to embodiments of the present invention. Audio and/or visual cues may be used to alert a user to a particular dosage schedule, for example beeping when a certain amount of time has elapsed since a first administration of a drug. Such alarms and/or schedules may be set or customized by the users, or may be selected from a predetermined set of alarm and scheduling options, according to embodiments of the present invention.

According to embodiments of the present invention, the BOA device 104 may provide role-based data and/or audio streams; for example, a technician administering CPR may receive audio and/or visual information about the patient's cardiac condition, but the BOA device 104 may filter out other information such as mapping and/or routing information for that user. Private, customized feedback and/or information may be provided to EMS users based on their roles, according to embodiments of the present invention.

The BOA device 104 may further provide decision support for an EMS technician, according to embodiments of the present invention. Based on information entered by the technician 114 (e.g. via a patient charting device 108) and/or information received from a patient monitoring device 106, BOA device 104 may compare the information with internal or external databases to display or otherwise convey a differential diagnosis, and/or predictive diagnosis (e.g. based on vectors or EKG information), according to embodiments of the present invention. For example, the BOA device 104 may present the EMS technician 114 with a decision matrix based on symptoms and/or responses to treatments to help the EMS technician 114 determine, for example in an interactive format, a potential diagnosis. The BOA device 104 may provide protocols or links to protocols based on the information received, either from the technician 114 or from one of the devices with which it is in communication.

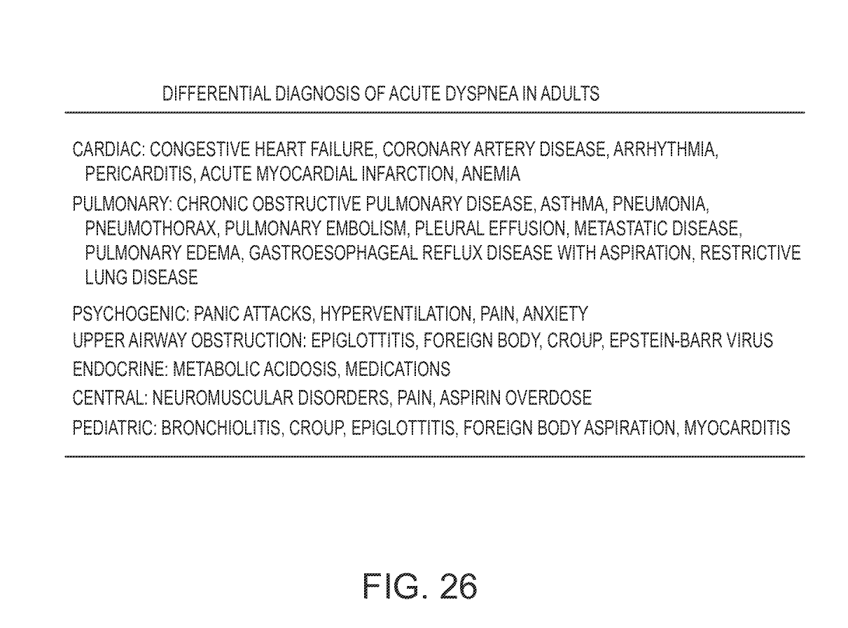

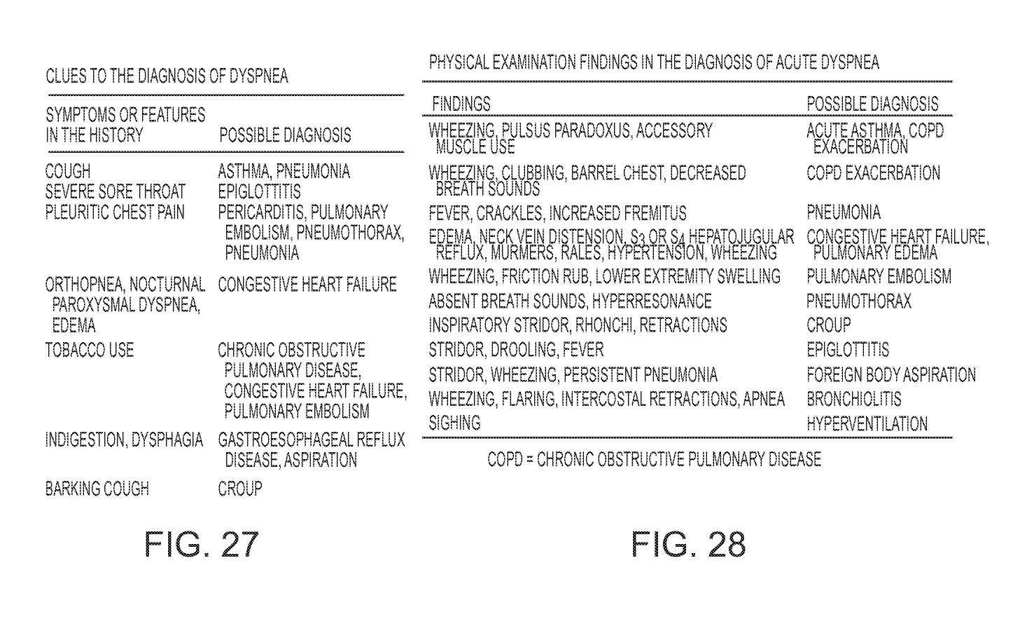

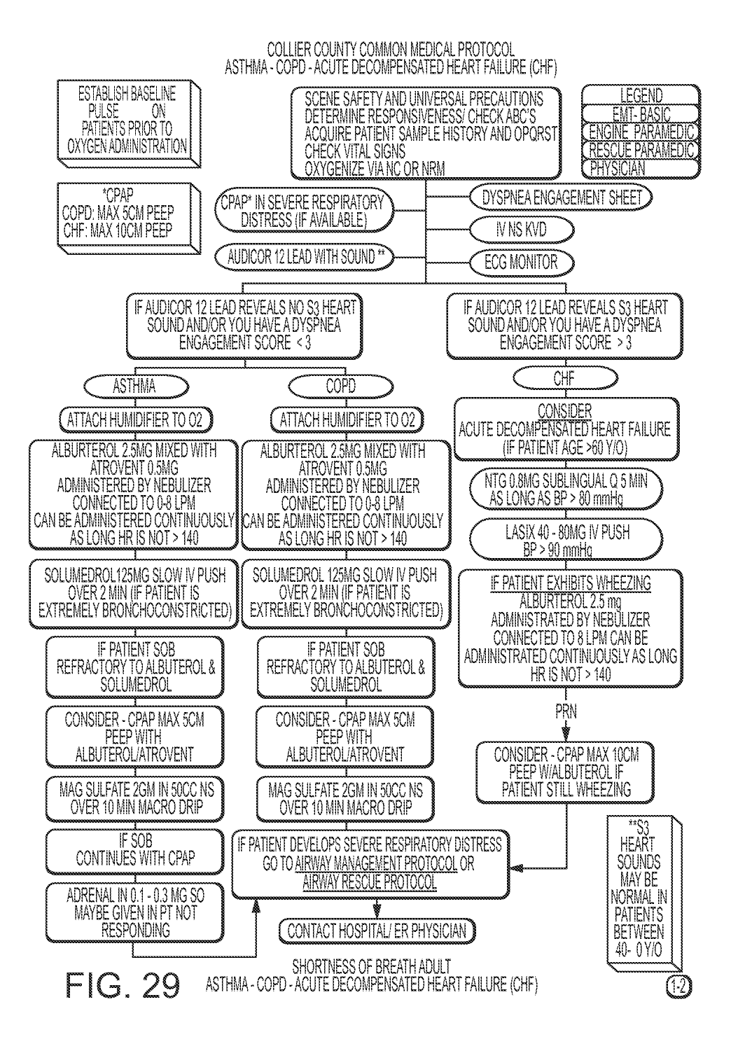

In one embodiment, the data for the patient's history may be entered via the BOA device 104 with patient physiological measures via the monitor of BOA device 104. As the differential diagnosis requires both patient history, patient examination findings, and measures of the patient's physiological state via such monitoring as ECG, capnography and pulse oximetry, these data elements are integrated into a user interface that automatically or semi-automatically integrates the various data elements on a single differential diagnosis screen within the application on the BOA device 104, according to embodiments of the present invention. The interface of BOA 104 begins by asking the rescuer to choose from a list of common presenting symptoms or complaints by the patient, e.g. dyspnea or respiratory distress. The information such as on the screens illustrated in FIGS. 26-28 (taken directly from Am Fam Physician 2003; 68:1803-10, which is incorporated by reference herein) and FIG. 29 (taken directly from the Collier County Common Medical Protocol, revised Feb. 1, 2008), provides a structured approach for rescuers to obtain information. As patient history and physical examination findings are entered into the BOA device 104, the differential diagnosis page may gradually narrow down the possible diagnoses. Heart sound measurement and detection may be incorporated into the monitoring device 106 for the detection of S3 and S4 heart sounds and automatically narrow the differential, or suggest for the rescuer to confirm agreement with the software diagnosis, of heart failure or pulmonary edema. A flowchart for incorporating heart sounds is shown in FIGS. 26-29. Pulse oximetry and capnography are also very helpful measures and may be automatically incorporated into the algorithm for more accurate diagnosis.

In one embodiment, rescuers may be able to simply touch the cursor to the history or physical exam findings listed as possible from the screen-displayed lists of FIGS. 26-29, thereby minimizing unnecessary keying inputs. At the bottom of each list of possible findings or history is a data entry position for “Other”, for those findings or history which are not normally consistent with the presenting condition. In one embodiment, these additional findings, history or physiological measurements can be compared with a larger differential diagnosis database to suggest other possibilities to the rescuer based on a calculated probability or if the other possible causes have been ruled out, according to embodiments of the present invention.

In much the same way that twelve-lead data and other BOA 104 device data may be sent to an enterprise environment 102 and displayed and/or retrieved on an enterprise workstation 122 or web-based environment, the BOA device 104 may also be configured to receive, display, and/or store similar information from an enterprise environment 102, according to embodiments of the present invention. For example, in a situation in which a patient is being transported from one hospital to another to receive specialized care, the hospital may send to the BOA device 104 information about the patient's vitals and/or health history and/or physician recommendations. Alternatively, the hospital may grant electronic authorization for the remote EMS technician to query its database or databases where such information is kept, to enable the EMS technician 114 to select, using the BOA device 104 interface, which and how much information he would like to receive. In this way, technicians in an ambulance 101 can see what is happening to a patient at the hospital, for example.

The BOA device 104 may also include speech recognition software and/or text-to-speech software, according to embodiments of the present invention. As such, the BOA device 104 may provide an audio signal that reads text or numeric data received from one or more devices, to convey the data to the EMS technician 114 audibly, such that the EMS technician 114 need not divert visual attention from the patient or from another task, according to embodiments of the present invention. The BOA device 104 may also recognize voice command prompts, to enable the user to operate the BOA device 104 by voice instead of having to divert manual attention from the patient or the task at hand, according to embodiments of the present invention.

The BOA device 104 also be configured to retrieve audio data stored on a device, such as a patient monitoring device 106, to help the EMS technician 114 in treatment or diagnosis, and/or for storage, technician evaluation, quality control, or later playback. For example, the patient monitoring device 114 may be a defibrillator that records a continuous audio stream; the BOA device 104 may access the continuous audio stream and permit selective play back of certain portions and/or transmit the audio stream or audio file for remote access or storage, according to embodiments of the present invention. The BOA device 104 may also be configured to receive audio information from a patient monitoring device 106 or other device even before the EMS technician 114 has reached the patient, to help the EMS technician 114 to prepare for the scene.

The BOA device 104 may be configured to connect with a video monitoring device, for example a webcam, or a standalone video camera, and/or a video capture device that is mounted on or part of another device to which the BOA device 104 connects, according to embodiments of the present invention. For example, a video or still camera mounted in the back of an ambulance 101 may provide visual data to BOA 104 for storage and/or transmission and/or retransmission to the enterprise environment 102 and/or the administration environment 103. Such a video feed may permit a physician waiting at a hospital to view the patient's status before the patient arrives, for example.

With an ability to connect with and interface multiple EMS-related devices, both clinical and non-clinical, and aggregate such EMS-information (both clinical and non-clinical) from multiple devices, the BOA device 104 may also be configured for inventory monitoring and control. For example, the BOA device 104 may be communicably coupled with a bar code scanner, a radio frequency identification (“RFID”) receiver or transceiver, or other inventory monitoring device. The BOA device 104 may maintain or communicate with a database that tracks a particular set of inventoried items, whether they be medical devices, supplies, drugs, personnel, or the like.

For example, the BOA device 104 may include a database that tracks the inventory of devices, supplies, and drugs on board a particular ambulance 101. When a new device is placed on the ambulance 101, the new device is equipped with a tag or bar code or some other unique identifier, and the BOA device 104 may be configured to automatically sense, or to be instructed to sense (e.g. by scanning a bar code with the bar code scanner), the presence of a new inventory item. The BOA device 104 may also prompt the user with a status update request, for example: new item, item being removed, item being dispensed, item destroyed, item transferred. Hence, at the beginning of an ambulance 101 shift, the crew may query the BOA device 104 to display the inventory of devices, supplies, and/or drugs on board, and may supplement the inventory for any deficient item. When a drug is administered, it may be scanned into the BOA device 104 system with an indication that it has been dispensed and should be replaced. At the end of a shift, the crew may check the inventory via the BOA device 104 and restock necessary supplies and/or transmit the inventory situation to a third party for any appropriate restocking, monitoring, and/or verification activity.

Such inventory information may also be conveyed by BOA 104 for remote use and/or storage. For example, a defibrillator patient monitoring device 106 may be checked out to each crew of each ambulance 101, and this information may be sent by BOA device 104 through network 120 to the enterprise storage server 126, which may aggregate such information across multiple ambulances 101. A shift supervisor using a remote enterprise workstation 122 may query such database to determine which defibrillators are out in the field on which ambulances 101, according to embodiments of the present invention. In this way, the BOA device 104 may auto-upload inventory information to a central system.

The BOA device 104 may also be configured to connect with devices (clinical and/or non-clinical) that track EMS technician 114 and patient 116 safety, according to embodiments of the present invention. For example, the BOA device 104 may be configured to connect with accelerometer and/or tire pressure sensors, and/or other vehicle-relate sensors to track driving conditions, driving behavior, safety level, and/or event occurrences, according to embodiments of the present invention. According to one embodiment of the present invention, the BOA device 104 may be configured to connect with a breathalyzer device, which may be used to sense and/or estimate the blood alcohol content of the driver and/or patient. The BOA device 104 may collect such data and display it to the user in a feedback format, and/or may send such data through the network 120 for storage and/or remote evaluation, according to embodiments of the present invention. The BOA device 104 may also monitor a vehicle's maintenance schedule and alert the user when maintenance is needed or recommended, according to embodiments of the present invention.

Due to its connection with the network 120 and also with other devices 106, 108, 110, the BOA device 104 may also serve as an ambulance headquarters and/or a type of “repeater” in a trauma or disaster situation, according to embodiments of the present invention. For example, the BOA device 104 may be configured to connect with multiple devices including devices outside the ambulance 101 and/or in a different ambulance 101, to permit the BOA device 104 user to view and manage response treatments, for example. Such a configuration also permits data from multiple devices (e.g. multiple defibrillators or other patient monitoring devices) to be conveyed through the network 120 to an enterprise environment 102 and/or administration environment 103, according to embodiments of the present invention. In another example, a single ambulance 101 equipped with a BOA device 104 system as described above may be deployed to a disaster or trauma situation, and the BOA device 104 may be connected to and aggregating information from multiple patient monitoring devices 106. A supervisor or situation manager may use the BOA device 104 to monitor treatment status, prioritize patient medical needs, transmit relevant information to selected outside caregivers, hospitals, and/or treatment centers, and to distribute resources accordingly.

According to some embodiments of the present invention, the BOA device 104 is configured to perform diagnostics on and/or to initiate self-diagnostics for devices with which it is connected. The BOA device 104 may also be used for training and/or education of EMS technicians 114, by making downloaded protocols available for display, and/or by simulating a medical emergency (e.g. simulating the device feeds from multiple clinical and non-clinical devices during a medical emergency or transport).

According to some embodiments of the present invention, the BOA device 104 provides a visual indication of whether its connection with the navigation device 110 (or other predetermined device) is online or offline. According to some embodiments, the user can select to view historical rather than current patient information; for example, the user may select to view thumbnails of previous twelve-leads, and can send a collection of twelve-lead data snapshots to an enterprise environment 102 (e.g. a hospital), each with a unique serial number, for example. The enterprise user 124 may also view the patch notes from the BOA device 104, so that the EMS technician 114 need not convey them telephonically, according to embodiments of the present invention.

The BOA device 104 may also include a drop-down menu interface, listing each device to which the BOA device 104 is connected and its connection status, according to embodiments of the present invention. The BOA device 104 may also be connected with a biometric device such as a fingerprint reader or a retinal scanner, or a non-biometric device such as a keypad, to assist in verifying the identity of a patient and/or in authorizing access to patient medical records. Such records may be stored in remote databases and/or stored by different entities, for example.

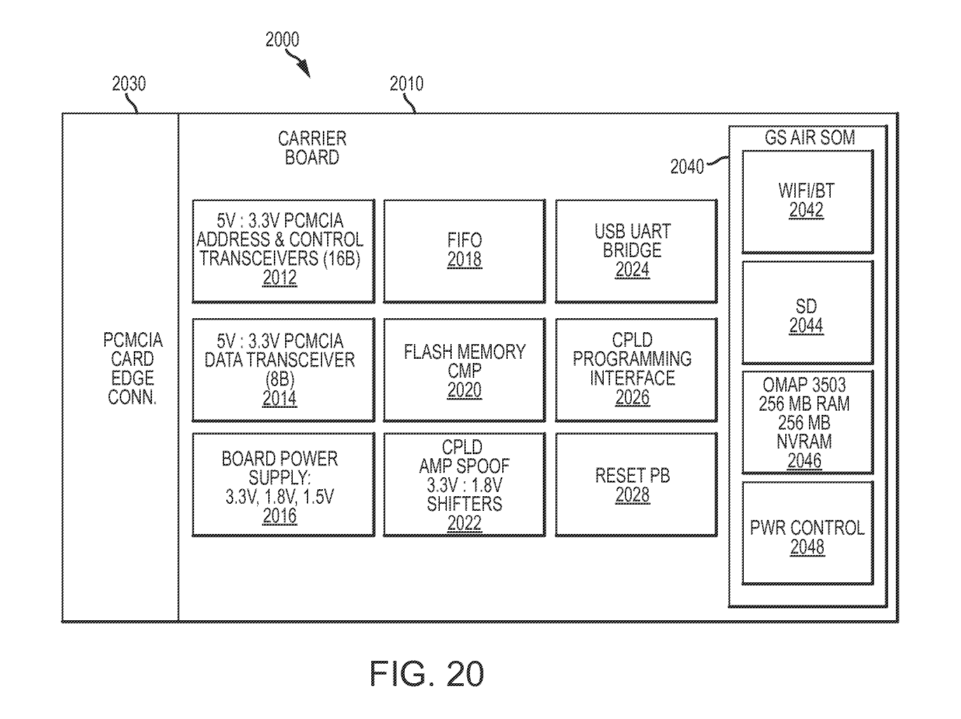

FIGS. 20-23 illustrate an EMS communication interface device 2000, configured to facilitate communication between a patient monitoring module 1102 and a device adapter/communication interface 1104 (see FIG. 11). Not all patient monitoring devices 106 include the hardware necessary for certain kinds of communication (e.g. wireless communication), either with BOA device 104 or with other enterprise environments 103. An EMS communication interface device 2000 may be added as an accessory to the patient monitoring device 106 in order to supplement its communication capability, as well as provide additional functionality, according to embodiments of the present invention.

The EMS communication interface device 2000 may be configured to interface with the patient monitoring device 106 via an existing hardware interface, such as, for example, via a PCMCIA card slot, a USB slot, or the like, according to embodiments of the present invention. The following example illustrates an EMS communication interface device 2000 that interfaces with a patient monitoring device 106 via a PCMCIA card slot in the device 106, according to embodiments of the present invention.

FIG. 20 illustrates a carrier board 2010 design for an EMS communication interface device 2000, according to embodiments of the present invention. The carrier board 2010 may be a custom carrier board for a systems-on-module (“SOM”) hosting of various subsystems. The carrier board 2010 may host a PCMCIA edge connector 2030, PCMCIA address and control transceivers 2012, PCMCIA data transceivers 2014, a board power supply 2016, a first-in-first-out (“FIFO”) co-processor input memory buffer 2018, a flash memory common memory plane (“CMP”) 2020, a complex programmable logic device (“CPLD”) attribute memory plane (“AMP”) spoof shifter 2022; a universal serial bus (“USB”) universal asynchronous receiver-transmitter (“UART”) bridge 2024, a CPLD programming interface 2026, and a reset push button 2028. The power supplies for 3.3V, 1.8V, and 1.5V levels may be derived from PCMCIA 5V and possibly 12V inputs, according to embodiments of the present invention. Device 2000 may further include a USB 2.0 port.

The carrier board 2010 may also include a SOM coprocessor subsystem 2040 such as, for example, a Gumstix Overo Air SOM or a LogicPD xxxSOM. SOM 2040 may include a Bluetooth (“BT”) radio and/or antenna and/or a WiFi (e.g. 802.11a/g) radio and/or antenna 2042. The 802.11a/g subsystem may be initialized and configured during boot, and may also be configured via terminal session, according to embodiments of the present invention. SOM 2040 may also include a storage device 2044, such as, for example, a removable micro SD storage/memory slot. A micro SD card may be used in such a slot as random access storage as well as a source of the boot strap code to initialize the co-processor subsystem 2040. SOM 2040 may also include a power management integrated circuit (“IC”) 2048, such as, for example, a Texas Instruments TPS65950 integrated power management IC. SOM 2040 may also include a processor 2046 such as, for example, a TI Open Multimedia Applications Platform (“OMAP”) 3503 processor with 256 MB of random access memory (“RAM”) and 256 MB of non-volatile RAM (“NVRAM”) in a package-on-package (“POP”) package. The coprocessor subsystem 2040 may be communicably coupled to the carrier board 2010 via dual 70-pin headers, according to embodiments of the present invention. The carrier board 2010 may also include a Joint Test Action Group (“JTAG”) interface for programming, according to embodiments of the present invention.

The device 2000 may include CPLD firmware, such as, for example, Actel Igloo Nano AGL250V2-VQG100_{—}0. Such CPLD firmware may govern linear flash (“LF”) control signals for read/write operations, may govern FIFO control signals for write and read operations in a manner of a FIFO dual-ported implementation, and may employ level shifted address and data buses for LF, FIFO, and the OMAP, according to embodiments of the present invention. The device 2000 may include an operating system, such as, for example, OE 2.6.x Open Embedded Linux. The device 2000 may employ the C# Common Language Runtime (2.6.2), for example the Mono common language runtime (“CLR”), according to embodiments of the present invention. The device 2000 may include persistent data storage using SQLite software library, according to embodiments of the present invention. The device 2000 may perform asset management patterned data storage for framed data, and/or asset management patterned services for parameterized frame retrieval, according to embodiments of the present invention. The device 2000 may accomplish WiFi communications using User Datagram Protocol/Internet Protocol (“UDP/IP”) for streaming data output, a .NET remoting service bus, and/or a .NET remoting eventing bus, according to embodiments of the present invention.

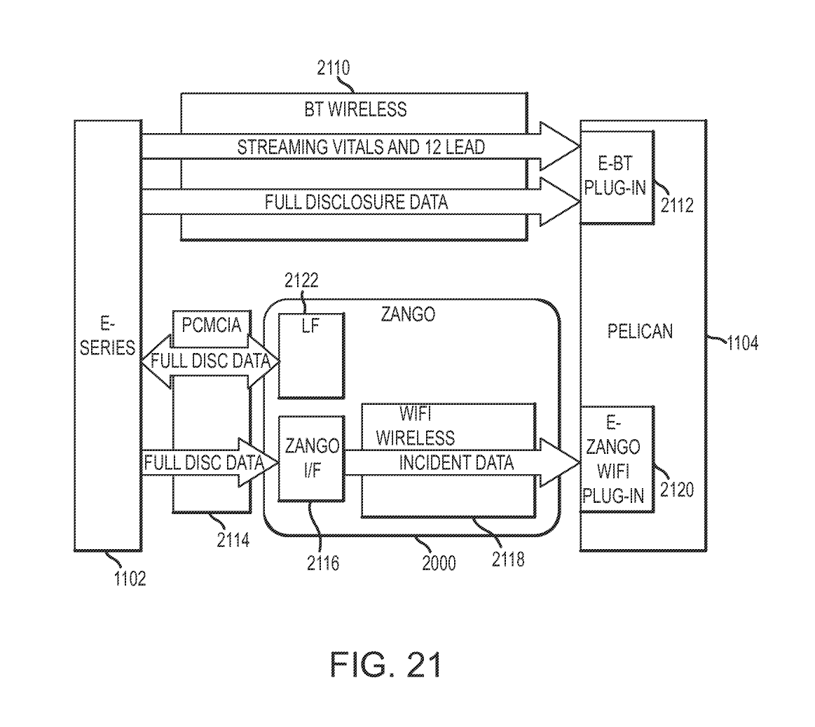

FIG. 21 illustrates a system overview for an EMS communication interface device 200, according to embodiments of the present invention. A patient monitoring module 1102 processes and sends patient monitoring data. The patient monitoring module 1102 may be implemented by a Zoll E-Series Defibrillator, according to embodiments of the present invention. Such patient monitoring module 1102 is configured to transmit streaming patient vital signs and twelve lead information, as well as full disclosure data, over a BT wireless connection 2110, to a BT plug-in 2112 that is part of a device adapter 1104, according to embodiments of the present invention. As used herein, the term “Full Disclosure Data” means all data recorded by a patient monitoring device 106, and includes, without limitation, patient vital signs, twelve-lead data, audio information, ECG information, lead type, gain, defibrillator shock information, system mode, paddle type, heart rate alarm status, heart rate, configuration information, code marker information, non-invasive blood pressure measurements, patient name, patient identification, biphasic defibrillator data, invasive blood pressure information, invasive blood pressure waveform data, temperature data, SpO₂ information, SpO₂ waveform, sample number information, accelerometer information, accelerometer waveform, impedance waveform, CPR field data, APLS waveform, and/or APLS compression detection.

A WiFi wireless connection has a much higher bandwidth for the transfer of information than a BT wireless connection. However, in some cases, the patient monitoring device 106 on which the patient monitoring module 1102 runs may not include WiFi capabilities, but it may include a personal computer memory card international association (“PCMCIA”) card slot with a PCMCIA interface 2114. A PCMCIA card may also be referred to as a PC card. The EMS communication interface device 2000 may be plugged in to the PCMCIA card slot 2114. The device 2000 may include a linear flash memory card 2122 or other memory element for recording full disclosure data from the patient monitoring device 106, according to embodiments of the present invention. The memory card 2122 may be used to replicate all existing memory card functionality of the patient monitoring device 106, by storing in linear flash memory 2122 all data written to the patient monitoring device 106 data slot, by permitting a utility mode user-initiated retrieval of stored data from linear flash memory 2122, and/or by permitting a utility mode user-initiated erasure of the linear flash memory 2122, according to embodiments of the present invention.

The full disclosure data stream from the patient monitoring module 1102 may also be received through the PCMCIA slot 2114 by an EMS communication interface module 2116, which transforms the full disclosure data into incident data, and provides the incident data over a WiFi connection 2118 to a WiFi plug-in 2120 that is part of the communication interface 1104, according to embodiments of the present invention.

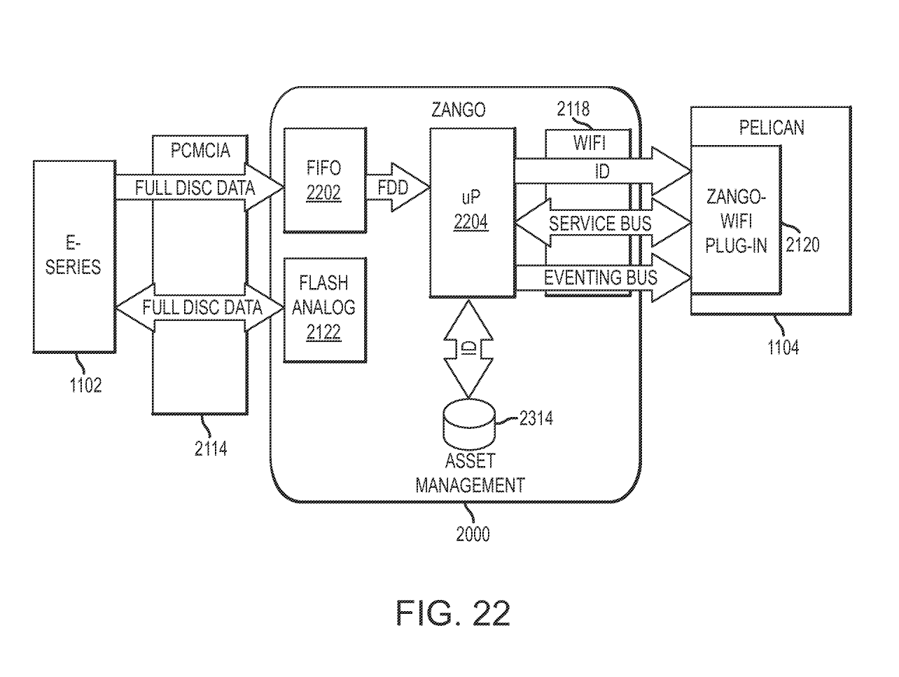

FIG. 22 illustrates another system overview for an EMS communication interface device 2000, according to embodiments of the present invention. As illustrated in FIG. 21, full disclosure data is recorded in a memory module 2122, for example a flash linear analog memory module 2122, according to embodiments of the present invention. The flash analog module 2122 may be read, written, and/or erased by the patient monitoring module 1102 similarly to the fashion in which any memory element permanently associated with the patient monitoring device 106 may be read, written, and/or erased by via the device 106, according to embodiments of the present invention. This may be accomplished by using a utility mode of the device 106, for example. As such, the flash analog 2122 is not interfaced to the SOM (e.g. to microprocessor 2204), but only to the patient monitoring module 1102 in write/read/erase fashion.

According to embodiments of the present invention, the flash analog memory 2122 is designed to resemble the linear flash card that is normally associated with, and which may be embedded within, the patient monitoring device 106. Certain information may be stored in a non-volatile memory area, for example in the attribute memory plane, and certain other information may be stored in the first series of bytes of the common memory plane, to make the memory 2122 resemble the internal memory of the patient monitoring device 106. The communications interface 2116 may be a FIFO buffer 2202, which may receive full disclosure data from the patient monitoring module 1102 via the PCMCIA interface 2114, and pass the full disclosure data to a microprocessor 2204. The FIFO 2202 is uni-directional from the patient monitoring module 106 to the microprocessor 2204, according to embodiments of the present invention. Incident data sent may also be persisted in the asset management database 2314.

According to embodiments of the present invention, the FIFO buffer 2202 and/or the flash analog memory module 2122 are hardware-only solutions that function even when the SOM 2040 is non-operational. This functionality permits data protection in the case in which the SOM 2040 is not functional, and permits data buffering for the SOM 2040 to initialize (e.g. to boot and start the EMS communication interface services), according to embodiments of the present invention. During therapy mode data capture to the card 2122, if the SOM 2040 were to be disabled, device 106 data would not be lost, according to embodiments of the present invention. This also permits users who have been trained on utility modes of a patient monitoring device 106 related to the storage of data on a memory module to continue using such utility modes, even with the data being stored on memory module 2122 instead of a memory module internal to device 106, according to embodiments of the present invention.

Using a plug-in 2120 that is part of the communication interface 1104, incident data (“ID”) may be streamed from the microprocessor 2204 over a WiFi connection 2118. Such information may be received and displayed by BOA device 104, for example, and may be displayed in real time and/or in clinically significant time (e.g. with a delay not larger than that which permits a medically accurate and timely observation, diagnosis, and/or treatment decision to be made). According to embodiments of the present invention, the incident data may be streamed on a BOA device 104 with no more than a one-second delay. For example, twelve-lead data generated by a defibrillator patient monitoring device 106 may be updated at least once each second, according to embodiments of the present invention.

The microprocessor 2204 may also be programmed to generate asynchronous (e.g. event based) notifications via an eventing bus, over the WiFi connection 2118, according to embodiments of the present invention. For example, if a patient vital sign falls outside of present parameters, the microprocessor 2204 may be programmed to send an alarm event via eventing bus across the communication interface 1104.

In addition, the microprocessor 2204 may be programmed to permit a two-way service bus/service interface, to permit the requesting of incident data related specific incidents, according to embodiments of the present invention. For example, after a treatment incident, the user may request, via a service bus, from microprocessor 2204 all information associated with the particular incident (using a unique incident identifier, such as a case number, patient name, or the like). The microprocessor 2204 would then query the asset management module 2314 and retrieve any records associated with the particular incident, and send them back out through service bus, according to embodiments of the present invention. In this way, users may retrieve specific incident data rather than having to download all of the card file data (which in many cases will relate to multiple incidents, or information beyond the specific subset of information sought). This is made possible by the conversion of full disclosure data into incident data by the microprocessor 2204 prior to storage and/or forwarding. In some cases, users may wish to request all data stored by asset management module 2314, which would be a similar operation to the request for the card file directly from the patient monitoring module 1102.

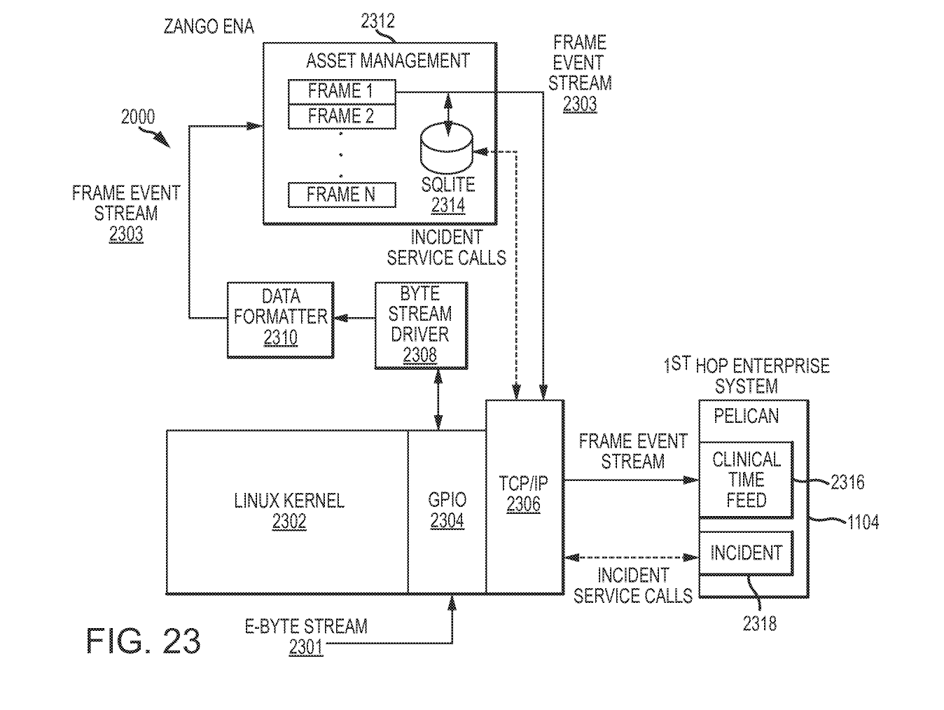

FIG. 23 illustrates a software logic diagram for an EMS communication interface device 2000, according to embodiments of the present invention. A Linux Kernel 2302 may include a general purpose input/output (“GPIO”) module 2304 configured to receive the data stream (e.g. the full disclosure data) 2301 from the patient monitoring device 106. The data stream 2301 is interfaced to the system 2000 through the FIFO module 2202 which is controlled with several GPIO 2304 lines, according to embodiments of the present invention. The FIFO is read to the SOM using GPIO status, control and eight bits of data, according to embodiments of the present invention. The byte stream driver 2308 may be implemented in user space rather than a device driver to facilitate debugging, in some embodiments. The byte stream driver 2308 may keep the FIFO 2202 drained by monitoring the FIFO 2202 empty flag (which may be polled as opposed to interrupt driven for debugging efficiency in one embodiment).

Bytes read from the FIFO by the byte stream driver 2308 are re-assembled as blocks similar to those delivered by the patient monitoring device 106 and framed in the data formatter 2310, according to embodiments of the present invention. This results in a frame event stream 2303 from the data formatter 2310. The frame event stream is then sent to an asset management module 2312, which saves the frames to the database 2314 and forwards them out the WiFi channel to the TCP/IP module 2306 of the Linux Kernel 2302. According to some embodiments of the present invention, the frame event stream 2303 is sent over the WiFi connection via an encrypted UDP broadcast, so that it may be received by a wide range of clients (e.g. an iPhone may be configured to receive the UDP broadcast). The frame event stream 2303 may also be received by a clinical time feed plug-in 2316 of the communications interface module 1104, according to embodiments of the present invention.

Asynchronous requests for incident data stored in the database 2314 may be made by authorized external clients, such as via an incident plug-in 2318 of the communications interface module 1104, according to embodiments of the present invention. Such incident service calls are shown in dashed lines in FIG. 23. Although database 2314 is shown as an SQLite database, one of ordinary skill in the art will appreciate, based on the disclosure provided herein, that other database formats may be employed by asset management module 2312, according to embodiments of the present invention.

According to embodiments of the present invention, the byte stream is formatted by data formatter 2310 into blocks of data resembling device 106 data blocks, and these full data blocks are broadcast in a WiFi format upon construction (e.g. as a block is made, it is sent over the WiFi interface). According to embodiments of the present invention, the asset management module 2312 frames the byte stream into consistent blocks of time, for example one second per frame, and each frame is saved into the asset management patterned data storage (e.g. database 2314).

Although FIGS. 21-22 show full disclosure data as two separate feeds, a single full disclosure data feed may be bifurcated and sent to both the flash analog module 2122 and the FIFO 2202 simultaneously, according to embodiments of the present invention.

A user may query the device 2000 to request health information, for example, running time, exceptions detected, and other information from the patient monitoring device 106, according to embodiments of the present invention. A user may also request specific incident-based data from the device 2000; for example, a user may send a query that says “send all of the cases,” or “send data relating to a specific case” or “send all twelve-lead data from a specific case.” The device 2000 may also stream delivery of case data so as to permit multiple authorized receivers (e.g. multiple BOA devices 104) to obtain the data simultaneously, according to embodiments of the present invention. According to some embodiments of the present invention, device 2000 facilitates data sharing between the patient monitoring device 106 and the enterprise environment 103.

On power up, the device 106 interrogates the occupant of the PCMCIA slot 2114 to ascertain if a valid linear flash card 2122 is present. The validity test may consist of reading a series of bytes from the LF AMP and validating the values against sets of acceptable cards or an acceptable card. If a valid card is found, the device 106 reads a series of bytes from the CMP to test for validity and to determine if the card has been “formatted” according to the requirements of the device 106. In the absence of such a series of bytes, the device 106 may write such information to the card 2122, according to embodiments of the present invention. Once the card 2122 is validated, the device 106 begins to write the device data to the LF card 2122 as byte streams that are formatted into blocks as described, above.

Although the device 2000 is depicted as interacting with device 106 in a one-way fashion, the device 2000 may also be configured to interact bi-directionally with device 2000. For example, the device 2000 may be configured to provide a WiFi user interface similar to the user interface observed directly on the patient monitoring device 106, to permit total or partial remote control of the patient monitoring device 106, according to embodiments of the present invention.

Packaged in a PCMCIA type x housing, each card 2010 contains a connector 2030, an array of flash memories packaged in thin small outline packages (“TSOP”) and card control logic. The card control logic provides the system interface and controls the internal flash memories as well as the input FIFO to the SOM, according to embodiments of the present invention. Level shifters are present to adapt PCMCIA logic voltages to card logic voltages.

Card logic voltages of 3.3V, 1.8V, and 1.5V may be derived from the PCMCIA VCC voltage (TTL, +5V, possibly +12V). A single stage for 3.3V and 5V conversions is built using three discrete transceivers. A CPLD is used to perform 3.3V and 1.8V conversions.

| Part | Logic Voltages | Power | Notes |
|---|---|---|---|
| J1 | +5 V | +5 V, +12 V | 2X34 PCMCIA |
| | | | connector |
| U5, U6, U7 | +5 V: +3.3 V | +5 V, +3.3 V | Level Shifters |
| U3 | +3.3 V | +3.3 V | Flash Memory |
| U7 | +3.3 V | +3.3 V | FIFO |
| U1 | +3.3 V: +1.8 V | +3.3 V, +1.8 V | CPLD |
| MCU | +1.8 V | +4.0 V | OMAP SOM |

Data enters FIFO at 3.3V from the PCMCIA byte stream. Reading the FIFO is clocked an 8 bit byte at a time on the read clock shifted between 3.3 and 1.8 to OMAP, through the CPLD. OMAP control and status interface bits may be converted in a similar fashion. Each carrier card 2010 may have a USB2.0 port. OMAP UART signals are connected to a USB to UART serial bridge 2024, according to embodiments of the present invention.

A JTAG interface for programming the CPLD may be provided. A 2×34, A and B sided PCMCIA Connector (J1) may be used, that inter-connects I/O, status and power signals between the device and the card, according to embodiments of the present invention. For the device signals that the card interface is interested in, there is a group of three transceivers (U5, U6, and U7) that inter-convert PCMCIA voltage (VCC) and board voltage (3V3), according to embodiments of the present invention. Device 2000 is interested in 26 address bits, 8 data bits, and 6 control signals that are intended to be level-shifted, according to embodiments of the present invention. U5 and U6 are uni-directional 16b input shifters from device to card for address and control information, according to embodiments of the present invention. U7 is a bi-directional 8b level shifter for 8 bits of data.

According to embodiments of the present invention, the device 2000 reads and writes data through this interface to LF memory. U5 shifting 16 address bits [PCA0:PCA15] to [A0:A15]. U6 shifting 10 address bits [PC16:PC25] to [A16:A25], and 6 control signals {PC_REGn, PC_RESET, PC_CE1n, PC_CE2n, PC_OEn, PC_BWEn} to {REGn, RESET, CE1n, CE2n, OEn, BWEn}.

| Sig | Description | Active |
|---|---|---|
| REGn | Attribute Memory Select | Low |
| CE1n | Card enable 1 | Low |
| CE2n | Card enable 2 | Low |
| OEn | Output enable | Low |
| BWEn | Write enable | Low |
| RESET | Reset | High |

[PCD0:PCD7] 8 data bits (U2). Address shifters may be input only, in which case the card does not generate address information to the device 2000, only outbound addressing (device to card) is exposed, according to embodiments of the present invention. The data shifter is bi-directional as the device can read and write data to and from the card, according to embodiments of the present invention. U5 shifts 16 bits of address and U6 shifts 8 control signals and the upper 8 bits of the address and control signals from PCMCIA VCC to 3V3.

Device 2000 is configured to permit streaming data transmission via WiFi during therapy mode operations of the device 106, as well as post-case upload of device data. The device 2000 has hardware components as well as programmable elements using both firmware and embedded software, including an embedded operating system as described, above. According to some embodiments, the EMS communication interface device 2000 is thicker than a standard Type III PCMCIA card.

An embodiment of the present invention may include one of more of the following features and/or characteristics:
The carrier may be a PCMCIA card
The carrier may be inserted into a patient monitoring device PCMCIA data slot.
The card 2000 interfaces to the patient monitoring device 106 in such a way as to appear to the patient monitoring device 106 as a valid LF card (“linear flash analog”) 2122.
The card 2000 presents the PCMCIA byte stream, written by the patient monitoring device 106, via a buffered hardware interface, to a SOM processor.
The carrier stores the received PCMCIA byte stream to a non-volatile storage subsystem (“linear flash analog”) such that all of the patient monitoring device 106 read/write/erase functionality is preserved in all device 106 modes of operation supporting these operations.
The SOM provides IEEE 802.11. b/g wireless communications capability.
The SOM provides Bluetooth V2.0+EDR wireless communications capability.
The SOM provides a micro SD card slot.
The SOM supports watchdog type monitoring to provide for automatic reset if the SOM becomes non-functional.
During patient monitoring device 106 or SOM reset or initialization, data is captured to flash analog memory.
Data capture continues uninterrupted during SOM reset.
The system 5000 is designed such that data being written by the patient monitoring device 106 is saved to the flash analog regardless of SOM state
The SOM is able to access data saved while the SOM was unavailable.
The carrier board provides a USB connector.
The carrier SOM combination supports USB 2.0 On-The-Go (“OTG”).
Device 2000 form factor includes PCMCIA standard dimensions in width and height.
Device 2000 form factor includes a width of 85.6 mm×54.0 mm X a thickness (in some cases, this thickness is greater than type III which is 10.5 mm)
Device 2000 thickness is no larger than permitted by device 106 PCMCIA slot.
All carrier board components are mounted on one side of the carrier card.
The interface to the patient monitoring device 106 is via slot bay via 68-pin PCMCIA card edge connector.
Device 2000 is encapsulated to meet medical device requirements for EMC/RFI.
The SOM is mounted on the carrier using 2 AVX 5602 70 pin connectors.
Device 2000 is powered from the PCMCIA data slot, which may be on the order of 2.5 W continuous with peak current not exceeding 600 mA.
Device 2000 may utilize 15 GPIO pins to control reading FIFO byte stream buffer.
Device 2000 may utilize 3 UART lines from the SOM connected and a USB bridge on the carrier.
Device 2000 may include an antenna for WiFi.
Device 2000 may include an antenna for BT.
Device 2000 may use an Angstrom Open Embedded Linux operating system (“O/S”).
The device 2000 O/S may include Mono for the purposes of running code implemented in C#.
The device 2000 O/S may include SQLite.
The device 2000 may support the use of USB for bidirectional serial communications.
The device 2000 provides secure wireless communications, including end-point authentication, confidentiality, integrity, and/or delivery confirmation.
External data recipients (external processes to the device 2000) are able to request streaming data delivery.
Data recipients are able to request complete incident data delivery by incident identifier, e.g. post-incident data.
Device 2000 software is upgradeable via wireless interface.
Device 2000 software is verified at run time using a cyclic redundancy code (“CRC”)-like mechanism.

A device 2000 according to an embodiment of the present invention may permit individual screens for different receiving devices (e.g. different receiving devices using the communications interface 1104) to permit different users to obtain different data. For example, one user's settings could be configured to receive and display the frame event stream data relating to a patient's twelve-lead data, while an administrative technician user's settings could be configured to periodically request only frames associated with error codes generated by the patient monitoring device 106, according to embodiments of the present invention. Similarly, the same data may be received by and/or displayed by multiple users simultaneously over a WiFi connection, according to embodiments of the present invention.

In this way, the data from a patient monitoring device 106 may be streamed, e.g. over a wireless WiFi connection, from a patient's house to or from an ambulance, and/or from an ambulance to or from a hospital. Various frames in the event stream may be filtered and/or requested, such that a specific subset of data may be obtained. For example, respiration data may be included in a frame event stream generated by device 2000, according to embodiments of the present invention.

A device 2000 according to an embodiment of the present invention may be combined with other types of patient monitoring devices 106, for example an automatic external defibrillator (“AED”). The device 2000 may thus be configured to send status information from the AED, to facilitate software updates for the AED, and/or to remotely test the AED, according to embodiments of the present invention. Such a device 2000 may also be used with a patient charting device, for example to combine the patient charting device 108 information from one vendor/platform with the patient monitoring device 106 information from another vendor/platform, according to embodiments of the present invention. The device 2000 may also function as a data aggregator, to parse, organize, and place streams of information into discrete frames information that are more easily sorted, queried, and supplied at a later, post-incident time frame, according to embodiments of the present invention.

According to embodiments of the present invention, the patient monitoring device 106 (e.g. defibrillator) sends data to the device 2000 in data blocks, for example ECG data, or patient's current heart rate. A collection of data blocks corresponding to one incident may be referred to as incident data. Full disclosure data is the concatenation of data associated with all incidents, and may be broken into sequences of data blocks corresponding to each individual/patient. When a service request is received for an incident, all of the frames stored on device 2000 for that incident are collected and put together in sequence. According to embodiments of the present invention, each ECG block corresponds to 100 ms of ECG data, which provides ten data blocks per second. The defibrillator may add to each data block an incident identifier, time information about when the data block was recorded, and/or a computing hash for data integrity purposes, according to embodiments of the present invention.

Device 2000 (which is referred to in some figures as a “Zango” device) and BOA device 104 (which is referred to in some figures as a RescueNet Link, or RNL, device) work together, according to embodiments of the present invention. Device 2000, by virtue of its embedded computer, embodies a powerful processing engine. This processing engine is used to manage sophisticated data, communications, and applications operations on behalf of BOA device 104 users, according to embodiments of the present invention. According to one embodiment of the present invention, the device 2000 does not have input/output user interfaces (e.g., no keyboard, or display), so it works in conjunction with BOA device 104 to provide users access to the communications and data management services it supports, according to embodiments of the present invention.

FIGS. 20 and 23 illustrate the logical and functional architecture of the EMS communications interface card 2000 processing and the BOA device 104 processing, respectively. When device 2000 is not connected to device 104, device 2000 stores all device data and can transmit it to device 104 when a connection is established or restored.

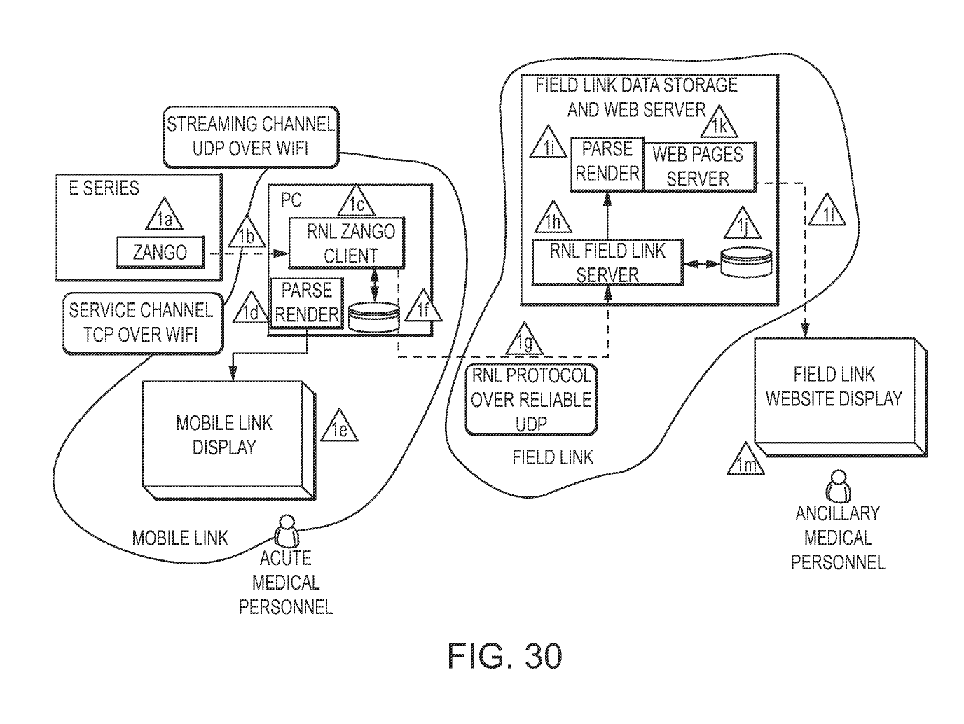

FIG. 30 illustrates a data transmission interface, according to embodiments of the present invention. Zango device (1a), can be configured to perform a number of functions, according to embodiments of the present invention:

Frame defibrillator incident data blocks.

Stream framed incident data.

Save incident data frames to Zango database.

Host a set of data management services upon the Zango database.
In one embodiment, data management services are read/erase only. Services to modify incident data are not supplied.

The “EMS communications interface channel” (1a, 1b, 1c) provides a means to transmit patient monitoring data (e.g. E Series data) to the BOA device 104. This channel uses the device 2000 to connect to BOA 104.

The RNL Zango Client (1c) can be configured to perform a number of functions:
Receive streamed incident frame data (1b).
Present incident frame data on the Mobile Link Display (1e) (parse, render, 1d)
Store incident frame data into the Mobile Link database (1f)
Host a set of data management services upon the Mobile Link database (1f).
   In some embodiments, data management services are read/erase only; and services to modify incident data are not supplied.
Forward 12 lead ecg and vitals data to Field Link. (1g)
Consume Zango data management services (1b).

The following table lists and describes various elements of FIG. 30, described with respect to one embodiment of the present invention.

| Notation | | |
|---|---|---|
| (FIG. 30) | Description | Notes |
| 1a | Zango accessory | Data management |
| | | accessory for ZOLL E |
| | | Series. Captures, stores, |
| | | and transmits E Series |
| | | data written to the E Series |
| | | data slot to connect the E |
| | | Series data to RNL. |
| 1b | Zango UDP/IP | |
| | transmissions over WPA2 | |
| | secured 802.11. | |
| 1b | Zango TCP/IP service | |
| | invocation response | |
| | transactions over WPA2 | |
| | secured 802.11. | |
| 1c | RNL Zango Client | RNL receiver of Zango |
| | | transmissions. |
| 1a, 1b, 1c | Zango channel | |
| 1d | Zango parsing and | Zango messages from the |
| | rendering engine | E Series are parsed and |
| | | rendered for acute medical |
| | | viewing. |
| 1e | Mobile Link Display | |
| 1f | Mobile Link Storage | |
| 1g | RNL Protocol: Reliable | |
| | UDP/IP over secured | |
| | cellular networks. | |
| 1h | RNL Field Link Server | Mobile link message |
| | | receiver in Field Link |
| | | environment. |
| 1c, 1g, 1h | RNL Mobile Link to Field | The RNL Mobile Link to |
| | Link Communications | Field Link Channel |
| | Channel | connects Mobile Link to |
| | | Field Link using reliable |
| | | UDP/IP over secured |
| | | cellular networks. |
| 1j | Field Link Storage | |
| 1i | Field Link parsing and | |
| | rendering engine | |
| 1k | Field Link web server | |
| 1l | Secured connection to | |
| | Field Link users | |
| 1m | Field Link web viewer | |

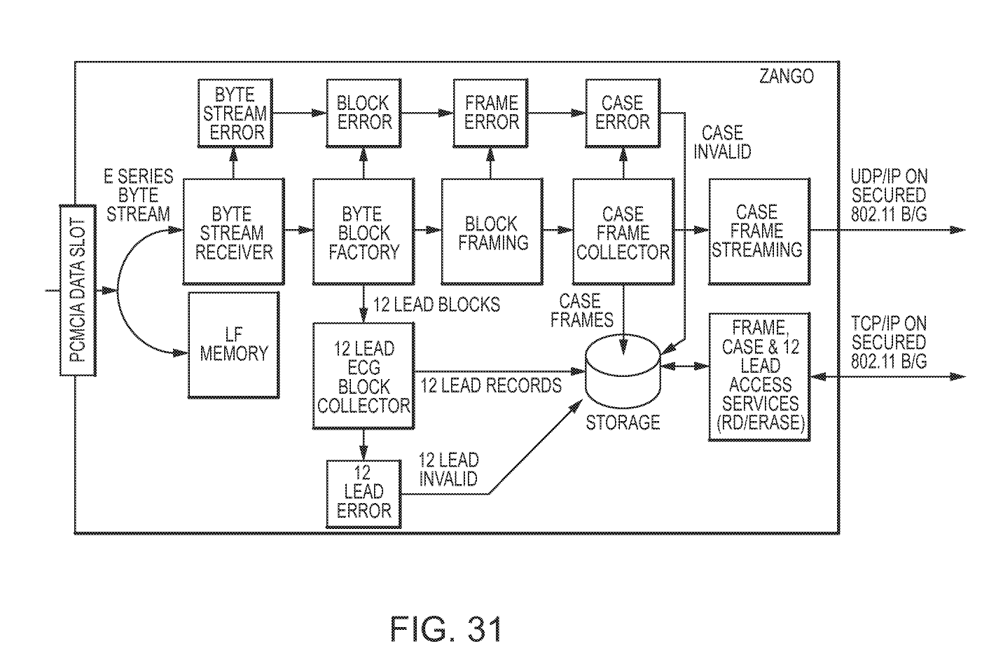

FIG. 31 illustrates an EMS communication interface transmission processing block diagram, according to embodiments of the present invention. The E Series writes a continuous byte stream of data to the PCMCIA Data Slot. The byte stream consists of E Series data block messages some of which are sent periodically and some of which are sent episodically. An example a periodic message is the ecg message. The E Series writes the ecg values for the currently displayed lead once per 100 ms, the message contains 25 data values (250 Hz samples, 4 ms apart), according to embodiments of the present invention.

Examples of episodic messages are the vital sign messages. The E Series sends a particular vital sign message when a particular vital sign parameter value has changed; asynchronous messages are sent with no particular frequency, according to embodiments of the present invention.

The byte stream is bifurcated at the input to the Zango card. One branch stores data into an on board (16 MB) linear flash, replicating all of the E Series linear flash operations. All data written is stored in the linear flash subsystem. The interface is hardware level, instant on prepared to receive and save the E Series byte stream to flash subsystem.

The second byte stream branch goes into the processor side of the Zango card. The processor side of the Zango card functions to process the byte stream performing the logical operations illustrated in FIG. 31. In the non-faulted case the byte stream receiver passes bytes to the byte block factory. The byte block factory re-constructs E Series data block messages from the byte stream. In this operation, 12 lead ecg data blocks are reconstructed and managed on a separate path to the incident path (sets of 12 lead data blocks are collected into entire 12 lead messages). The 12 lead data is entirely preserved in the case stream. One of the reasons for storing them separately is to permit a service user to request to see a 12 lead record on the service channel, rather than uploading the entire incident to get the 12 lead data, according to embodiments of the present invention.

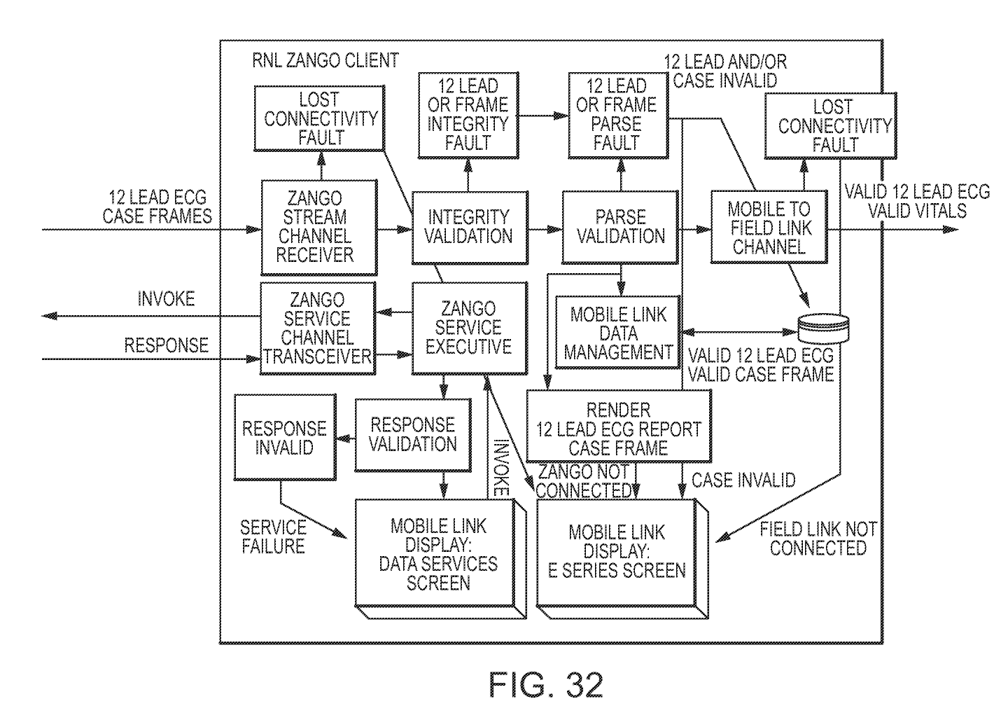

Blocks are then framed into a configurable time interval's worth of data blocks. For example, frames of one second in size might have on the order of 15 data blocks in the one second frame. Frames are collected into constructs of cases or incidents. Frames are stored in the Zango database. Complete incidents are marked (collection of all incident frames) and managed as incidents as they are completed. Frames are also streamed on WiFi where they can be received by authorized client applications, such as the RNL Zango Client described, below, with respect to FIG. 32.

The upper row of boxes in FIG. 31 identify detection and error handling processes for risk control of compromised data faults, according to embodiments of the present invention. Byte stream, block, framing, 12 Lead, or incident error all result in the following behaviors, according to embodiments of the present invention:
Data is marked as invalid.
Invalid data is not rendered for a user to view during the acute treatment phase of an incident
Data is stored marked as invalid for forensic analysis.
Any one of these faults will cause the incident to be marked invalid.
Acute medical personnel are informed of data faults, assuming connectivity to RNL.

These are the control measures and behaviors that trace directly to the hazard analysis for data compromised faults, in one embodiment of the present invention.

FIG. 32 illustrates a EMS communications interface device client architecture, according to embodiments of the present invention. In some cases, Zango connectivity to RNL may be volatile as a result of the nature of wireless communications in mobile environments. For example, an E Series equipped with a Zango card may be moved out of range of the wireless access point to which it had been connected. When the device is back in range and reconnects, processing resumes as illustrated. Data written by the E Series while not connected to RNL is persisted in the Zango database and can be obtained in RNL upon re-connect, according to embodiments of the present invention.

The upper row of boxes in FIG. 32 identify detection and error handling processes for risk control of compromised data faults and communications faults. Integrity or framing faults detected on the streamed data result in the following behaviors, according to embodiments of the present invention:
Data is marked as invalid.
Invalid data is not rendered for a user to view during the acute treatment phase of an incident
Data is stored marked as invalid for forensic analysis.
Either of these faults will cause the incident to marked invalid.
Acute medical personnel are informed of data faults for either 12 leads or case frames.
Acute medical personnel are informed of communications faults.
Acute medical personnel are informed of service faults.

Service responses are validated and invalid service responses are notified to the user and invalid data is not displayed, according to embodiments of the present invention. Connectivity status between Zango and the Zango Stream Channel Receiver is monitored and reported to users on the Mobile Link Display. Lost connectivity between Zango and RNL does not result in lost data as Zango stores data in the Zango database regardless of connection status. Service channel connectivity is not continuously monitored, service requests will fail (response invalid) if service connectivity is not present.

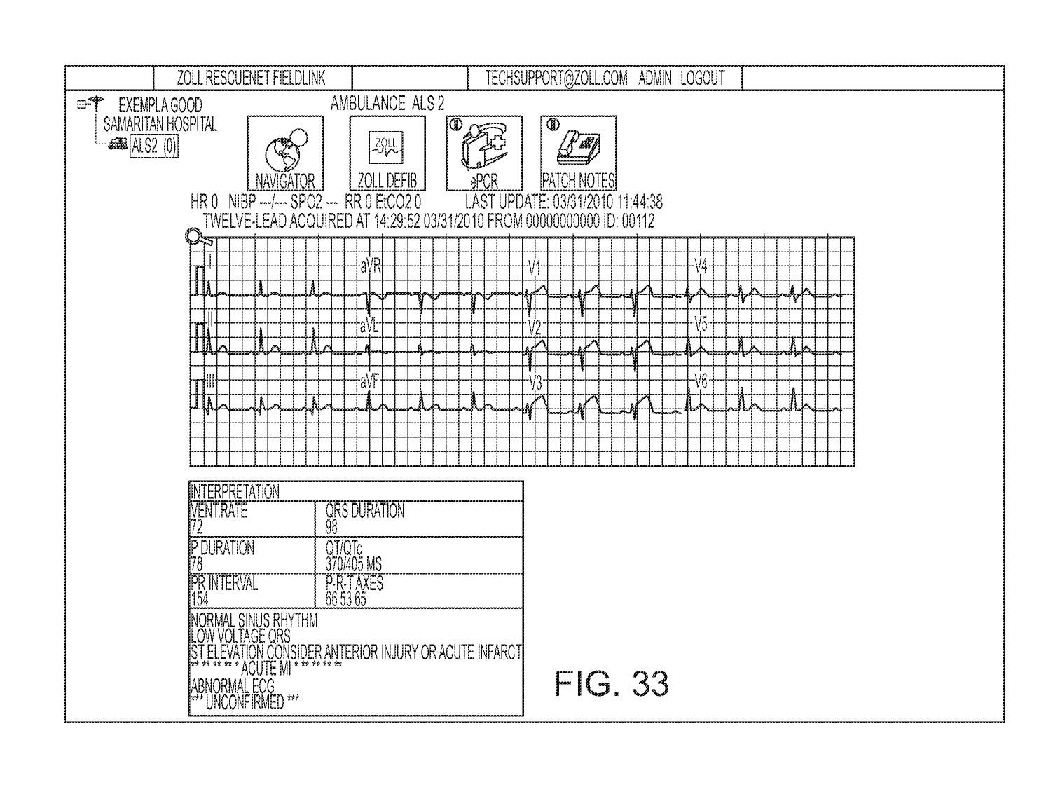

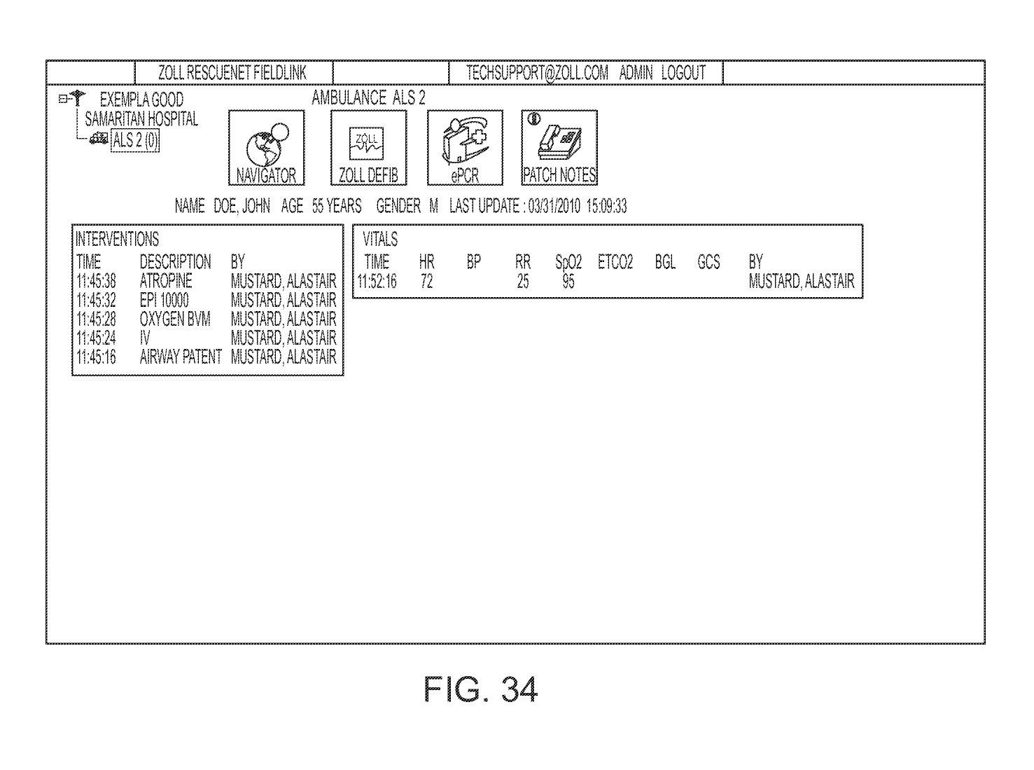

FIGS. 33-37 illustrate various embodiments of screen shots available as viewed by the enterprise user 124 via the enterprise workstation 122, according to embodiments of the present invention. FIG. 33 illustrates an enterprise display and graphical user interface shown when the enterprise user selects the patient monitoring button (e.g. the “Zoll Defib” button), according to embodiments of the present invention. FIG. 34 illustrates an enterprise display and graphical user interface shown when the enterprise user selects the patient charting button (e.g. the “ePCR” button), according to embodiments of the present invention. FIG. 35 illustrates an enterprise display and graphical user interface shown when the enterprise user selects the navigation button, according to embodiments of the present invention.

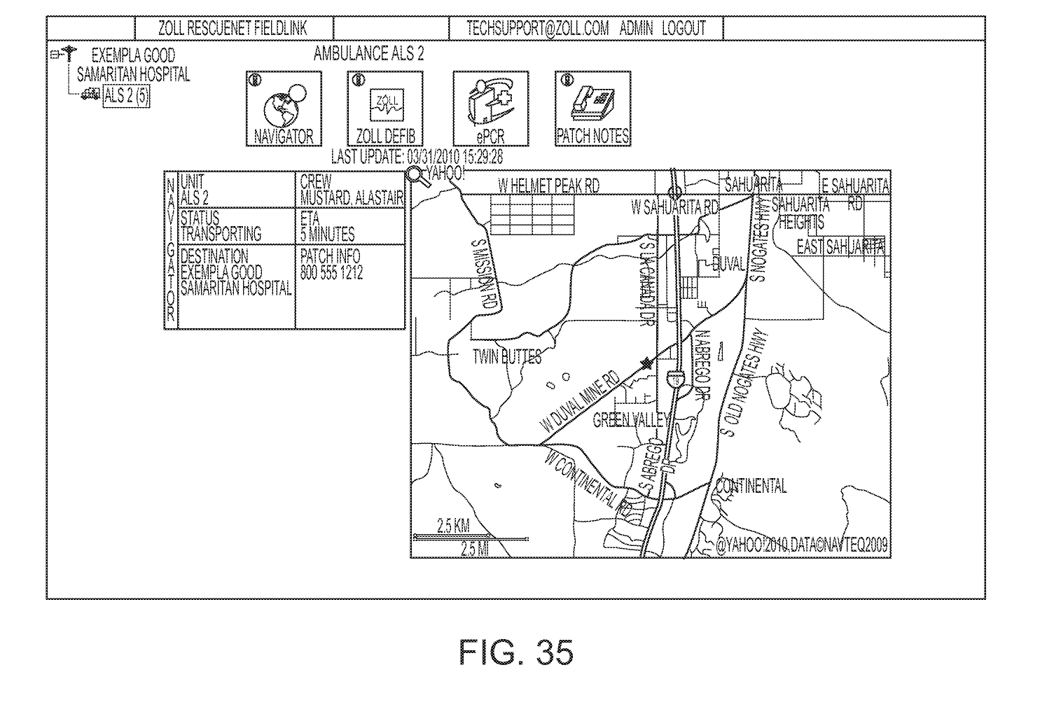

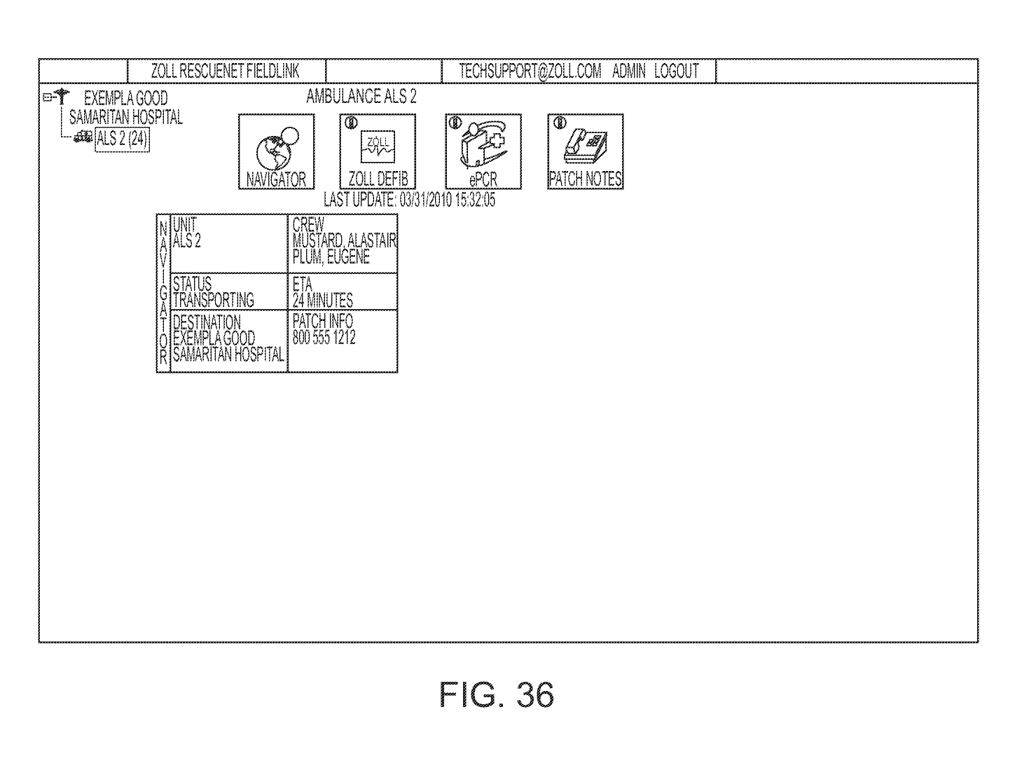

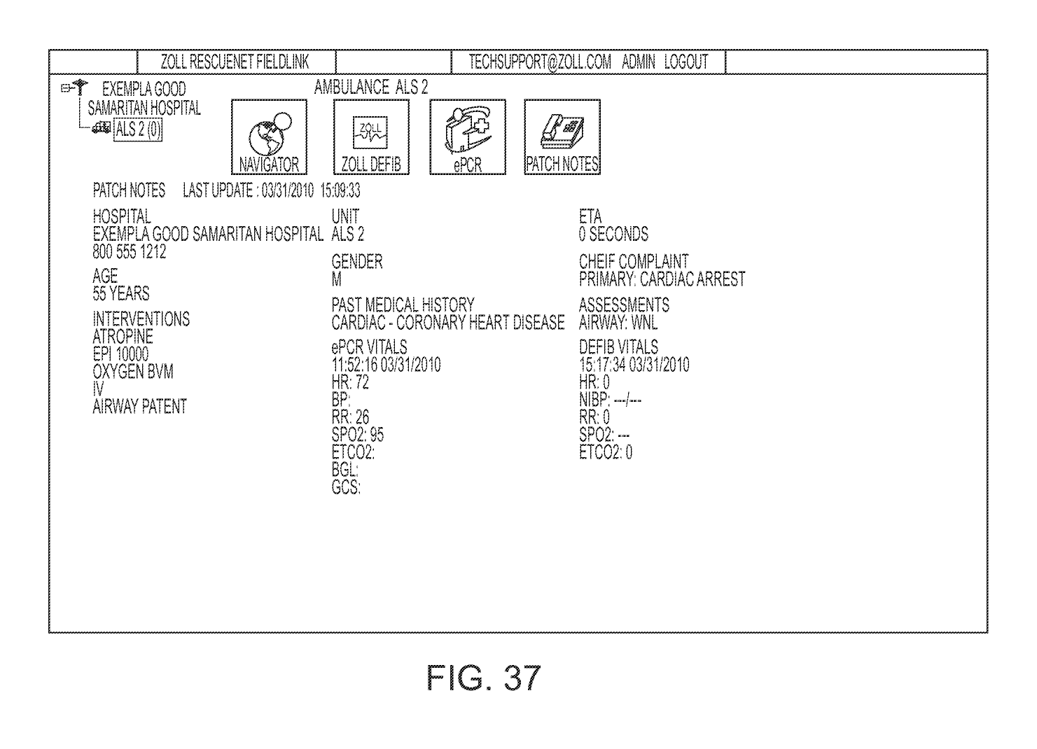

FIG. 36 illustrates an alternative enterprise display and graphical user interface shown when the enterprise user selects the navigation button, according to embodiments of the present invention. The display of FIG. 36 would correspond to a display created when the BOA device 104 is not communicably coupled with a navigation device; hence, in this situation, the enterprise display lists the positional and/or navigation information as input by the BOA 104 user. FIG. 37 illustrates an enterprise display and graphical user interface shown when the enterprise user selects the patch notes button, according to embodiments of the present invention. According to some embodiments of the present invention, the EMS technician 114 who is interacting with the BOA device 104 need not select the patch notes screen and relay the information to the enterprise user 124; instead, the enterprise user may select the patch notes button via the enterprise workstation 122 to observe the same information.

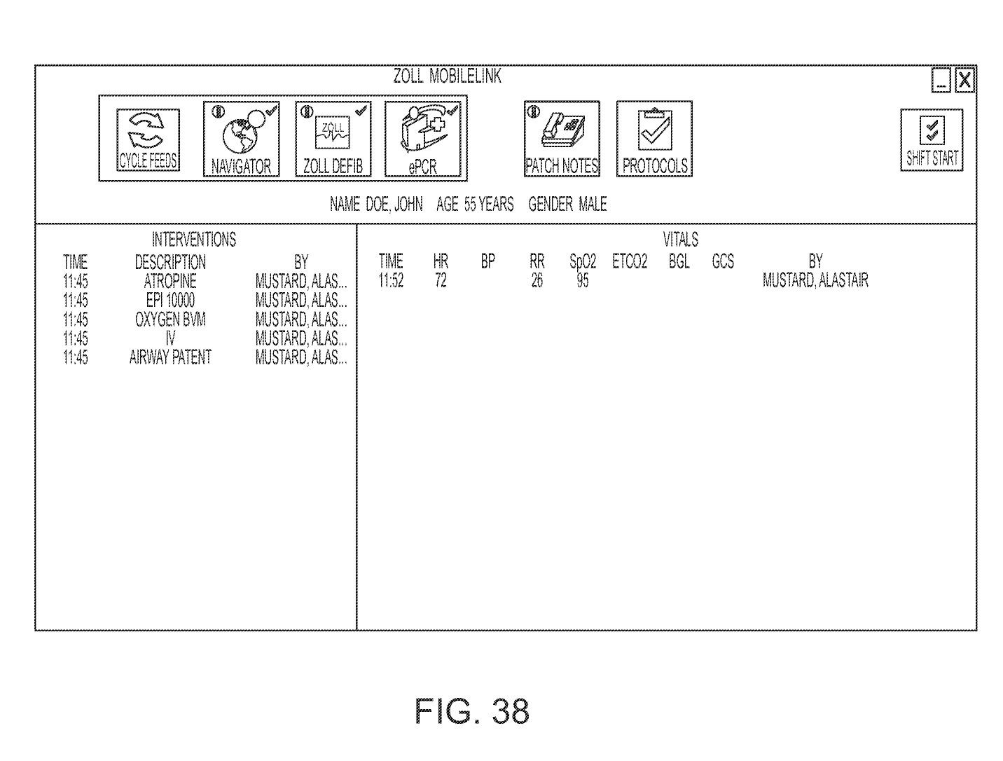

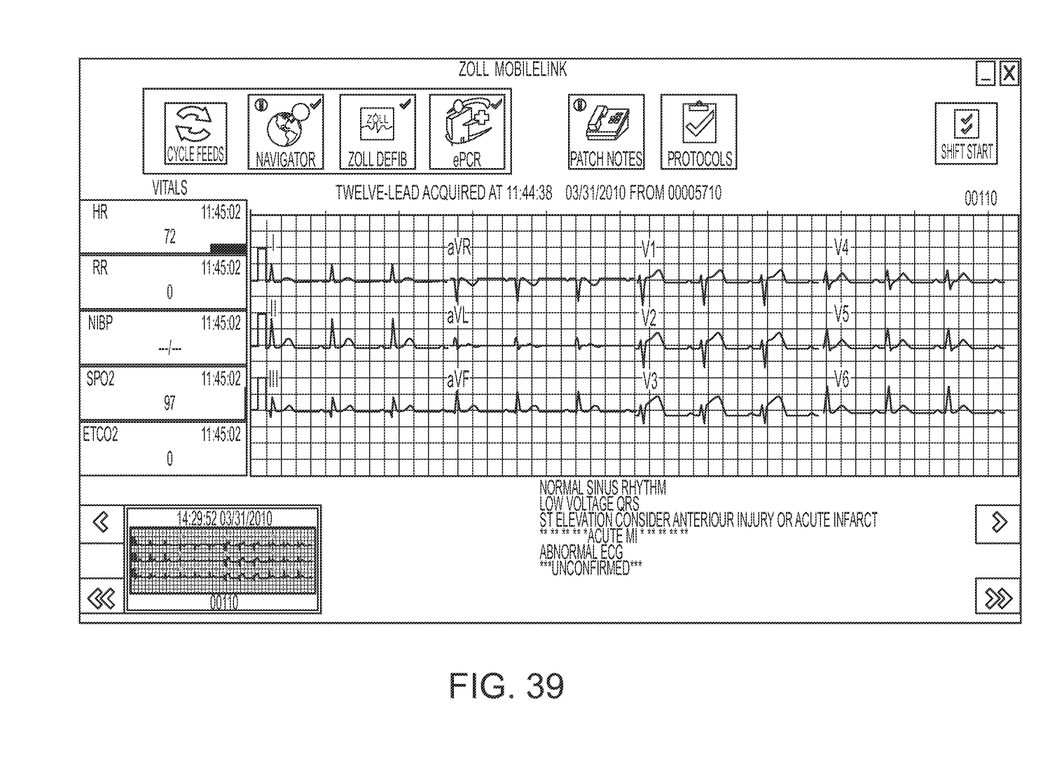

FIGS. 38-44 illustrate additional examples of screen shots displayed by BOA device 104, according to embodiments of the present invention. FIG. 38 illustrates a display and graphical user interface displayed when the user selects the patient charting button of a BOA menu template, according to embodiments of the present invention. FIG. 39 illustrates a display and graphical user interface displayed when the user selects the patient monitoring button of a BOA menu template, according to embodiments of the present invention. As illustrated by the thumbnail twelve-lead image in the bottom left corner, this BOA device 104 may be configured to display historical snapshots of past twelve-lead data, according to embodiments of the present invention.

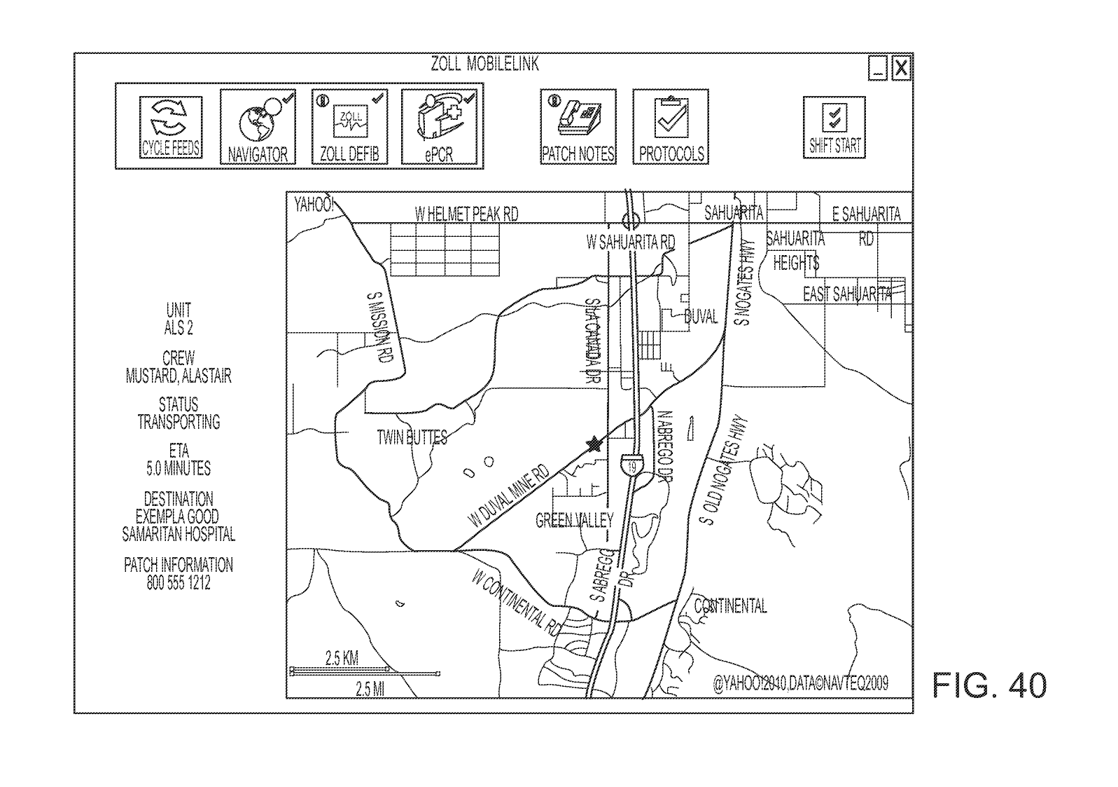

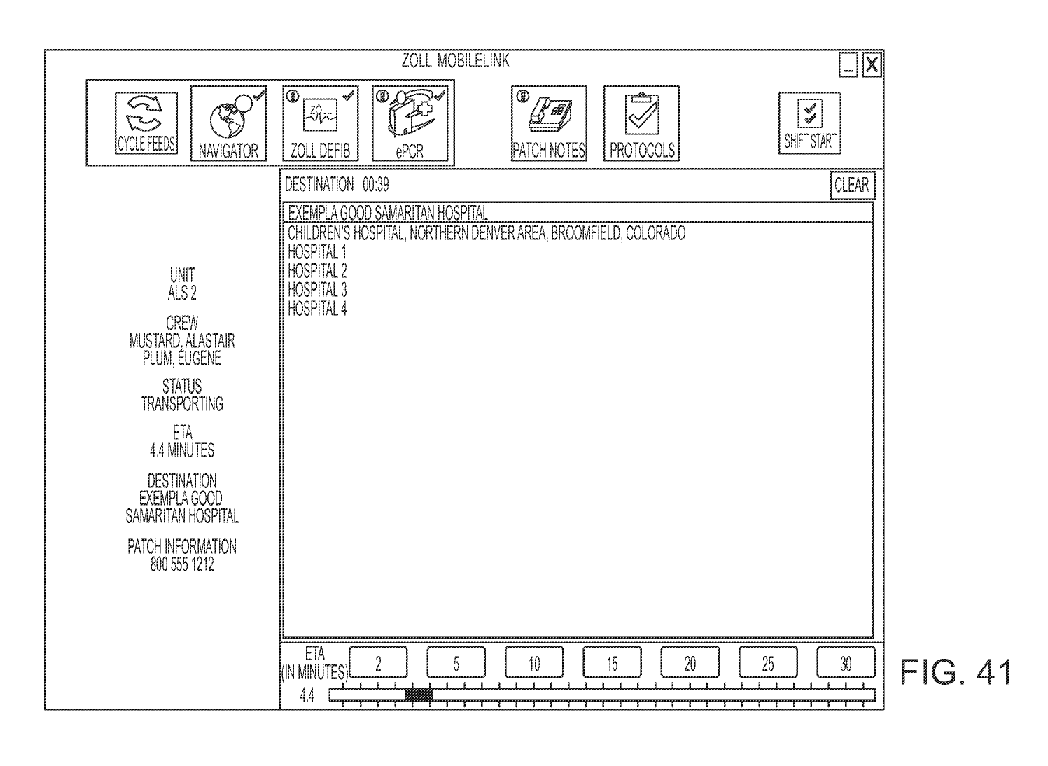

FIG. 40 illustrates a display and graphical user interface displayed when the user selects the navigation button of a BOA menu template, according to embodiments of the present invention. FIG. 41 illustrates an alternative display and graphical user interface displayed when the user selects the navigation button of a BOA menu template, in situations in which a navigation device 110 is not communicably coupled to the BOA device 104. In such situations, the screen of FIG. 41 is configured to permit a user to manually select a destination, as well as select an estimated time of arrival, according to embodiments of the present invention. This information may be replicated or otherwise transmitted to the corresponding enterprise view (e.g. FIG. 36), according to embodiments of the present invention.

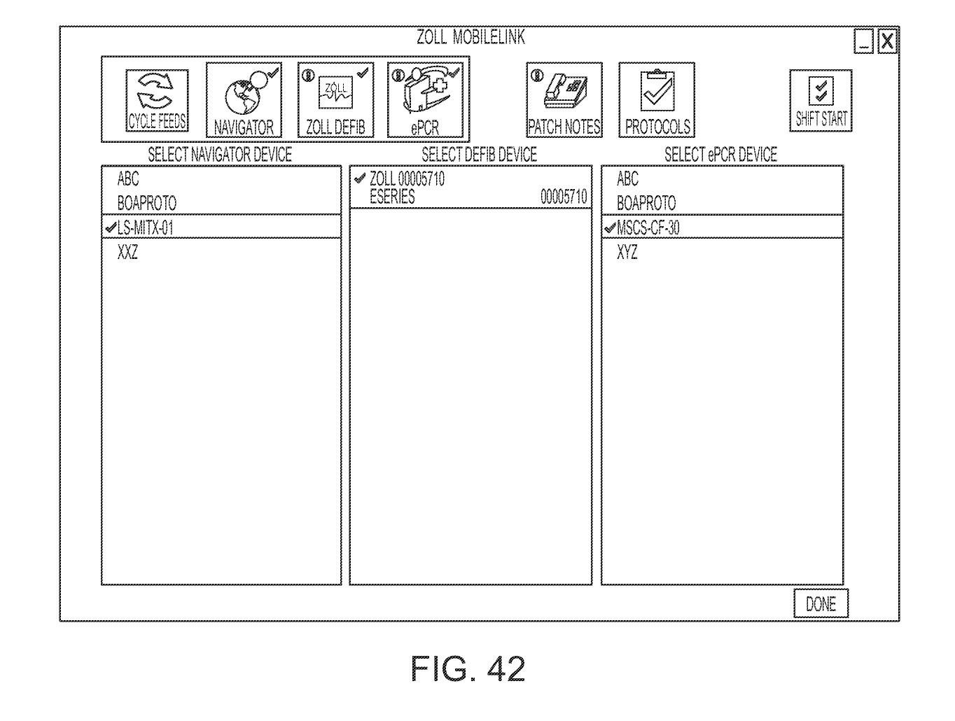

FIGS. 38-44 illustrate that a “shift start” button maybe included on the BOA device 104 interface. The shift start button may be used, for example, at the beginning of a shift, in order to permit the EMS technician or other user to communicably couple the BOA device 104 with other devices, according to embodiments of the present invention. FIG. 42 illustrates a display and graphical user interface displayed when the user selects the shift start button of a BOA menu template, according to embodiments of the present invention. In this screen, the user is permitted to select a navigation device, a defibrillator device, and a patient charting device; in this screen, the user is also able to confirm the identities of the devices to which the BOA device 104 is already communicably coupled, as indicated in this particular example by a checkmark next to the device name, according to embodiments of the present invention.

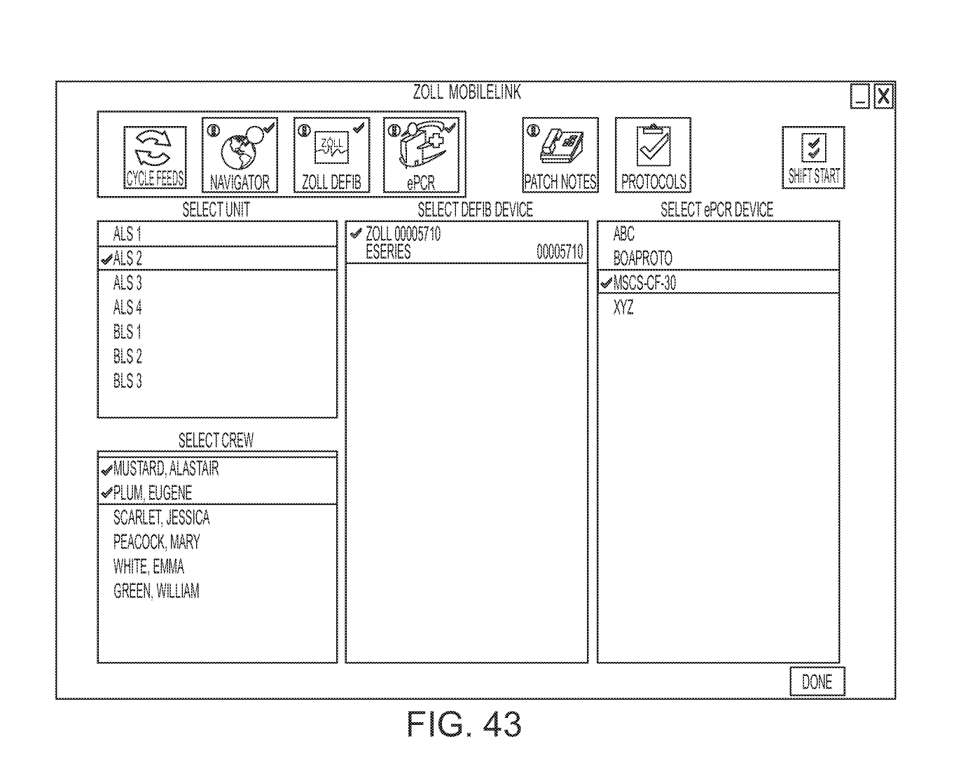

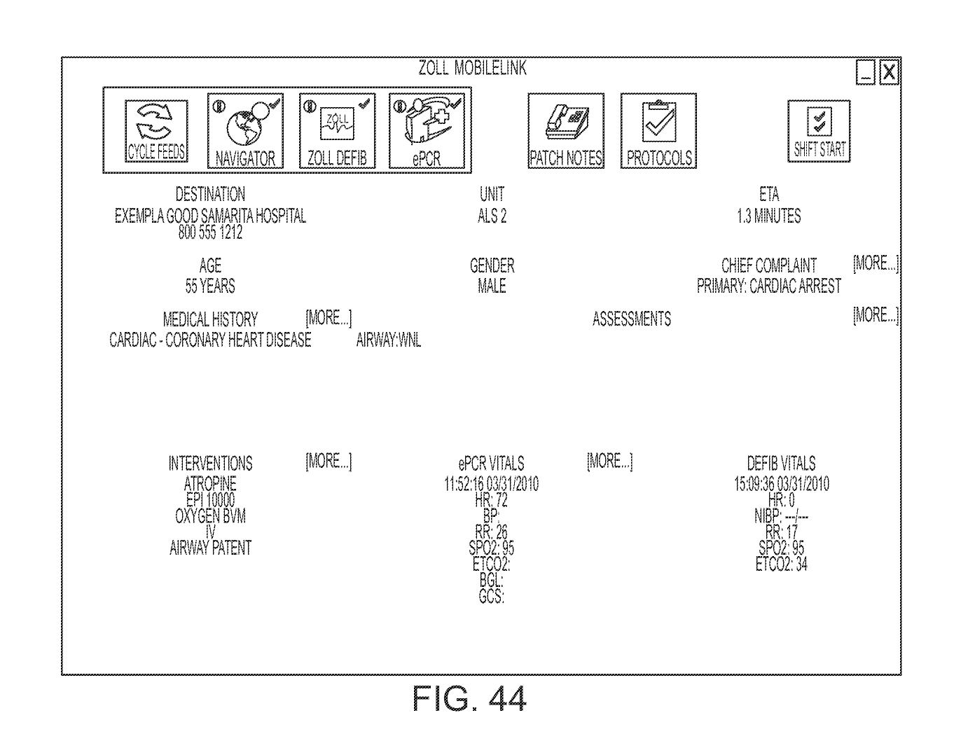

FIG. 43 illustrates an alternative display and graphical user interface displayed when the user selects the shift start button of a BOA menu template, according to embodiments of the present invention. In this alternative display, the BOA device 104 has sensed that a navigation device 110 is not available or is disconnected, and thus prompts the user to identify the EMS transport unit and/or the crew members present with the unit. This information may be used in the corresponding navigation screens for the BOA device (FIG. 41) and the enterprise environment 102 (FIG. 36). FIG. 44 illustrates a display and graphical user interface displayed when the user selects the patch notes button of a BOA menu template, according to embodiments of the present invention.

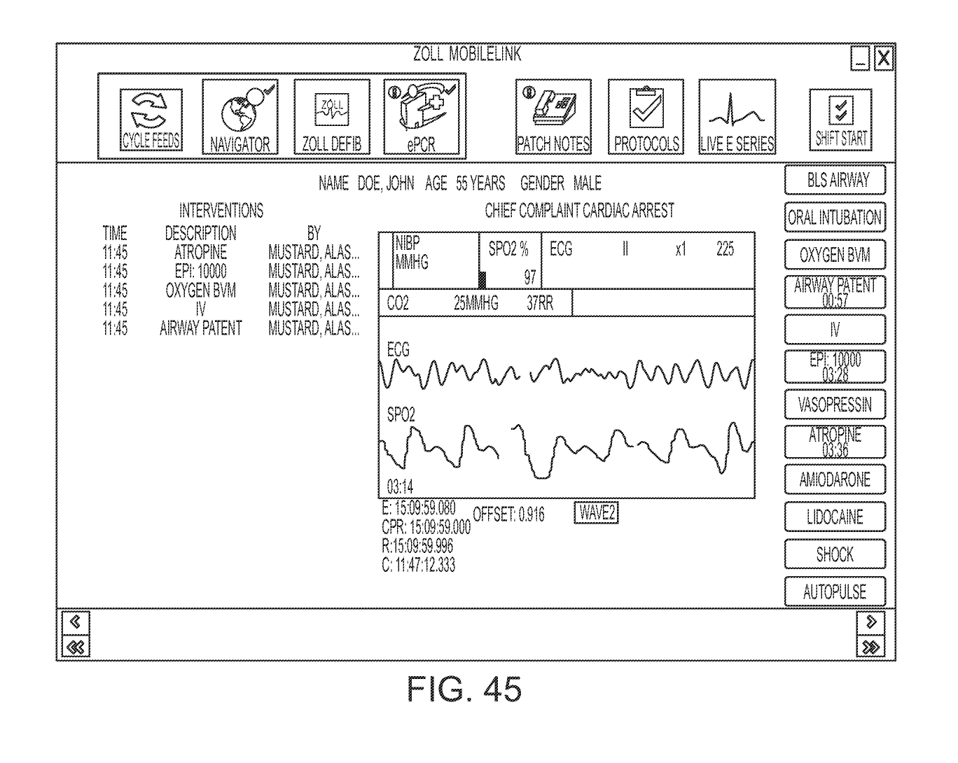

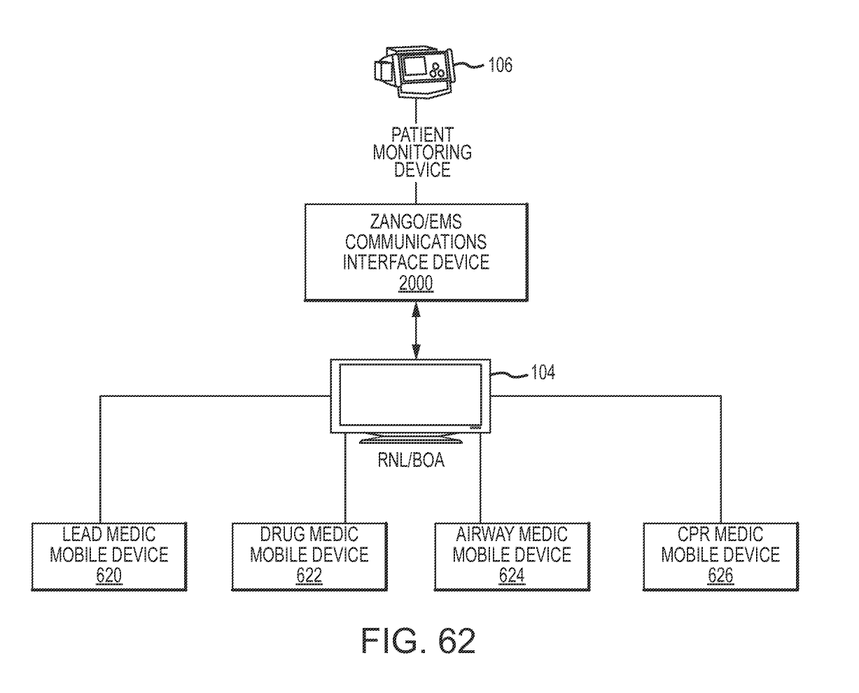

FIG. 62 illustrates a system for role-based data feeds from a BOA device to EMS technician mobile devices, according to embodiments of the present invention. BOA device 104 receives streaming ECG data and other data from the patient monitoring device 106, which may be accomplished wirelessly via an EMS communications interface device 2000 as described above, according to embodiments of the present invention. The BOA device 104 displays such information on a screen such as the screen illustrated in FIG. 45.

FIG. 45 illustrates a display and graphical user interface displayed when the user selects a live patient data button of a BOA menu template, according to embodiments of the present invention. This display includes a list of interventions, a display of patient information, a display of chief complaint, an ECG wave form and/or an SpO2 waveform, as well as a button console (shown as extending vertically on the right side of the screen) listing buttons for available patient interventions, according to embodiments of the present invention. The intervention button console may be dynamic and/or color-coded. The intervention button console may also include timers.

For example, when a patient's airway is checked, the EMS technician activates (e.g. pushes or touches) the “patient airway” button on the intervention button console. The button activates and displays a timer, which counts down to the next time when the patient's airways should be checked. This amount of time may be customized by the user and/or preprogrammed into the BOA module operating the BOA device 104 based on established treatment protocols for the locale in which the patient is treated. Color may also be used; for example, the buttons of the intervention button console may be normally gray, and the “patient airway” button may turn yellow as soon as the button is pushed and the timer activated. The button may turn red within a predetermined amount of time before expiry of the timer, for example one minute before the expiration of the time period being timed. For example, a user may look at the intervention button console of FIG. 45 and see that doses of Epi and Atropine have recently been administered, because those buttons are yellow and their timers activated, while also seeing that the patient's airway was previously checked and is about ready to be checked again, because that button is red. This permits the EMS technician to rapidly visually assess which interventions have been made, as well as which interventions should (or may, according to protocol) be considered in the near future, for any point in time.

Different EMS technicians may have different roles to play in an EMS scenario, based on their training or qualifications, the number of available technicians, and the status of the patient. In the same way, a single EMS technician may need to play multiple roles in an EMS encounter. Such EMS technicians may more effectively and efficiently perform their corresponding tasks if they are presented only with the information related to their particular role, such that they do not see extraneous information which they must mentally process and filter, and such that they are not presented with decision-making or data input options that do not apply to their role. One way in which such role-based information delivery may be accomplished is by providing each EMS technician with a mobile device with software configured to permit an interface with a BOA device 104 based on the user's role.

FIG. 62 illustrates examples of such mobile devices communicably coupled to BOA device 104, including a lead medic mobile device 620, drug medic mobile device 622, airway medic mobile device 624, and CPR medic mobile device 626, according to embodiments of the present invention. According to embodiments of the present invention, each mobile device 620, 622, 624, 626 includes a WiFi transceiver that communicates wirelessly with a WiFi transceiver of BOA device 104.

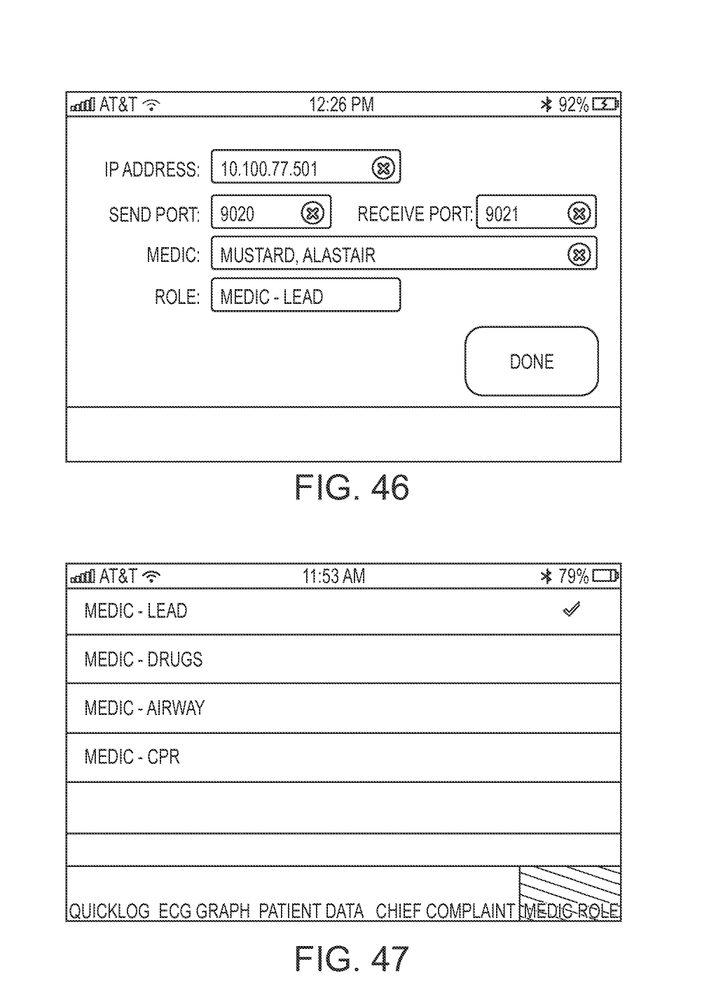

FIG. 46 illustrates a start screen for a role-based EMS technician mobile device 620 in communication with a BOA device 104, according to embodiments of the present invention. The software instructions contained on the mobile device render this start screen to permit the medic to identify the IP Address, send port, receive port, medic name, and medic role, according to embodiments of the present invention. FIG. 47 illustrates a role selection screen for a role-based EMS technician mobile device in communication with a BOA device, according to embodiments of the present invention. A checkmark next to the “Medic-Lead” listing indicates that the user of the mobile device is the lead medic. According to embodiments of the present invention, a password or other authentication may be required in order to restrict role based on identity.

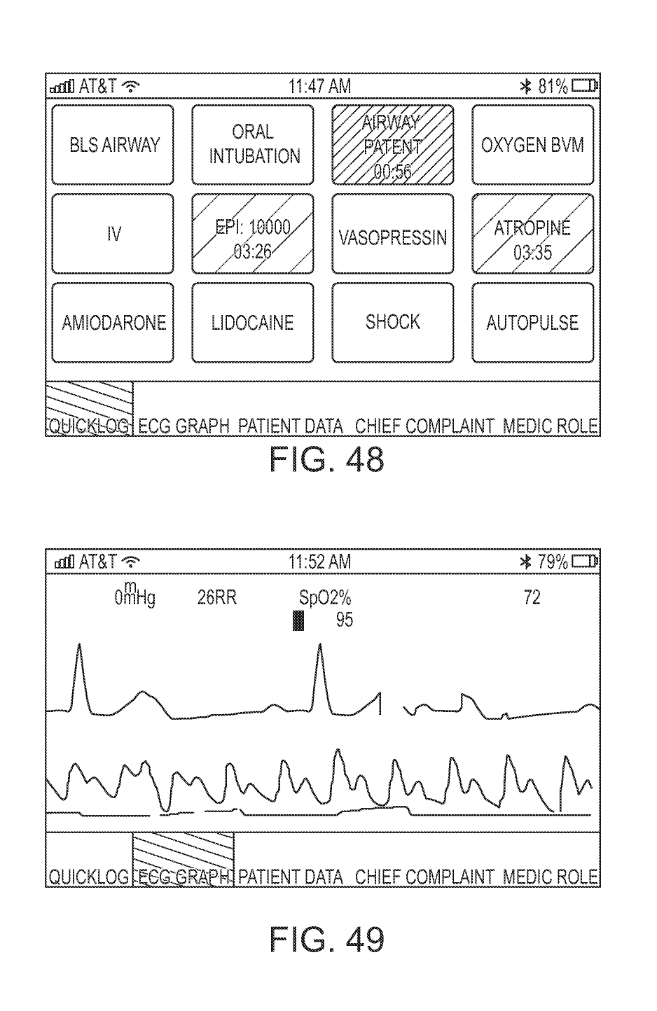

FIG. 48 illustrates a lead medic quick log screen for a role-based EMS technician mobile device in communication with a BOA device, according to embodiments of the present invention. The mobile device may be configured to display a list of menu options, for example the menu options shown extending horizontally along the bottom of the screen of FIG. 48 permit the lead medic to choose Quick Log, ECG Graph, Patient Data, Chief Complaint, and Medic Role. These options may differ based the user's role. When the lead medic clicks on the Quick Log tab, the lead medic is presented with an intervention button panel, according to embodiments of the present invention. The quick log tab display replicates the intervention button console of the BOA live ECG display of FIG. 45, such that when a lead medic pushes an intervention button on the mobile device via the screen of FIG. 48, the same button (and corresponding timer and/or color) is indicated as being activated in the BOA display screen of FIG. 45, and vice versa, according to embodiments of the present invention.

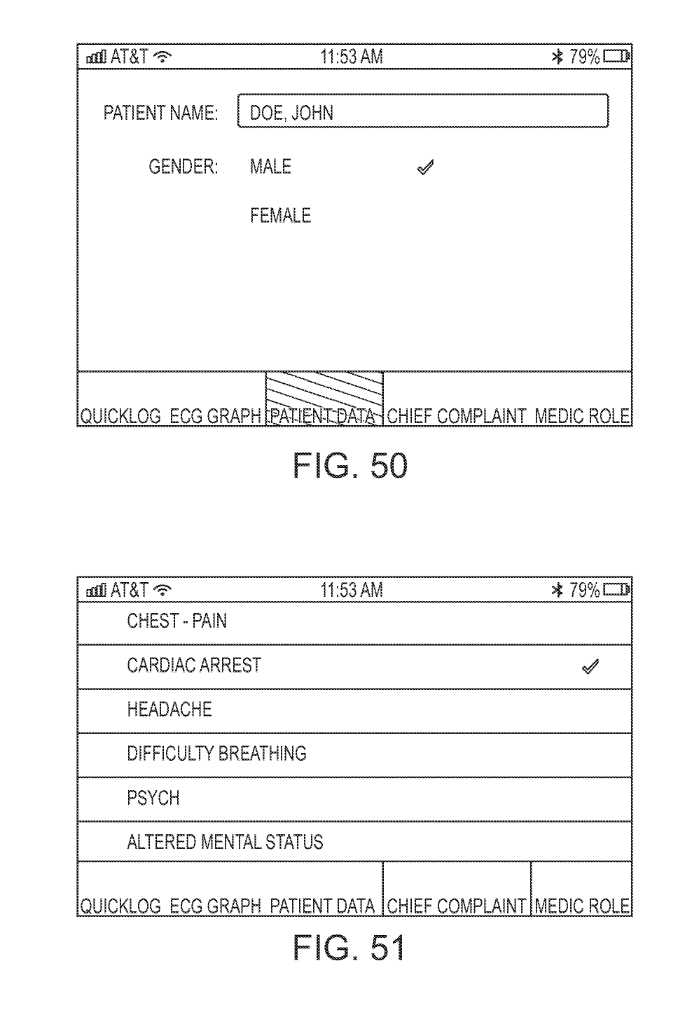

FIG. 49 illustrates a lead medic ECG graph screen for a role-based EMS technician mobile device in communication with a BOA device, according to embodiments of the present invention, which is displayed for the lead medic when the lead medic selects the ECG graph menu button. Because the lead medic's role typically requires a broad swath of patient information, the lead medic ECG graph screen essentially recreates the patient data display screen of the BOA device 104 of FIG. 45, according to embodiments of the present invention. FIG. 50 illustrates a lead medic patient data screen, which permits the lead medic to enter patient information, including the patient's name and gender, according to embodiments of the present invention. FIG. 51 illustrates a lead medic chief complaint screen which permits the lead medic to identify the patient's chief complaint, according to embodiments of the present invention.

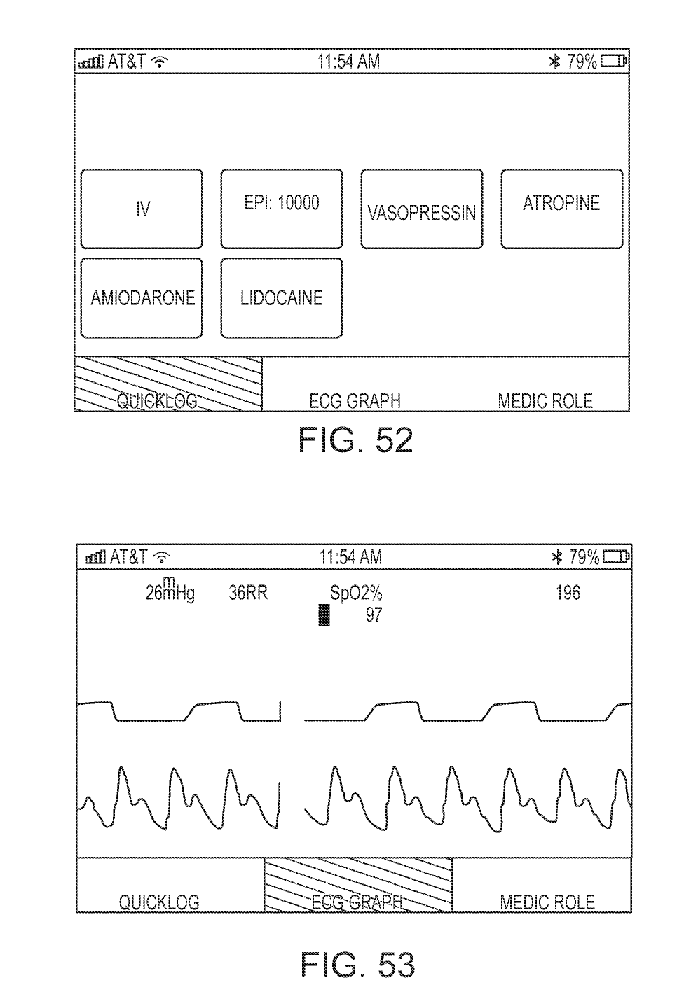

FIG. 52 illustrates a drug medic quick log screen and FIG. 53 illustrates a drug medic ECG graph screen for a medic who has identified his or her role as drug medic, according to embodiments of the present invention. Because the medic has identified a role of drug medic, the quick log screen presents only a subset of the interventions which relate to drugs, according to embodiments of the present invention. Although the drug medic role accesses only a subset of the full set of intervention buttons, the same intervention buttons are tied together across the entire platform, according to embodiments of the present invention. For example, if the drug medic indicates that a dose of atropine has been given by tapping the atropine intervention button on his mobile device 622, the atropine button will turn yellow as activated, and begin a timer, not only on his mobile device 622, but also on atropine buttons of the quick log screen of the lead medic device 620 and on the intervention button console of the BOA device 104 display, as well as any other devices whose quick log screens include the atropine intervention button, according to embodiments of the present invention.

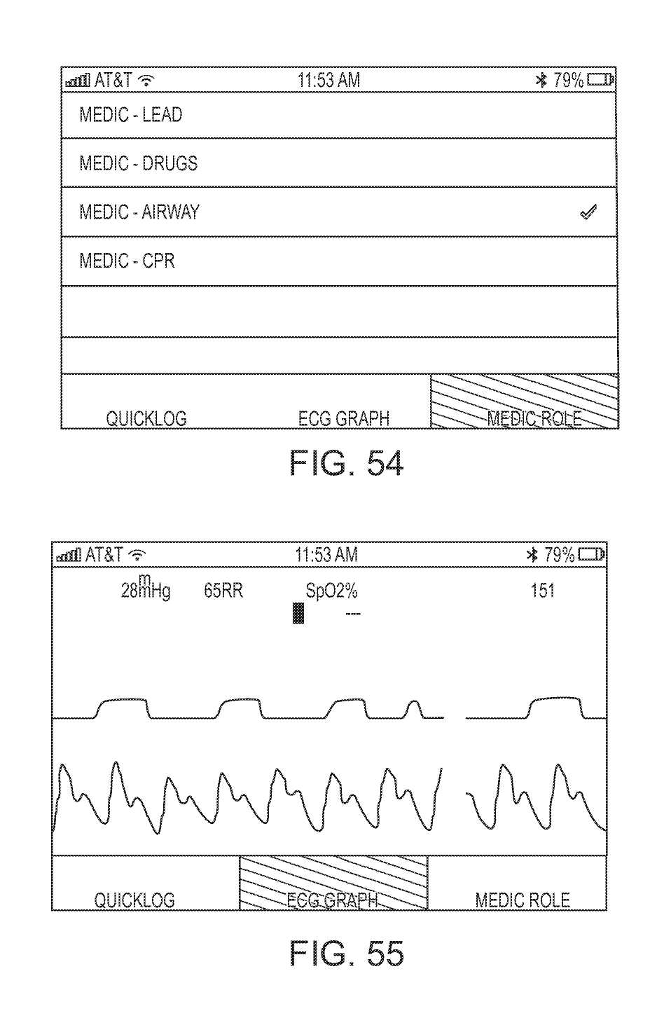

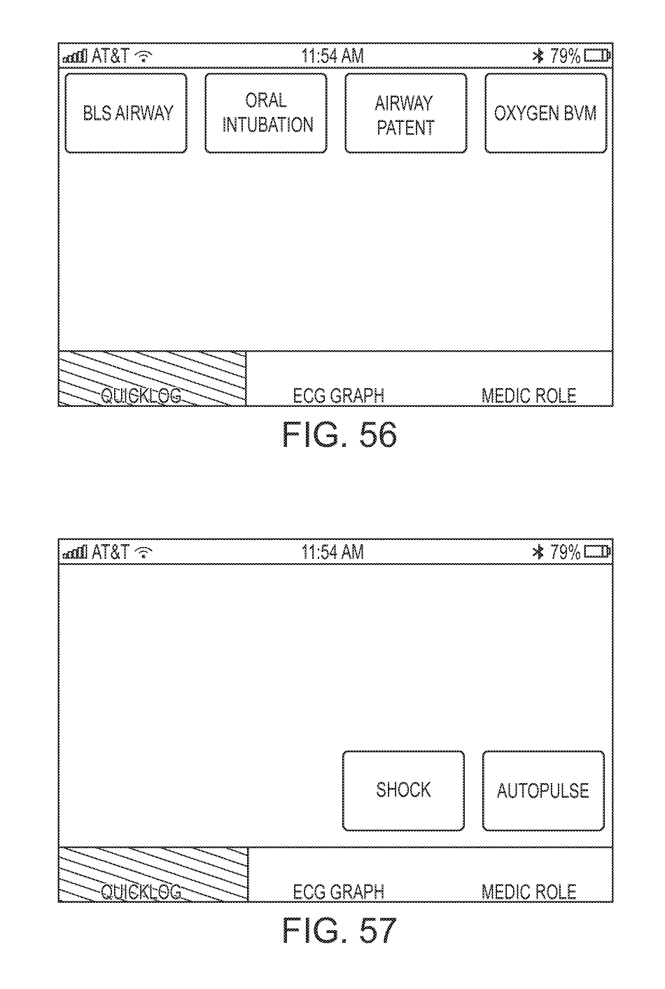

FIG. 54 illustrates a role selection screen in which an airway medic role has been identified (e.g. by tapping or otherwise selecting that option on the mobile device 624). FIG. 55 illustrates an airway medic ECG graph screen, and FIG. 56 illustrates an airway medic quick log screen listing the subset of interventions that relate to the airway medic's role, according to embodiments of the present invention.

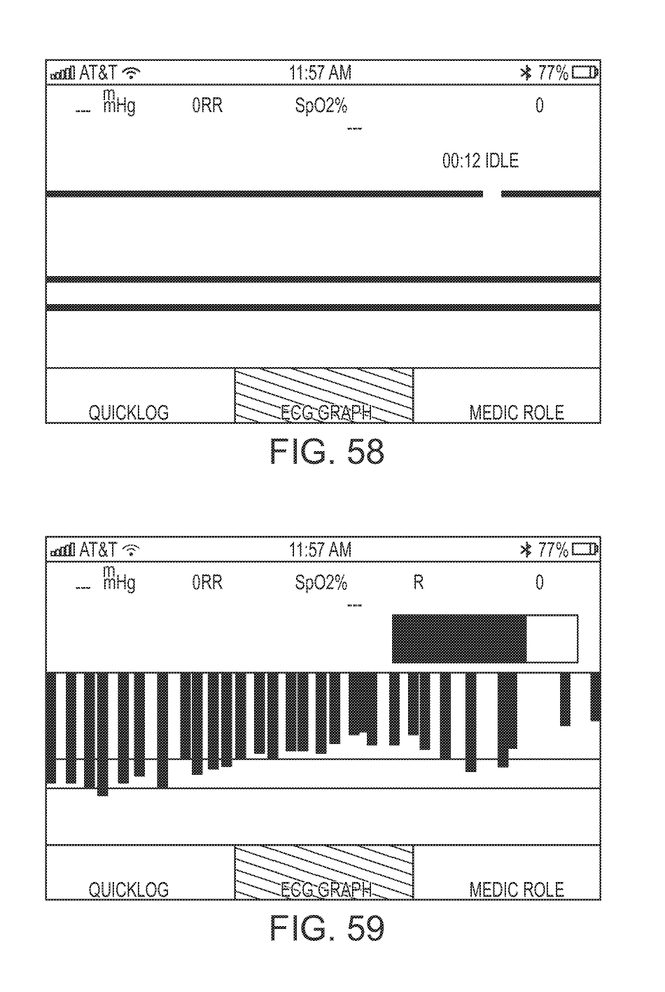

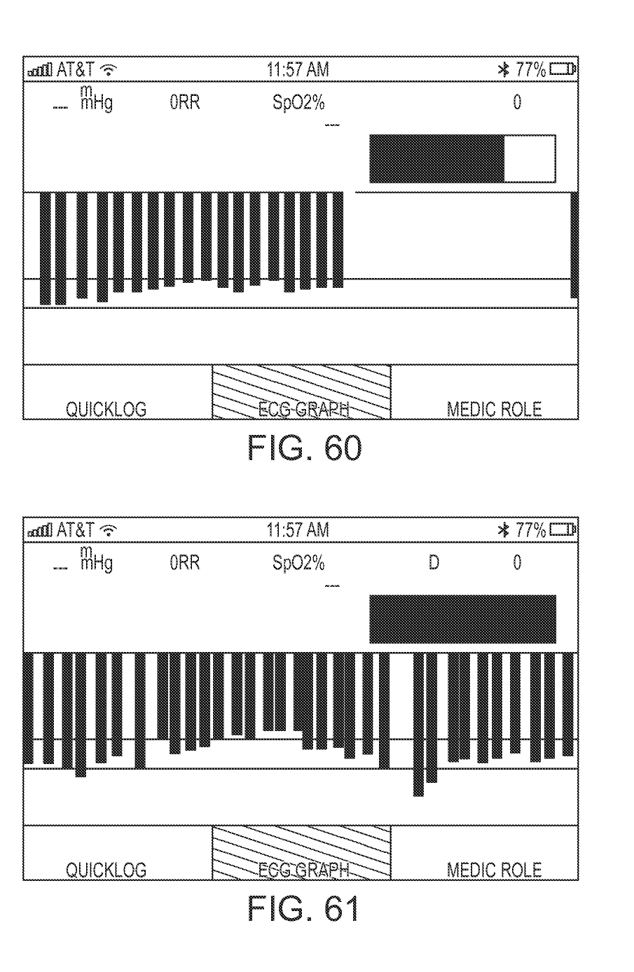

FIG. 57 illustrates a CPR medic quick log screen illustrating a subset of interventions that relate to the CPR medic's role, according to embodiments of the present invention. FIG. 58 illustrates a CPR medic ECG graph screen during idle for a role-based EMS technician mobile device in communication with a BOA device, according to embodiments of the present invention. FIGS. 59-61 illustrate a CPR medic ECG graph screen during administration of compressions, which do not show the ECG wave form but instead show measurement and/or evaluation of chest compressions (because the CPR medic is concerned primarily with resuscitation), according to embodiments of the present invention. The CPR feedback provided by the screen interface of FIGS. 58-61 may take many different forms. For example, as illustrated in FIG. 59, vertically descending bars may be used to represent depth of each chest compression, spaced horizontally in a manner along a time axis. The chest compression bars descend from an axis toward another set of axes, which specify the desirable or optimal range of depth for each chest compression. A qualitative indicator bar, shown in the upper right, gives the user a combined visual feedback relating to depth and rate of chest compressions; a full box means that both the rate and depth are within desired limits. The letter “R” on FIG. 58 indicates a potential alert regarding the rate of the chest compressions, and the letter “D” on FIG. 61 indicates a potential alert regarding the depth of chest compressions, according to embodiments of the present invention. According to embodiments of the present invention, the CPR feedback screen of device 626 provides information about the rate and volume of patient ventilation.

According to embodiments of the present invention, the patient monitoring device 106 and/or EMS communications interface device 2000 and/or the BOA device 104 includes a filtering mechanism (e.g. a circuit or processing instructions) that filters or removes chest compression interference from ECG signal data. Embodiments of the present invention may include a device or utilize a method similar to those described in U.S. Pat. No. 7,295,871, issued Nov. 13, 2007, which is incorporated by reference herein. Embodiments of the present invention may also employ Real CPR Help® technology available from Zoll Medical Corporation.

The use of role-based information delivery and intervention tracking permits a more efficient EMS treatment scenario by filtering data based on role, according to embodiments of the present invention. For example, the drug medic, airway medic, and CPR medic do not have menu tab selections available for patient data entry or for chief complaint entry, while the lead medic has those options.

Although only four mobile devices 620, 622, 624, and 626 are shown in FIG. 62, the BOA device 104 may communicably couple with a greater or fewer number of role-based mobile devices. Also, although particular intervention options and data feed displays are shown as being related to particular roles, one of ordinary skill in the art, based on the present disclosure, will appreciate the numerous different roles that may be identified and implemented, as well as the numerous different data feeds and/or options that may be associated with each role. Further, mobile devices (e.g. 620) may be configured to communicably couple with multiple BOA devices 104 and/or to receive information for multiple patients from the same BOA device 104, to permit the medic to toggle between various patient data feeds and/or to treat different patients, possibly in different roles, according to embodiments of the present invention.

According to embodiments of the present invention, the software modules and hardware contained within the BOA device 104 for feeding the data to and from the mobile devices 620 may be consolidated into an EMS communications interface device 2000, and/or directly into a patient monitoring device 106.

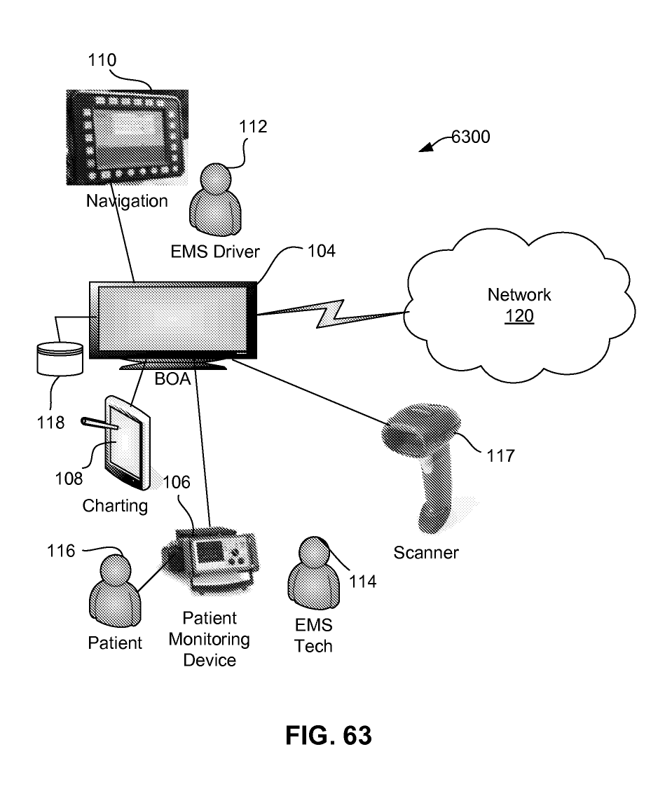

FIG. 63 illustrates a system 6300 similar to system 100, including a scanner device 117. Scanner device 117 may be a bar code scanner, such as, for example, a two-dimensional or “2D” bar code scanner with imaging capabilities. Scanner device 117 may be, for example, a Symbol DS-6707-DP barcode scanner with imaging capability. Bar code scanner 117 may be communicably coupled with BOA device 104, for example with a USB, Bluetooth®, RS232, or other connection. The bar code scanner 117 may be configured to capture and transmit to a PC (e.g. BOA device 104) bar code data and/or image data, according to embodiments of the present invention. The bar code scanner 117 may be a handheld bar code scanner, or may be a stationary scanner attached to the emergency vehicle 101 or another device. Multiple scanners 117 may be communicably coupled with BOA device 104, and may be of different types.

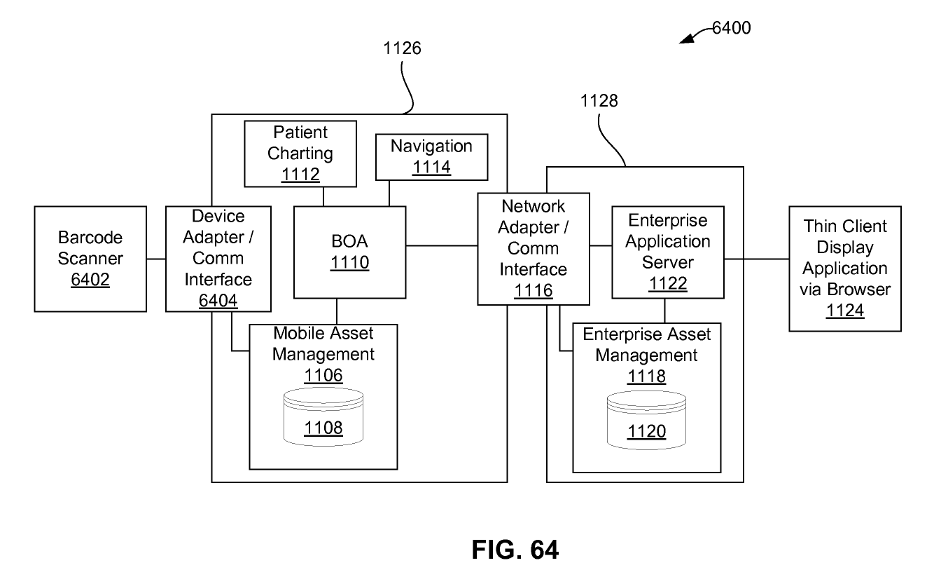

FIG. 64 illustrates a treatment domain system 6400 overview for real-time display of medical information collected from multiple different EMS devices, including a bar code scanner, according to embodiments of the present invention. The various modules shown in FIG. 64 function or perform the same as or similarly to the corresponding modules of FIG. 11; specifically, FIG. 64 illustrates how such modules may perform in the context of a connection with a bar code scanner device. The software operating on the bar code scanner 6402 captures and sends bar code data and/or image data via a communicable coupling with mobile domain module 1126. The device adapter/communications interface module 6404 receives the raw bar code data and/or raw image data and arranges it into XML documents according to schemas based on the particular data type. The BOA module 1110 and/or mobile asset management module 1106 and/or patient charting module 1112, which may be subscribed to the particular communication interface 6404 or otherwise able to receive events or notifications based on the creation of a particular bar code XML documents by the communications interface 6404, may receive the bar code XML documents and update patient records, system status, inventory records, intervention records, or otherwise store or transmit the bar code or image data.

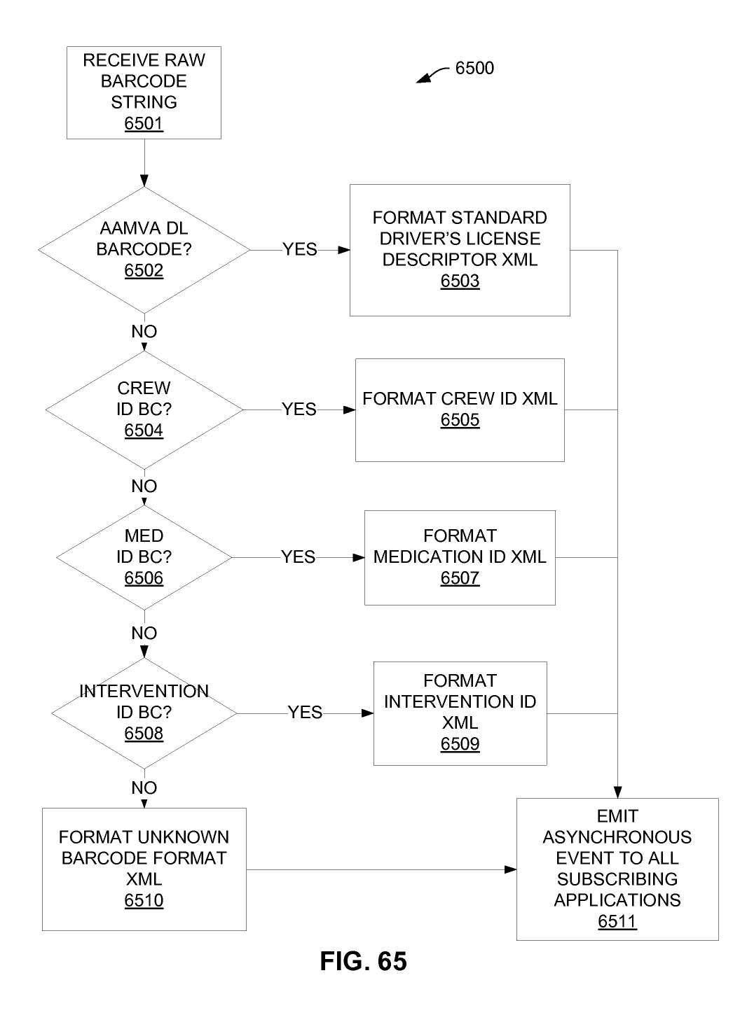

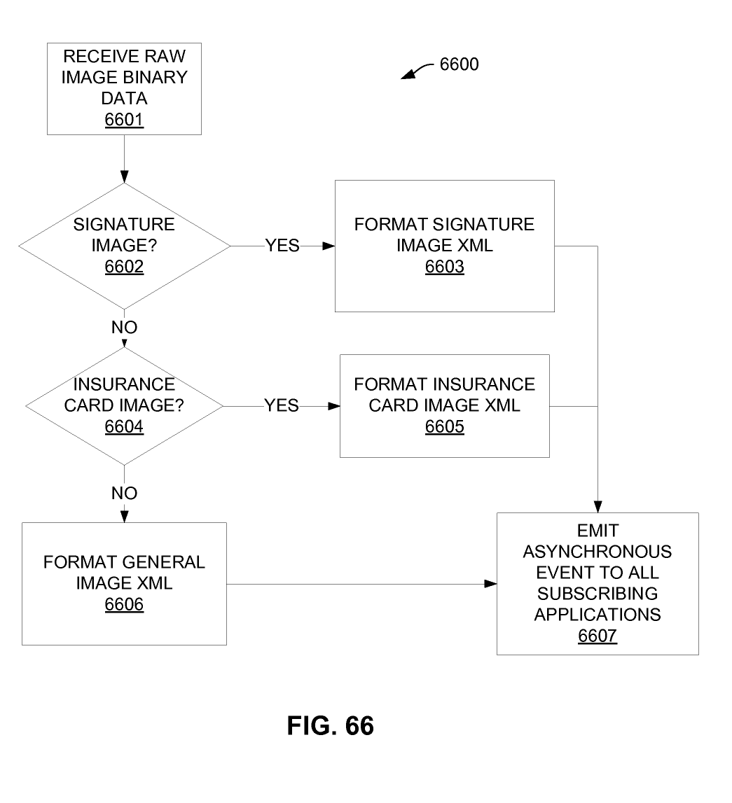

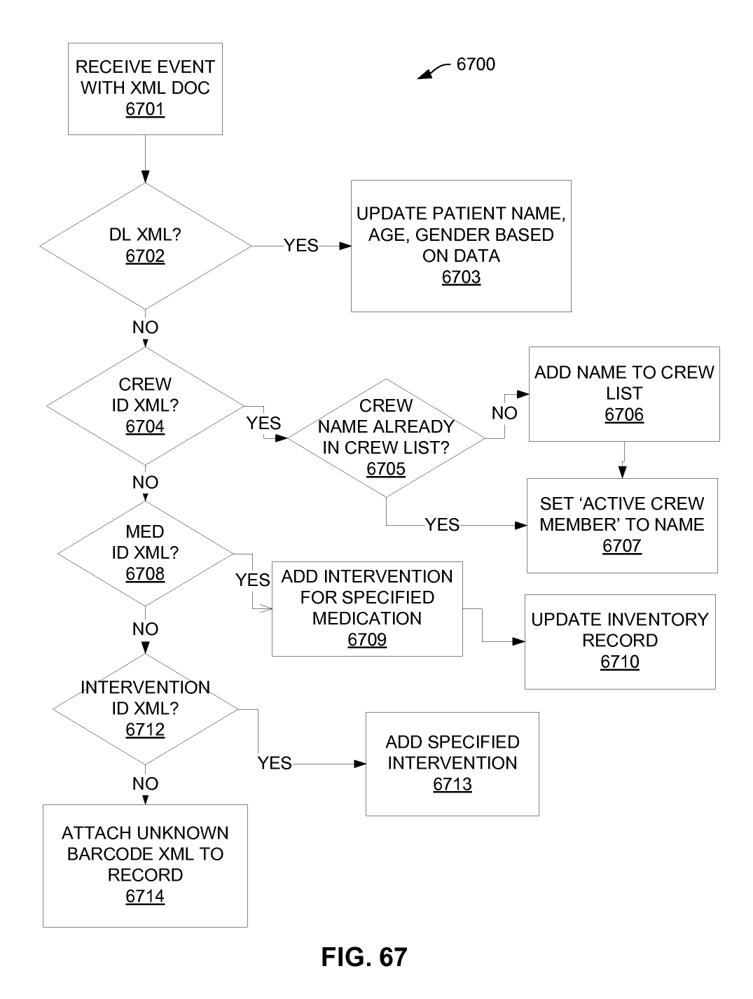

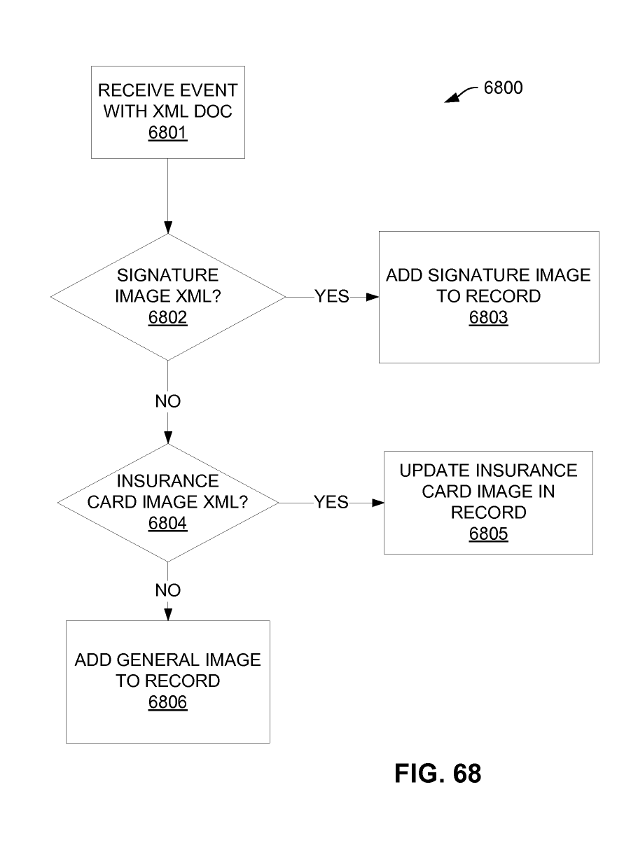

FIGS. 65 and 66 illustrate flow charts describing methods for handling bar code and image data received from the bar code scanner, and may be performed by the device adapter/communications interface module 6404, according to embodiments of the present invention. FIGS. 67 and 68 illustrate flow charts describing methods for handling bar code and image XML documents received from the communications interface module 6404, and may be performed by the BOA module 1110 and/or mobile asset management module 1106, according to embodiments of the present invention. Although particular XML documents are discussed, one of ordinary skill in the art will recognize, based on the disclosure provided herein, that the particular XML documents and/or schemas employed may be customized to particular data types, and/or particular device capabilities. Although particular examples of data types are described herein, similar configurations and methods may be used to receive other types of information receivable by a scanner. And although the use of XML is described, one of ordinary skill it the art, based on the disclosure provided herein, will recognize that other languages and/or protocols, for example object-oriented programming languages, may be used to exchange information between the various devices and/or modules distributed on those devices, according to embodiments of the present invention.

FIG. 65 illustrates a flow chart 6500 describing a method for handling bar code data received from a bar code scanner, according to embodiments of the present invention. The device adapter 6404 receives a raw bar code string (block 6501). The format of the data, or a header or other specific portion of the data, is checked to determine whether the raw bar code string is in American Association of Motor Vehicle Administrators (AAMVA) format (block 6502), and if so, the bar code string is recognized as corresponding to a driver's license, and a driver's license descriptor XML document is formatted based on the data in the raw bar code string (block 6503). An asynchronous event is emitted to subscribing applications (block 6511) with the driver's license XML document. The device adaptor 6404 may be configured to check for other present or future standard driver's license formats, in addition to or instead of AAMVA, according to embodiments of the present invention. The steps of FIG. 65 involving data format checks may be performed in varying order, according to embodiments of the present invention.

If the raw bar code string is not in a driver's license format, the format of the data, or a header or other specific portion of the data, is checked to determine whether the raw bar code string is a crew identifier bar code (block 6504). If so, then a crew ID XML document is formatted based on the data in the raw bar code string (block 6505). The data may include the crew member's name, a unique identifier corresponding to the crew member, and/or other crew member identifying information, according to embodiments of the present invention. An asynchronous event is emitted to subscribing applications (block 6511) with the crew identifier XML document.

If the raw bar code string is not a crew identification bar code, the format of the data, or a header or other specific portion of the data, is checked to determine whether the raw bar code string is a medication identifier bar code (block 6506). If so, then a medication ID XML document is formatted based on the data in the raw bar code string (block 6507). The data may include a name of the medication, a dosage amount, a unique identifier (e.g. a number) corresponding to the medication, and/or other medicine identifying information, according to embodiments of the present invention. An asynchronous event is emitted to subscribing applications (block 6511) with the medication identifier XML document.

If the raw bar code string is not a medicine identification bar code, the format of the data, or a header or other specific portion of the data, is checked to determine whether the raw bar code string is an intervention identifier bar code (block 6508). If so, then an intervention ID XML document is formatted based on the data in the raw bar code string (block 6509). The intervention data may include an intervention description, a date, a time, a duration, a dosage or amount, or other intervention identifying information, according to embodiments of the present invention. An asynchronous event is emitted to subscribing applications (block 6511) with the intervention identifier XML document.

If the communications interface module 6404 is unable to identify the raw bar code string as a particular data type, the content of the data may be formatted into an unknown bar code format XML document (block 6510), which may then be asynchronously emitted to subscribing applications (block 6511), according to embodiments of the present invention. Although FIG. 65 describes four possible data types which can be recognized and formatted into XML documents, the recognition and XML formatting for numerous other data types may be performed.

FIG. 66 illustrates a flow chart 6600 describing a method for handling image data received from a bar code scanner, according to embodiments of the present invention. Raw image binary data is received (block 6601). A determination is made about whether the raw image binary data is a signature image (block 6602). This determination may be performed in numerous ways. For example, a special symbol or bar code may be placed to one or both sides of a signature block on a printed or electronic document, such that when a 2D bar code scanner receives the image, a flag or other indicator is included to indicate that the image is a signature image. The image data in this case may also include an identification of the particular document to which the signature image pertains. The signature image may then be formatted into an XML document (block 6603), and asynchronously emitted to subscribing applications and/or devices (block 6607).

If the image is not a signature image, a determination is made about whether the raw image binary data is an insurance card image (block 6604). This determination may also be performed in numerous ways. For example, a special symbol or bar code on the insurance card may indicate this data type, or image processing software may be used to recognize the image as an insurance card based on its size and/or the presence of one or more numbers, letters, and/or colors. An insurance card XML document may then be formatted based on the insurance card image (block 6605), and the XML document may be asynchronously emitted to subscribing applications (block 6607).

If the image is not recognized as any particular data type, the raw image binary data may be formatted into a general image XML document (block 6606) and asynchronously emitted to subscribing applications (block 6607), according to embodiments of the present invention.

FIG. 67 illustrates a flow chart 6700 describing a method for handling bar code XML records received from the communications interface module 6404, according to embodiments of the present invention. An event, such as an asynchronous event, is received (block 6701). A determination is made about whether the XML document is a driver's license XML document (block 6702), and if it is, then patient records are updated with data from the driver's license XML document (block 6703). This data may include a patient's name, age, gender, birth date, weight, driver's license number, social security number, and/or whether the patient is an organ donor. This information may be used to update one or more fields in records stored or displayed by BOA system 104 and/or associated systems. In an EMS context, in which time is often of the essence, and in which the patient may be nonresponsive or unable to verbally provide this information, being able to scan a bar code on a patient's driver's license and auto-populate patient charting information saves valuable time and facilitates patient treatment.

This patient information obtained with a driver's license bar code scan may be used in various ways, both at the time of treatment and afterwards. For example, the BOA system 104 may receive a driver's license XML indicating that the current patient is a male who is eighty years old, and may then send a configuration request to a defibrillator or other patient monitoring device 106 to configure itself for a male patient who is eighty years old. Without the facilitated input permitted by a driver's license bar code scan, the EMS technician 114 would typically need to ask the patient or a relative for this information for charting or treatment purposes, manually enter the information onto a chart, and then manually configure the patient monitoring device 106, thereby using valuable patient treatment time for such administrative tasks. The BOA system 104 may also use driver's license information for identification and/or authentication purposes, for example to match the treated patient with an individual insured record for insurance or billing purposes.

The information obtained with a driver's license bar code scan may also be transmitted and/or stored in the administrative environment 103, for example on a storage server 126. This information, or subsets of it, may also be displayed and/or stored in the enterprise environment 102.

If the XML document received is not a driver's license XML document, a determination is made whether the XML document is a crew identification document (block 6704), and if so, a determination is made whether the person identified in the XML document is already listed in a crew list (block 6705). For example, each ambulance 101 may include an electronic record indicating the current crew members operating the ambulance, and/or their roles in the crew. As a new crew member comes on board, or as a new crew starts their shift aboard the ambulance (or fire truck or other emergency vehicle), the crew member may scan a crew identification bar code with the bar code scanner 117. The crew identification bar code may be included on a crew member identification badge, for example. In another example, the crew member scans a bar code on the crew member's driver's license, and the BOA system 104 recognizes (at block 6703) whether the identification belongs to an employee in a database of potential crew member employees. In some cases, the BOA system 104 may prompt the crew to select whether the individual whose driver's license has been scanned should be identified as a part of a crew, or as a patient. The bar code scanner 117 sends the crew identification to the BOA system 104, and if the crew member is not on the current crew list, the crew member's name or identification is added to the crew list (block 6706). After the crew member has been added to the crew list, or if the crew member was already on the crew list, the BOA system 104 sets the “active crew member” to the name or identification of the crew member whose identification was most recently scanned (block 6707). This has the effect of automatically defaulting the treatment provider/crew member to the most recently scanned crew member for BOA system 104 input actions which require identification of a crew member, for example the administration of a medication. According to an alternative embodiment of the present invention (not shown), each time a crew identification XML document is recognized, the BOA system 104 prompts a user (either the same person whose crew ID was scanned, or another crew member) to select a desired action, such as “add crew member,” “remove crew member,” “identify as patient,” and “set to active crew member.” The crew identification bar code scanned may also originate from an electronic source, such as from the screen of a crew member's mobile electronic device, according to embodiments of the present invention. Any prompting may be provided on the BOA system 104 display, and/or on the display of the mobile device, according to embodiments of the present invention.

According to embodiments of the present invention, the enterprise storage server 126 and/or enterprise application server 128 monitor the crew lists for multiple sets of emergency vehicles 101, and when a new crew member logs onto the crew list of one vehicle 101, the servers 126, 128 notify the BOA system 104 of the vehicle or crew on which the particular crew member was previously logged. The crew member may be automatically logged off of one vehicle or crew when the crew member logs in to another vehicle or crew, or one or both of the new and old vehicle or crew may be prompted or alerted of the crew change action. This may prevent the same crew member from being listed in the active crew lists of more than one crew or vehicle at the same time, according to embodiments of the present invention. Although use of the crew member bar code identification logging is described with respect to vehicles, the crew member may be logged into and out of multiple different crews or teams, even overlapping crews or teams, which are tracked electronically, even independently of any building or vehicle.

If the XML document received at block 6702 is not a crew identification XML document, a determination is made whether the XML document is a medication identification XML document (block 6708). If so, a patient intervention may be logged into BOA system 104 and/or related or subscribed systems, to indicate that a particular medication has been dispensed (block 6709). Different medications may include different bar codes, and different dosages of the same medication may also include unique bar codes, so that an EMS technician 114 may simply grab a package of medication to be dispensed, scan the box or tag or bottle or other bar code on or associated with the medication, and then administer the medication to the patient. In this way, the patient charting and other activities that would normally be required in association with the dispensing of the medication may be accomplished automatically, and/or in a more efficient fashion, to permit the EMS technician 114 to focus more time and attention to patient care. The medication identification XML may include a name of the medication, a unique identifier of the medication (such as, for example, a drug code), a dosage indication, a date, and/or a time, according to embodiments of the present invention. The BOA system 104 may log the medication intervention by associating the medication intervention information with a particular patient and a particular crew member administering the medication, as well as a date and time, according to embodiments of the present invention. For example, the BOA system 104 may automatically or by default store the medication intervention as having been administered by the “active crew member,” which may also be the most recent crew member to scan their crew ID into the bar code scanner 117. According to some embodiments of the present invention, the patient associated with the medication intervention is the current patient, or the most recent patient to be identified by the BOA system 104, for example via a bar code scan of the patient's driver's license.

Various prompts may optionally be provided during the medication administration or intervention logging process for confirmation or convenience, or the BOA system 104 may be configured to perform according to various crew member presets. For example, one crew member may indicate that she wishes to have all medications and interventions automatically logged to the active crew member. Another crew member may indicate that he wishes to be prompted for confirmation of each medication or intervention before such intervention is logged by the system. The BOA system 104 may automatically configure its settings based on the current active crew member, which may be the most recent person to scan their crew ID bar code with scanner 117, according to embodiments of the present invention. In a similar way, the BOA system 104 may also be configured to configure the settings of other devices with which it communicates. For example, the BOA system 104 may recognize, based on input previously received from a particular crew member, that the particular crew member prefers certain default settings of a defibrillator device 106 which that crew member finds easiest to use; when that crew member logs in to the crew list, or becomes the active crew member, the BOA system 104 may automatically send a command to the defibrillator device 106 to configure it according to the predetermined settings, according to embodiments of the present invention.

A bar code for a particular medication or dose of the medication may be included on the packaging of the medication, according to embodiments of the present invention. Alternatively, a bar code for a particular medication may be included in a separate location; for example, a document hanging in the back of each ambulance lists each medication and dosage, and provides a bar code at which the EMS technician 114 may point the scanner 117, and optionally push a button to active the scanner 117 for increased precision, to select a particular medication. Alternatively, the document with such bar code information may be worn by the EMS technician 114, for example on a sleeve of a garment for facilitated scanning with either a handheld or stationary scanner. According to some embodiments of the present invention, when the BOA system 104 receives the medication indication, the medication is checked against a database of medications previously administered during the EMS event (e.g. by the crew of the ambulance 101), and/or against a database of medications or drugs indicated in the patient's electronic chart as being recently or routinely taken by the patient. The BOA system 104 may identify that the medication which has just been scanned may create a potentially harmful reaction or side effects based on the patient's existing medications or drugs or condition, and may activate an alarm (visual, audible, or both) to indicate this possibility to the EMS technician 114. This alarm may be activated immediately, such that the EMS technician 114 is provided with adequate time to change the treatment plan during the time it takes to finish opening the medication packaging or preparing the medication for administration. A similar alarm may be activated if the current active crew member is not qualified or allowed to dispense the particular medication or treatment.

The BOA system 104 may also be configured to maintain an inventory of medications on board the vehicle 101 and the status of each dosage of medication. When the BOA system 104 receives the medication identification XML document indicating that a medication has been dispensed, the BOA system 104 may update the inventory to subtract the medication and/or dosage from the inventory (block 6710). At the end of a case, a shift, a day, a week, or other period of time, the BOA system 104 may be configured to transmit or display a list of medications used during the time period to permit restocking of the emergency vehicle. The BOA system 104 may also be configured to alert the crew if the inventory does not satisfy certain requirements, for example if the medication inventory is considered inadequate to begin a day or a shift, or if the medication inventory has been depleted enough to require the vehicle to be restocked before the next emergency response or other time period or event.

If the XML document received at block 6702 is not a medication identification, a determination is made whether the XML document is an intervention identification XML document (block 6712), and if so, the information about the specified intervention is added to the patient treatment record (block 6713). An intervention may be an action performed on or related to the patient. The bar codes for such interventions may be included on devices related to such intervention, or on one or more documents on the vehicle 101, the EMS technician 114, and/or a mobile device, according to embodiments of the present invention. For example, if a patient's blood pressure is taken with a manual blood pressure cuff, the scanner 117 may be used to scan a bar code mounted on the blood pressure cuff. In some cases, the BOA system 104 may be configured to prompt the user to request information based on a received bar code. For example, if a manual blood pressure bar code is received, the BOA system 104 prompts the user to enter the blood pressure observed. In some cases, best practices, or laws or regulations, or treatment protocols may call for the EMS technician 114 to check or verify certain patient status indications, for example at certain times or certain time intervals. For example, certain treatment protocols may call for an indication of whether the patient is conscious or not. The EMS technician 114 may scan one bar code to indicate that the patient is conscious, or another bar code to indicate that the patient is not conscious, or scan a single “consciousness” bar code and be prompted for the indication. According to embodiments of the present invention, the BOA system 104 activates an alarm each five minutes requiring the EMS technician 114 to scan either the conscious or the unconscious bar code. As another example, a bar code may be scanned to indicate that a breathing tube has been placed into the patient; alternatively, the breathing tube packaging may include a bar code thereon which, when scanned, indicates this type of intervention (and also updates the inventory listing for breathing tubes).

If the BOA system 104 does not recognize the XML document as a particular kind of identification, the BOA system 104 may simply attach the unknown XML document to the patient's record. This information may be used later, for example for billing purposes, according to embodiments of the present invention. Or if a particular medication includes more than one bar code, and the EMS technician 114 accidentally scans the wrong bar code, this bar code may be saved in the patient record and associated later with the particular medication or correct bar code.

FIG. 68 illustrates a flow chart 6800 describing a method for handling bar code image XML records received from the communications interface module 6404, according to embodiments of the present invention. An image-related XML document is received (block 6801). A determination is made whether the document is a signature image XML document (block 6802), and if so, the signature image is added to the patient's record (block 6803). The record created may also indicate an identification of a document to which the patient's signature has been applied, and/or content which the patient has signed. For example, a treatment provider may provide a patient with a standard consent of treatment form, which may have a symbol or other bar code at or near the signature block, so that a scan of the signature block also captures a unique document identification. This process may employ “signature capture” technology available from Symbol/Motorola, according to embodiments of the present invention. This permits the EMS technician 114 to scan just the signature and/or document ID portions and input them into the BOA system 104, for storage and/or use with other devices or applications. This saves disk space and also time. For example, if a hospital requires a consent form prior to admission, and if the ambulance crew transporting the patient to the hospital has obtained the patient's signature on the standard consent form, the ambulance crew may scan the patient's signature and send it to the hospital enterprise workstation 122 via network 120. This may help to minimize the delay experienced with paperwork upon arrival at the hospital, by preventing the EMS technician 114 from having to retain a physical copy of the document, make physical copies, and present the physical document to the hospital staff.

If the image-related XML document is not identified as a signature image document, a determination is made whether the image XML document is an insurance card image XML document (block 6804), and if so, the insurance card image is added to the patient's record (block 6805). The BOA system 104 may be configured to store only one insurance card image, such that each new insurance card image received replaces the previously stored image. According to some embodiments of the present invention, the BOA system 104 stores multiple insurance card images and permits the user or EMS technician 114 to choose the image of primary importance; this may permit the system to capture multiple insurance cards, and/or images of both the front and back of a particular insurance card, while also permitting the EMS technician 114 to determine which image should be stored (for example for billing purposes), and/or transmitted to the enterprise system 122 for facilitating hospital admissions, according to embodiments of the present invention.

If the image-related XML document is not identified as an insurance card image XML document, then the general image may be added to the patient's record (block 6806). For example, the EMS technician 114 may decide that a particular image is noteworthy, and may use the scanner 117 as a camera to capture an image relevant to patient care. For example, if the patient has a wound, the EMS technician 114 may take a picture of the wound with a 2D capable bar code scanner 117, which will then be added to the patient record. The wound image may then be accessed by or sent to the enterprise workstation 122 to permit the surgeon or emergency room physician to begin evaluating the wound, during the time the patient is being transported and before the patient has arrived at the surgical suite, according to embodiments of the present invention.

Bar code scanning may be used to input various information about the patient, crew, medications, interventions, and other information sources, into the BOA system 104, according to embodiments of the present invention. This information may also be accessed by an enterprise workstation 122, according to embodiments of the present invention. For example, application-specific messages may be sent from the BOA system 104 to an enterprise workstation 122 for display via a web interface. One example of such a message may include the information that the patient in Ambulance 7 is named John Doe, and may also include a picture of his insurance card. This information may permit a hospital admissions staff to begin the admissions process, according to embodiments of the present invention.

According to some embodiments of the present invention, the BOA system 104 periodically (e.g. each second, each minute) sends the current patient record, including any or all of the information items and images described herein, along with 12-lead data, vital sign information, geographic information, and/or other information to the enterprise storage server 126 and/or ultimately to an enterprise workstation 122 for access and/or display, for example via a web browser interface, according to embodiments of the present invention. The BOA system 104 may be configured to automatically update its display when items are added or updated in the patient record or event record, according to embodiments of the present invention. In addition to or instead of BOA system 104, other device or application may be configured to receive asynchronous bar code-related XML document events, in order to update their statue and/or modify a record, according to embodiments of the present invention.

In addition to the patient charting, inventory management, and crew management information facilitation, a bar code scanning system on an EMS vehicle may also be used in other ways. For example, each vehicle may include a bar code unique to that vehicle, and a medic may “check out” an ambulance at the beginning of a shift. For example, the medic may scan the bar code on the ambulance, then scan a crew ID bar code (e.g. on the medic's identification badge), to indicate that the ambulance is being checked out by the particular medic. At the end of a shift, the same process may be repeated to indicate that the particular ambulance is being returned. Or the ambulance may be checked out to another medic or crew member before it is returned to a facility, in a similar manner. Optional prompts may be used to confirm record changes; for example, when the ambulance bar code is scanned, the system may prompt the user to specify whether the ambulance is being checked out, returned, or checked out to another user. Bar code scanning may also facilitate routine inspection or other procedures; for example, at the beginning of a shift, a medic may scan a bar code on a drug cabinet to assert that it is locked, stocked, and/or ready for service, may scan a bar code on a jump kit to assert that it is stocked and ready for service, and/or may scan each backboard to assert the presence of a requisite number of them, according to embodiments of the present invention. Similarly, bar codes scanning may be used at other service points to verify that particular devices or conditions are adequate and/or safe.

Use of a bar code scanner to enter patient, crew, and object information into the BOA system 104 speeds up data entry, and gives an EMS technician more time and attention to focus on direct patient care. Bar code scans, including two-dimensional bar code scans, are easy to use and accurate. Although FIGS. 63-68 discuss use of a bar code scanner, one of ordinary skill in the art will appreciate, based on the disclosure provided herein, that similar processes may be used and similar results achieved with one or a combination of a bar code scanner, a magnetic card reader, digital camera, and/or radio frequency identification (RFID) reader. For example, many driver's licenses include a magnetic bar code portion which may be swiped with a magnetic card reader rather than or in addition to scanning the bar code with a bar code reader.

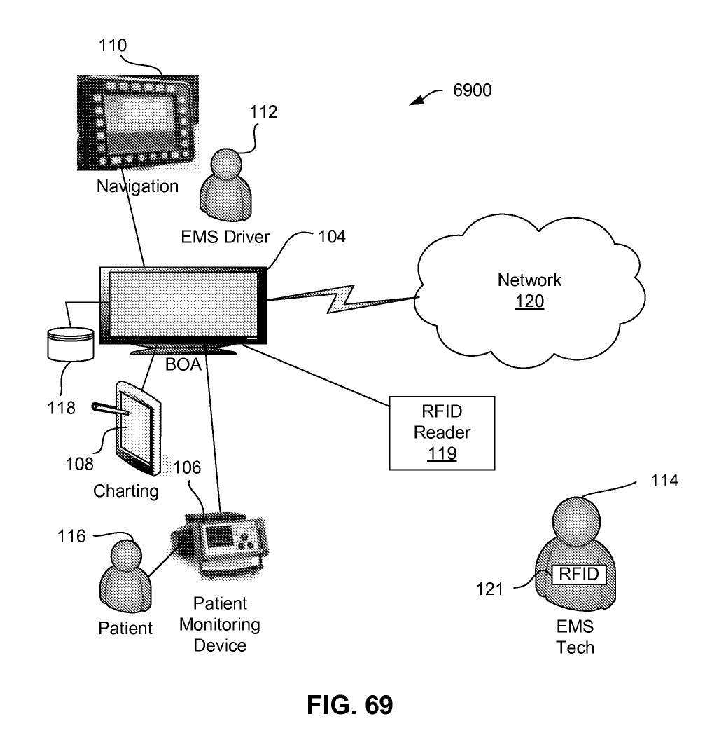

FIG. 69 illustrates a system 6900 for mobile and enterprise user collection and display of medical information collected from multiple different EMS devices, according to embodiments of the present invention. System 6900 is similar to system 100 of FIG. 1, and includes an RFID reader 119 communicably coupled with the BOA system 104, according to embodiments of the present invention. RFID reader 119 is configured to recognize and read one or more RFID tags 121, which may be carried by or worn by a crew member 114, according to embodiments of the present invention. Although RFID is discussed, other forms of electronic and/or wireless identification may be used, according to embodiments of the present invention. An employee, for example an EMS technician 114, may wear or carry an RFID tag 121 which contains the employee's name and/or a unique identification number associated with the employee. When the RFID tag 121 comes sufficiently close to the RFID reader 119, the RFID reader 119 detects the presence of RFID tag 121 along with a time stamp. This may occur when the employee enters or passes suitably close to a vehicle in which the RFID reader 119 is mounted, according to embodiments of the present invention. The RFID tag 121 may subsequently be used to identify the fact that the person wearing or carrying the RFID tag 121 was a crew member on board a particular vehicle, similar to the crew identification bar code information exchange discussed, above. This eliminates a manual log-in process for identifying crew members, according to embodiments of the present invention. As such, a crew member need not log in using a keyboard, and a crew member's presence in or near an EMS vehicle may be logged even if that crew member does not interact with the data management system in the vehicle at that time, according to embodiments of the present invention.

A crew tracking system may include two parts: a detectable device worn by an employee (e.g. tag 121), which may be an RFID tag, and a reader device 119 installed on the vehicle 101, which may be an RFID reader, according to embodiments of the present invention. The device 121 worn by the employee may be a passive device that may be detected by the reader 119, or an active device such as a transmitter which communicates with the reader 119. The reader 119 may be a receiver and/or transceiver, according to embodiments of the present invention. The reader device 119 passes employee presence information to the BOA system 104, which may then create a record containing the identity of the employee, the identity of the vehicle, and a time stamp; this record may be stored within the BOA system 104 and/or the enterprise storage server 126 for subsequent storage and/or display in various devices 106, 108, 110 and/or workstations 122 and/or reports generated by those devices.

In one example, at the scene of an EMS incident, a paramedic supervisor joins the regular crew of an ambulance 101 as they begin to transport a patient. The supervisor busily provides patient care, and therefore does not have time to log into the navigation device 110 using the keyboard and/or formally register as a crew member. At the hospital, he exits the vehicle and parts company with the regular crew. Without automatic crew detection, for example automatic crew detection with an RFID or other tag reader, the supervisor's presence may not ultimately be recorded in the trip documentation.

In another example, a volunteer firefighter drives his personal vehicle to the scene of a fire, where he joins the crew of an engine. Because a fire is being fought, the volunteer does not have time to register as a crew member, for example by climbing into the engine and logging into the navigation unit 110. With automatic crew detection, the volunteer firefighter's mere passage by or touching of the vehicle causes his presence to be noted by the BOA system 104. This provides a safety benefit, particularly in situations in which an accurate head count is needed for firefighter safety.

According to some embodiments of the present invention, the reader device 119 is a manual-type reader device which senses the presence of the crew tag 121 when the tag 121 is presented. For example, the manual-type reader device may be a card reader, and the tag 121 may be a card that is tapped onto, near, or swiped through the card reader, according to embodiments of the present invention. A confirmation step may be employed to avoid inadvertent registration of a person who passed by the vehicle but who did not become part of the vehicle's crew; for example, when the vehicle senses a new crew member by reading that crew member's tag 121, the BOA display 104 may present the user or another crew member with a dialog window. One example of such a prompt might be a yes or no selection in response to the following prompt: “This vehicle has identified Sally Smith as an occupant of this vehicle. Is this person a crew member on this vehicle?”

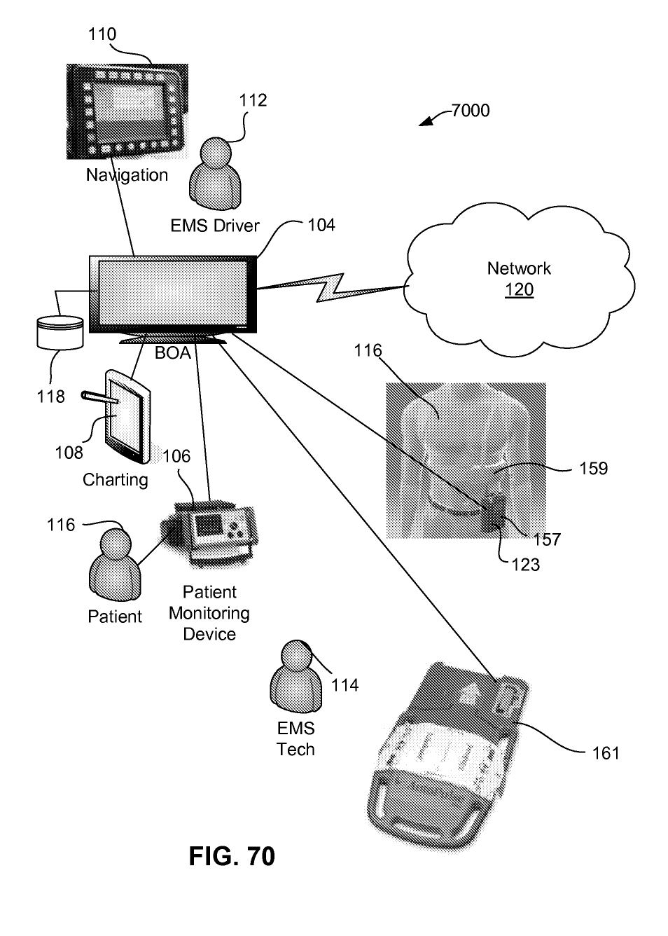

FIG. 70 illustrates a system 7000 similar to system 100, including a wearable cardioverter defibrillator (“WCD”) 157 and a non-invasive cardiac support pump (“NICSP”) 161, according to embodiments of the present invention. The WCD 157 may be, for example, a ZOLL® LifeVest® device. According to embodiments of the present invention, the WCD 157 may be a WCD as described in U.S. Pat. No. 4,928,690, granted May 29, 1990, and/or as described in U.S. Pat. No. 6,681,003, granted on Jan. 20, 2004, both of which are incorporated by reference herein in their entireties for all purposes. The NICSP may be, for example, a ZOLL® AutoPulse® non-invasive cardiac support pump device or LUCAS® chest compression system available from Physio Control™, or other portable mechanical chest compression device. The WCD 157 and/or NICSP 161 are communicably coupled with the BOA device 104, according to embodiments of the present invention.

The WCD 157 may include a sensor and/or electrode belt 159 configured to place one or more sensors and electrodes in contact with the patient, for example near the patient's heart. The WCD 157 may also include a computing device 123 communicably coupled with the electrode belt 159, and may be in the form of a control box worn on the patient's belt or hip, according to embodiments of the present invention. The computing device 123 may be a computer system similar to that described with respect to FIG. 18.

The WCD 157 is worn by the patient 116, and monitor's the patient's heart rhythm and function. When the WCD 157 determines that a treatable condition has occurred, for example when the patient enters cardiac arrest, the WCD 157 is configured to administer a defibrillating shock to the patient's heart. The WCD 157 may also include a power supply for this purpose. The WCD 157 may also be configured to supply a cardioversion signal to the patient. The WCD 157 monitors one or more patient conditions, including but not limited to: heart rate, twelve-lead or ECG data, therapy history, heart rate trends, heart rate variability trends, patient activity trends, body position trends, six-minute walk test data, heart sounds, blood oxygen content, respiration rate and/or amplitude, and/or background audio (e.g. for snore detection for sleep apnea monitoring). In addition, the WCD 157 monitors one or more device conditions, including but not limited to: battery status, defibrillator diagnostics, usage profiles, patient interaction with the device, and/or communication statistics. The WCD 157 may include a memory configured to store the monitored information about the patient conditions, as well as the information about the device, as well as other information about the patient, for example the patient's identity. Such information may be stored with a time stamp, according to embodiments of the present invention.

The WCD 157 thus contains a wealth of information about the patient's identity and medical history. Occasionally, patients 116 wearing WCDs 157 require emergency medical services (“EMS”), for example transport by ambulance to a hospital facility. In the EMS context, time is often of the essence, and EMS technicians 114 often have little attention to divert to operating devices or data entry. However, in the EMS context, the EMS technician 114 will often simply remove any WCD 157 which the patient is wearing and connect another system to the patient, for example a defibrillator 106. Embodiments of the present invention permit greater efficiency and better patient care by quickly or automatically downloading the wealth of patient information from the WCD 157, for example into BOA 104, according to embodiments of the present invention. This can save time by permitting the EMS technician 114 to skip some or all data entry steps. Also, although the wealth of patient information on the WCD 157 can often be used after a treatment incident to evaluate the patient's medical status (for example at the patient's next doctor's appointment) or to evaluate the performance of the device (for example at the device manufacturer monitoring event occurrences), such information is not available to the EMS technician 114 in current systems. Embodiments of the present invention permit the EMS technician 114 to benefit from this information during the actual EMS encounter.

According to some embodiments of the present invention, the WCD 157 is part of a patient monitoring network which is communicably coupled with network 120. This permits the BOA 104 system to communicate with the WCD 157 network, for example, permitting the BOA 104 system and its related devices to interface with the WCD 157 network while rescue personnel are in route to a patient. This may permit the BOA 104 device to receive information about a particular patient, including all of the information that WCD 157 can provide, before the rescue personnel are physically with the patient, according to embodiments of the present invention. Also, information and/or messages from BOA 104 may be sent to the WCD 157 network, for example to alert those medical professionals monitoring the long-term patient status that the patient has received emergency medical treatment, or has otherwise been the subject of a rescue attempt, according to embodiments of the present invention.

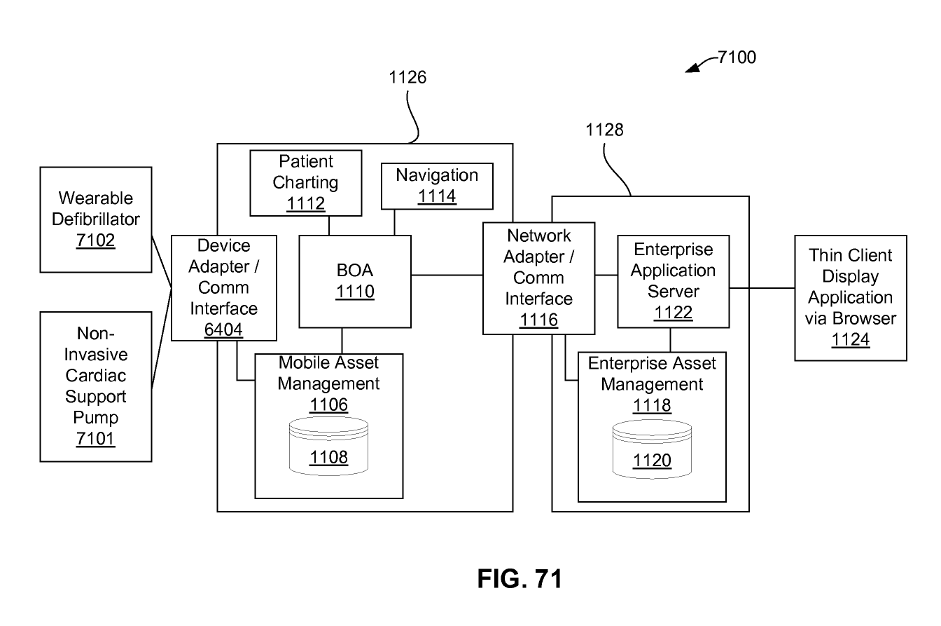

FIG. 71 illustrates a treatment domain system 7100 overview for real-time display of medical information collected from multiple different EMS devices, including a WCD and a NICSP, according to embodiments of the present invention. The various modules shown in FIG. 71 function or perform the same as or similarly to the corresponding modules of FIG. 11; specifically, FIG. 71 illustrates how such modules may perform in the context of a connection with a WCD and a NICSP. The software operating on the WCD 7102 and/or NICSP 7101 captures and sends patient data via a communicable coupling with mobile domain module 1126. The device adapter/communications interface module 6404 receives the data and arranges it into XML documents according to schemas based on the particular data type. The BOA module 1110 and/or mobile asset management module 1106 and/or patient charting module 1112, which may be subscribed to the particular communication interface 6404 or otherwise able to receive events or notifications based on the creation of particular patient data XML documents by the communications interface 6404, may receive the patient data XML documents and update patient records, system status, inventory records, intervention records, or otherwise store or transmit the patient data.

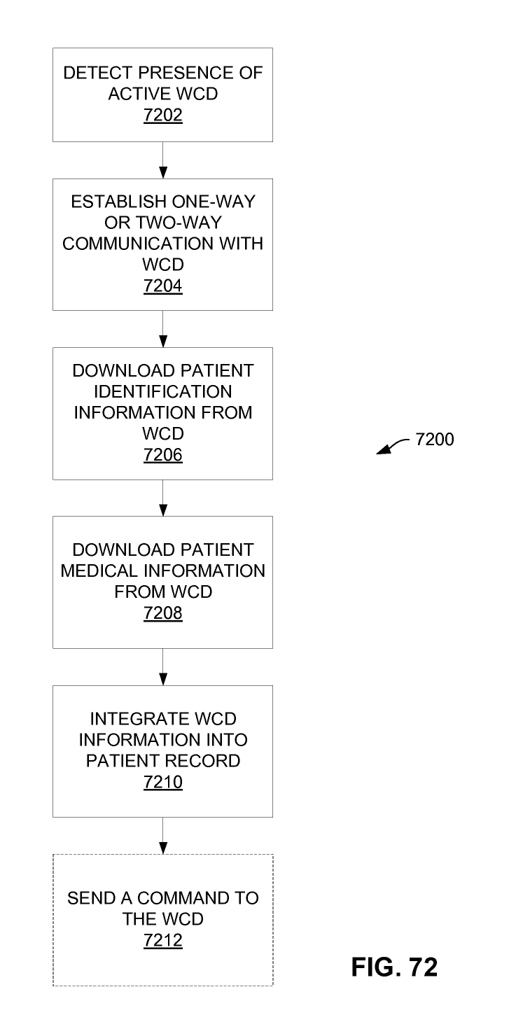

FIG. 72 depicts a flow chart 7200 illustrating a method for interfacing with the WCD 157, which may be performed, for example, by BOA 104, according to embodiments of the present invention. The presence of the WCD 157 is detected (block 7202). This may be accomplished, for example, using a device discovery process, for example a Bluetooth® device discovery protocol. A one-way or two-way communication may be established with the WCD 157 (block 7204). For example, this communication may be wireless, wired, or another form of communicable coupling. Communication may be established by connecting a cable to the WCD 157, in which case the presence of, and communication with, the WCD 157 would be established by the cable connection. One-way communication may be established by simply receiving data which the WCD 157 is already configured to send or which WCD 157 already sends. The communication with the WCD 157 may also be authenticated, to restrict the sharing of patient information to those devices and/or people who are permitted or approved to receive and/or use such information.

Also, the WCD 157 may have an independent connection to the network 120, either continuous or intermittent or periodically through manual interconnection. The wealth of patient information on the WCD 157 may, in addition to being wholly or partially stored locally to a memory on the WCD 157, may also wholly or partially be stored remotely, for example in a remote database 130. This remote database 130 may or may not be the same remote database 130 to which BOA 104 information is stored. Instead of, or in addition to, the BOA 104 connecting directly to the WCD 157 at the location of the EMS encounter (e.g. with a direct wireless connection), the BOA 104 may instead be configured to obtain the WCD 157 patient information from the remote database 130. For example, the BOA 104 may display an option on its user interface which permits the user to input the patient's name, identification number, and/or the serial number or other identifier on the WCD 157, and may then use such information to query and retrieve all relevant patient information gathered by the WCD 157 and stored on the remote database 130, according to embodiments of the present invention. According the some embodiments of the present invention, some patient information collected by or for the WCD 157 is obtained directly from the WCD 157 (e.g. recent patient information) and other patient information collected by or for the WCD 157 is obtained from remote database 130 (e.g. historical or archived patient information); this may happen particularly if the memory of the WCD 157 is smaller or more limited than the size of remote database 130, for example.

Patient identification information (block 7206) and/or patient medical information (block 7208) may be downloaded from the WCD 157, according to embodiments of the present invention. Patient identification information may include biographic and/or demographic and/or historical information about a patient, for example the patient's name, identification number, height, weight, race, and/or medical history, according to embodiments of the present invention. Because each WCD 157 may be customized and/or assigned to one individual patient 116, this information may be contained on the WCD 157 and/or stored remotely by an administrator of the WCD 157 or a healthcare provider or the like, for purposes related to monitoring the patient's health and treatment events.

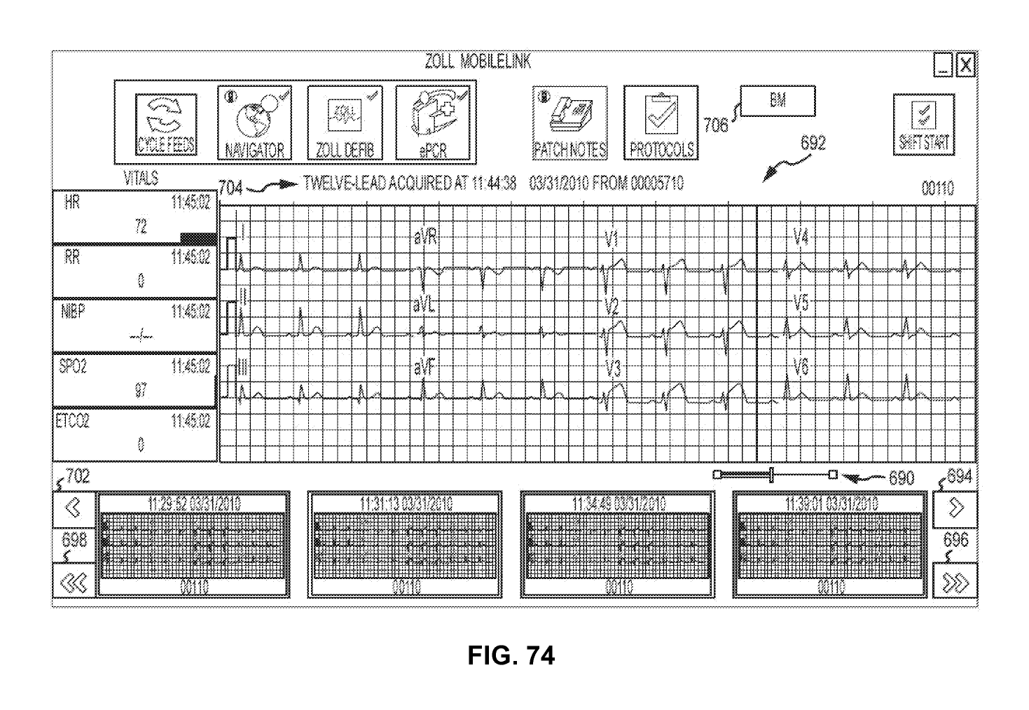

Medical information collected by the WCD 157 may include past and current medical information. Past medical information may include a length of time which the patient has worn the WCD 157, the number and type and date/time of the delivery of therapy or defibrillation pulses, twelve-lead or ECG snapshots or related data, heart rate over time, audio information, patient consciousness/unconsciousness time periods. This information may be helpful to the EMS technician 114 in an EMS encounter, and having such information automatically transfer, or easily transfer, to the BOA system 104 saves the data entry time, and permits this information to be used by the EMS technician 114 even if the patient is unconscious. Finally, the depth of information collected by the WCD 157 is such that it has the potential to be immensely helpful in the EMS treatment of the patient, but cannot be conveyed easily orally through questioning of the patient. One example would be the patient's twelve-lead or ECG snapshots over a period of time directly preceding the EMS encounter. As described below with respect to FIG. 74, the BOA system 104 may be configured to permit access to previous ECG snapshots of the patient over the EMS encounter. The BOA system 104 may be configured to capture the ECG snapshots from the WCD 157 and place them into the patient's record to permit easy access to them through the same interface, during the EMS encounter. The BOA system 104 may include a time marker indicating which information, for example ECG snapshots, were collected before the actual encounter. This also permits the EMS technician 114 to see what the patient's 116 normal heart rhythm looked like, for example for comparison purposes.

The WCD 157 may also transmit patient billing information, compliance information, and/or drug use information to the BOA system 104 and/or the patient charting system 108, according to embodiments of the present invention.

The BOA system 104 may also be configured to display, or to automatically process and adjust defibrillator parameters 106 based on, the defibrillation or pacing actions already taken by the WCD 157. For example, pulling such information from the WCD 157 permits the EMS technician 114 to see when the patient was administered shocks, and the energy level of the shocks. The EMS technician 114 could note, for example, that a first shock administered five minutes before the patient encounter was not powerful enough to correct the heart abnormality, but that a second shock administered by the WCD 157 shortly thereafter at a higher power was indeed successful. This will help the EMS technician 114 avoid a similar situation by alerting to the potential need to start with the higher delivery energy. In these ways, the patient information from the WCD 157 may be integrated into the patient's record in the BOA system 104 (block 7210), which includes patient and non-patient information from a variety of other devices.

The communicable coupling of the BOA system 104 with the WCD 157 also permits coordination of systems and of actions in a way that has previously not been possible. Removing the WCD 157 and/or connecting a patient 116 to a defibrillator 106 takes time. In addition to benefitting from a download of patient information from the WCD 157, the BOA system 104 may also be configured to connect with the WCD 157 and use the WCD 157 as a clinical monitoring and/or defibrillation device. For example, the BOA system 104 may be configured to connect with and display some or all available information about the patient 116 provided by the WCD 157 even before another patient monitoring/treatment device 106 has been connected to the patient 116. The BOA system 104 may also be configured to “seamlessly” switch from acquiring the patient data from the WCD 157 to acquiring the patient data from the other device 106 by determining when the other device 106 is ready to begin functioning. The BOA system 104 may be configured to provide a visual and/or auditory signal to the EMS technician 114 to switch off the WCD 157 and switch on the other device 106, according to embodiments of the present invention.

According to other embodiments of the present invention, the BOA system 104 has a two-way communication with the WCD 157, and is capable of sending a command to the WCD 157 (block 7212). According to such embodiments, the BOA system 104 may simultaneously, or closely in time, switch off the WCD 157 while switching on the other device 106. According to yet other embodiments, the WCD 157 and the other device 106 remain active on the patient at the same time, and the BOA system 104 receives the data from both devices 106, 157 and determines which data to track or display from each or tracks all data from each. According to yet other embodiments of the present invention, the BOA system 104 may also have two-way communication with WCD 157 in a way that permits the BOA system 104 and/or the other device 106 to administer defibrillation or other shocks via the WCD 157, controlled externally of the WCD 157. In this way, the software of the defibrillator 106 and/or BOA system 104 may be used to administer patient treatment even before another set of electrodes has been applied to the patient, if the patient is already wearing a WCD 157. In those situations, part of the information which the WCD 157 shares with the BOA system 104 includes information about the WCD 157 hardware and charge capacity. The WCD 157 electrical system may also have an energy input receptacle into which a cable may be plugged from another defibrillator device 106 which may be configured to deliver a higher energy therapy or to boost the energy of the pulse available from WCD 157. In this way, only a single set of electrodes need be applied to the patient, according to embodiments of the present invention. When both the WCD 157 and the defibrillator 106 are actively attached to the patient, the BOA system 104 may also be used to coordinate multi-vector shocks, to achieve uniformity of current density, according to embodiments of the present invention. The WCD 157 may also be configured to transmit information to the BOA system 104 about whether the electrodes are properly engaged with the patient, for example, whether one or more of the electrodes is not making proper contact for defibrillator energy delivery, according to embodiments of the present invention.

Although information from the WCD 157 is described as received by the BOA system 104, this information may also be received and/or used by other devices which are also communicably coupled to the BOA system 104 and/or to the WCD 157, according to embodiments of the present invention. For example, the patient information (identification and/or medical and/or other) may be populated into the patient charting system 108, so that the manual data entry is minimized. The patient charting system 108 may be further configured to indicate, for example by highlighting or outlining, the patient information fields which have not already been provided by the WCD 157. According to some embodiments, the patient charting system 108 indicates, for a particular field or set of fields, that the information has been downloaded from the WCD 157 and asks the EMS technician 114 for confirmation before accepting the information into the patient encounter record.

The NICSP 161 may be a portable battery-operated device which assists with chest compressions for a patient who has entered cardiac arrest, according to embodiments of the present invention. The NICSP 161 may include control electronics, for example in the form of a computer system, which control the performance of the NICSP 161 and which record data about the activities of the NICSP 161, for example the activities specific to a particular patient. The NICSP 161 may be used on a patient before and/or during an emergency medical response. When used before an EMS response, the BOA system 104 may communicably couple with the NICSP 161 and download patient information from the NICSP 161 for integration with the patient's encounter record and/or display to the EMS technician 114, for example via BOA display 104, according to embodiments of the present invention.

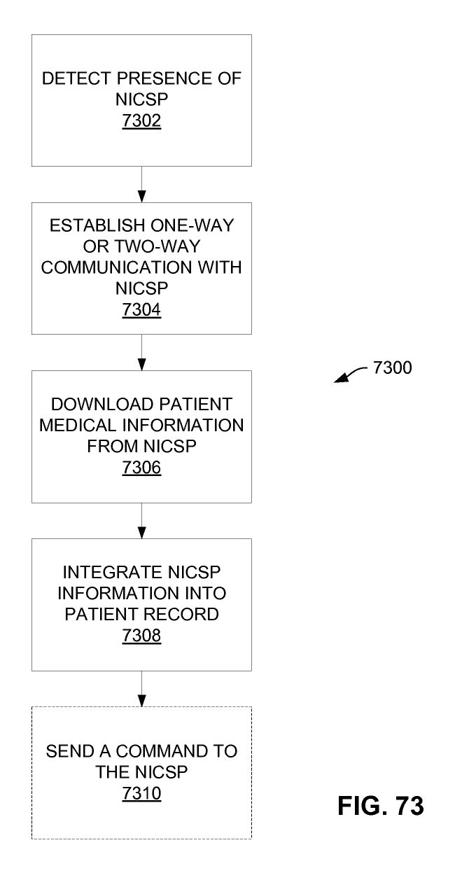

FIG. 73 depicts a flow chart 7300 illustrating a method for collecting information from an NICSP 161, according to embodiments of the present invention. The presence of the NICSP 161 is detected (block 7302). This may be accomplished, for example, using a device discovery process, for example a Bluetooth® device discovery protocol. A one-way or two-way communication may be established with the NICSP 161 (block 7304). For example, this communication may be wireless, wired, or another form of communicable coupling. Communication may be established by connecting a cable to the NICSP 161, in which case the presence of, and communication with, the NICSP 161 would be established by the cable connection. One-way communication may be established by simply receiving data which the NICSP 161 is already configured to send or which NICSP 161 already sends. The communication with the NICSP 161 may also be authenticated, to restrict the sharing of patient information to those devices and/or people who are permitted or approved to receive and/or use such information.

Also, the NICSP 161 may have an independent connection to the network 120, either continuous or intermittent or periodically through manual interconnection. The patient encounter information on the NICSP 161 may, in addition to being wholly or partially stored locally to a memory on the NICSP 161, may also wholly or partially be stored remotely, for example in a remote database 130. This remote database 130 may or may not be the same remote database 130 to which BOA 104 information is stored. Instead of, or in addition to, the BOA 104 connecting directly to the NICSP 161 at the location of the EMS encounter (e.g. with a direct wireless connection), the BOA 104 may instead be configured to obtain the NICSP 161 patient information from the remote database 130. For example, the BOA 104 may display an option on its user interface which permits the user to input the identification number and/or the serial number or other identifier on the NICSP 161, and may then use such information to query and retrieve all relevant patient information gathered by the NICSP 161 and stored on the remote database 130, according to embodiments of the present invention.

Patient medical information (block 7306) may be downloaded from the NICSP 161, according to embodiments of the present invention. Because each NICSP 161 may not be customized and/or assigned to one individual patient 116, the NICSP 161 will likely not include patient-specific information; however, the NICSP 161 may include encounter-specific patient medical information, according to embodiments of the present invention.

Medical information collected by the NICSP 161 may include past and current medical information. Past medical information may include a length of time which the NICSP 161 has been applying chest compressions to the patient, the number and type and date/time of the delivery of compressions, total number of compressions, total active time (e.g. in minutes and seconds), and/or total pause time (e.g. in minutes and seconds). This information may be helpful to the EMS technician 114 in an EMS encounter, and having such information automatically transfer, or easily transfer, to the BOA system 104 saves the data entry time, and permits this information to be used by the EMS technician 114 even if the patient has been unconscious for a long period of time. Finally, the depth of information collected by the NICSP 161 is such that it has the potential to be immensely helpful in the EMS treatment of the patient, but cannot be conveyed easily orally through questioning of the patient.

Other information may be downloaded from the NICSP 161. For example, information about the model number, serial number, configuration information, software version, manufacturer name, and/or manufacturer location of the NICSP 161 may be downloaded. In addition, battery information may be downloaded from the NICSP 161, for example the battery serial number, the number of charge cycles performed, and the remaining battery capacity (e.g. in hours and minutes or in percent of full or the like).

The BOA system 104 may also be configured to integrate the NICSP 161 information into the patient's EMS encounter record (block 7308), for example for later review of the code and/or for use in assessing the patient's condition during the EMS encounter. For example, the BOA system 104 may receive an indication from the NICSP 161 that the battery on the NICSP 161 is running low, and may in turn deliver an audio and/or visual alarm to the EMS technician 114, for example on the display device in the back of the ambulance, to notify the EMS technician 114 that it will soon be time to switch the battery for the NICSP 161, or to remove or disable the NICSP 161 and begin manual chest compressions, according to embodiments of the present invention. According to some embodiments of the present invention, the NICSP 161 provides data about an estimated time remaining on the current battery charge, and the BOA system 104 receives the data and compares the time remaining on the current battery charge with the time estimated to arrive at the current destination from the navigation system 110, and based on the comparison, provides a notification to the EMS technician 114 that the battery will likely need to be switched with a charged battery during the transport, and/or manual compressions will need to be started prior to arrival at the destination. This notification may also help the EMS technician 114 anticipate when the battery change will need to occur, so that manual chest compression can be arranged for the time during which the battery is switched, according to embodiments of the present invention. Such notification may be provided in the form of an alarm, for example a visual alarm or a sound. The sound may come from a device outside of the NICSP 161, for example from BOA system 104, and may be audible, according to embodiments of the present invention. A map of the transport route may be displayed, and a visual marker may be placed along the route at the estimated location at which the battery will need to be replaced in the NICSP 161, according to embodiments of the present invention. A visual display of an alert or fault experienced by NICSP 161 may be displayed in detail on the display portion of the BOA system 104, in a level of detail that may not be possible on the NICSP 161 screen, if any. Also, the BOA system 104 may be configured to monitor the performance of the NICSP 161 in clinical time, and/or during the EMS transport, and note in the patient record times during which the chest compressions were halted, for example when the battery was switched and re-initilization accomplished.

Some hospitals or other destinations may continue to use the same NICSP 161 after the patient has arrived; thus, the alarm or other warning system may take into account not only whether the battery has enough life to get the patient to the EMS destination, but also to continue operating for a certain amount of time after arrival, according to embodiments of the present invention. According to some embodiments of the present invention, the BOA system 104 and/or NICSP 161 only provide battery alerts if and when necessary, but do not otherwise distract the EMS technician 114 if no battery concern exits, using predicting alerting and/or reporting. A similar monitoring of power source may be accomplished for non-battery power sources, such as for example compressed gas, or the battery of a vehicle, according to embodiments of the present invention.

According to some embodiments of the present invention, other sensors are communicably coupled with the BOA system 104 whose data, when combined into calculations with the data from the NICSP 161, may provide visual or auditory information that is useful to the EMS technician 114 during the EMS encounter. For example, the BOA system 104 may further be communicably coupled with a skin color sensor connected to the patient 116 and configured to measure or indicate relative perfusion by indicating relative skin color. The BOA 104 may include a database showing a scale of relative skin colors and their perceived indication of perfusion rate; a more pale skin color may indicate a poor perfusion rate, while a warmer tone skin color may indicate a better perfusion rate. The BOA system 104 may also use such a skin tone sensor to compare skin color at two points in time to make a relative determination about whether the patient's perfusion is improving or getting worse, and/or to compare the patient's perfusion rate before the commencement of the treatment with the NICSP 161 to after the commencement of the treatment. Instead of or in addition to the skin color sensor, a blood flow monitor, such as a transducer that shows corotid/coronary blood flow, may be used to monitor perfusion rate or relative perfusion rate. This information may also be used to customize or improve the performance of the NICSP 161 based on the particular patient. The NICSP 161 has a certain number of modes of operation based on a certain number of assumptions and presets; when the NICSP 161 is communicably coupled with the BOA system 104, which is in turn communicably coupled with a variety of other devices providing information about the patient, such information may be used to improve or optimize the performance of the NICSP 161, for example by optimizing the timing and/or depth of chest compressions, according to embodiments of the present invention. The BOA device 104 may also be configured to display, and/or estimate, the amount of blood moved based on the observed or estimated perfusion rate, according to embodiments of the present invention.

Due to the limited amount of space and/or sophistication of the display screen on the NICSP 161, the BOA system 104 may be configured to provide more detailed instructions or explanations to the user, for example when a fault code is generated because the NICSP 161 is positioned improperly on the patient 116. Such error or fault codes or messages may also be automatically stored as part of the patient encounter record, rather than being stored only on the NICSP 161 for later manual download.

According to other embodiments of the present invention, the BOA system 104 has a two-way communication with the NICSP 161, and is capable of sending a command to the NICSP 161 (block 7310). According to such embodiments, the BOA system 104 may switch off or deactivate the NICSP 161 if the heart resumes beating or if a contraindicatory condition occurs. According to yet other embodiments of the present invention, the BOA system 104 may also have two-way communication with NICSP 161 in a way that permits the BOA system 104 and/or the other device 106 to control the mode of NICSP 161, externally of the NICSP 161. The BOA system 104 may also be configured to control not only the mode of the NICSP 161 (e.g. 30:2 or continuous), mute duration, and/or tone volume, but may also be configured to decide the duration, timing, and force/depth of the chest compressions provided by the NICSP 161 when communicably coupled.

According to some embodiments of the present invention, the back-of-ambulance environment also includes a charger for the NICSP 161 battery, and/or an extra battery for the NICSP 161, which are communicably coupled to the BOA system 104. The BOA system 104 may be configured to track battery performance information for one or more batteries, for example information about the last calibration cycle, the last full charge, and the degradation of the battery capacity or performance over time. According to some embodiments of the present invention, the patient 116 is wearing a WCD 157 and is placed into a NICSP 161, both of which are communicably coupled to BOA system 104. The BOA system 104 may, in such situations, coordinate the delivery of chest compressions with the delivery of any defibrillation shock, according to embodiments of the present invention.

The NICSP 161 may be a reusable device. According to some embodiments of the present invention, NICSP 161 provides real-time event data regarding chest compression information, including without limitation length of compression, depth of compression, force, and time data. In some cases, the NICS 161 may not store such performance data. In other cases, some or all of the data collected by the NICSP 161 may be stored on the NICSP 161 and/or transmitted to BOA 104, according to embodiments of the present invention. This includes performance data, battery performance data, software, and self-tests, according to embodiments of the present invention. When in use, the NICSP 161 may collect data about itself and its battery; the NICSP 161 may not in all cases have information about an identity of the patient, but it may be able to provide the chest compression information to another device (e.g. BOA 10) which does have information about the patient's identity, and an ability to combine the chest compression data with the patient identification data to create a patient record, according to embodiments of the present invention.

According to some embodiments of the present invention, the NICSP 161 includes an RFID chip or the like, and when the chip is moved into or near an ambulance, BOA 104 automatically recognizes its presence and connects to it. The NICSP 161 may, in some embodiments, include a GPS locator to track its position. In either case, the BOA 104 may be configured to verify the presence of NICSP 161 or any other device to which it is communicably coupled, and to alert the crew if the device goes out of range, or goes out of range for a particular period of time.

According to some embodiments of the present invention, the NICSP 161, though reusable, may employ certain durable medical equipment that must be replaced after each use or changed for each patient. For example, the NICSP 161 may include chest compression bands which are configured for one-time use. The NICSP 161 may include sensors to determine when such bands are removed and/or added, and/or to determine whether an added band has been used before, and to alert an EMS technician if the NICSP 161 needs new or additional chest compression bands, according to embodiments of the present invention.

The NICSP 161 may also include timing or clock circuitry, and the BOA 104 system may be configured to synchronize its clock with that of the NICSP 161, or otherwise compensate for any time differences between the two devices, in creating a master patient record, according to embodiments of the present invention.

The BOA interface 104 may be configured to display historical patient twelve-lead data, according to embodiments of the present invention. For example, if an EMS technician 114 is looking at a display of a patient's 12-lead ECG from ten seconds ago, the technician 114 may request to view each 12-lead ECG taken within the last ten minutes, or one 12-lead for each minute of the last ten minutes, in order to better understand how the patient's 12-lead portrayal has changed over that ten-minute period. FIG. 74 illustrates one example of a user interface that may be used to display snapshot 12-lead ECG data, according to embodiments of the present invention. According to some embodiments of the present invention, 12 leads are not continually streamed or provided, but are available when requested. For example, there may be one 12-lead for each minute if requested by the user.

This display may be displayed on BOA device 104, for example. The most recently acquired 12-lead portrayal is displayed in the main position 692, while previous 12-leads acquired in the past appear as smaller graphics or thumbnails along the bottom of the display, as illustrated in FIG. 74. In the example shown, the thumbnail for the more recently acquired 12-lead appears on the right, while each thumbnail toward the left represents successively earlier snapshots of the patient's 12-lead signal. According to some embodiments of the present invention, the thumbnails of historical 12-lead snapshots are themselves readable and legible on the display. According to some embodiments, when a user selects or touches or clicks on a 12-lead thumbnail image, the selected 12-lead is enlarged and displayed in the main position 692. In such cases, the display may be configured to indicate to the user that the currently displayed 12-lead image is not the most recently acquired; for example, the background color may change to red when a historical snapshot 12-lead is positioned in the main display 692, while changing back to gray or white when the most recently acquired 12-lead is positioned in the main display position 692. A time notification 704 may also be displayed to indicate the time and/or date of the currently displayed or currently enlarged 12-lead capture, according to embodiments of the present invention.

The buttons 694 and 702 may be pushed or selected in order to advance the line of thumbnails forward or backward in time, for example one by one, according to embodiments of the present invention. The double arrows button 696 may be pushed or activated in order to advance the line of thumbnails to show the most recently acquired 12-lead in the right-most position of the thumbnails, and the double arrows button 698 may be pushed or activated in order to advance the line of thumbnails to show the oldest acquired 12-lead (in the left-most position of the thumbnails), according to embodiments of the present invention. The double arrows 696, 698 may alternatively operate to transition data in a paged manner, such that pressing the double arrow buttons 696, 698 shifts the view to the next set of thumbnails (e.g. if four thumbnails are shown, the next page includes the next chronological set of four thumbnails). The thumbnails may also be arranged chronologically in the opposite direction.

The user interface may also include an input area permitting the user to specify the time frame over which the 12-lead thumbnails are displayed, or to otherwise sort or narrow the thumbnail display, according to embodiments of the present invention. For example, slider bar 690 may be adjusted left or right to augment or shrink the time period over which 12-lead thumbnails are displayed at the bottom of the screen. If the time period is increased, then the display may be refreshed to include additional 12-lead thumbnails corresponding to the time period (e.g. by shrinking the size of each thumbnail to fit more on the screen, and/or by adding additional rows of thumbnails), or the size of each thumbnail may remain the same but the system selects a representative thumbnail from periodic subsets of the total set of 12-leads satisfying the time criteria, according to embodiments of the present invention. Other filters for the 12-lead dataset may include a clinical event filter, or a user-requested filter. And although 12-lead snapshot datasets are illustrated, a similar display and user interface process may be employed for other sets of clinical and/or non-clinical data, according to embodiments of the present invention.

The display may also include a bookmark button 706 which permits a particular 12-lead representation to be flagged for later easy retrieval. In some embodiments, a thumbnail may be selected and dragged over to the bookmark button in order to bookmark the particular thumbnail. Another button (not shown) may permit the display to be filtered to show only bookmarked 12-lead images. According to some embodiments of the present invention, each 12-lead thumbnail display includes the date and time when it was recorded.

The display and user interface of FIG. 74 may also be available to an enterprise user 124 via an enterprise workstation 122, such that a doctor or other healthcare professional at a remote location (e.g. the hospital) can view thumbnails and historical clinical data for a patient while the patient is being transported and/or treated, for example via a web browser interface, prior to the patient arriving at the hospital. According to one embodiment of the present invention, the BOA device 104 screen and/or the enterprise workstation 122 may view more than one patient on the same screen, and/or tiled or split screens containing similar information for multiple patients, in order to track activity across the spectrum of units in service, and/or to handle a mass casualty situation.

In some embodiments, the BOA device 104 or other external device may query any 12-lead snapshot data set contained on the patient monitoring device, for example WCD 157, and subsequently process, sort, and/or filter the data. The same ECG data collected and/or displayed by BOA device 104 may also be collected and/or displayed remotely, for example via a web interface hosted by enterprise application server 128 and accessed by an enterprise workstation 122, for example at a hospital.

According to some embodiments of the present invention, the BOA 104 system permits one device to share the hardware of another device to perform certain functions. For example, the NICSP 161 may be configured to provide prompts on a display screen, but may not have an audio capability. The WCD 157 may have an audio capability, so the BOA system 104 may be configured to pass audio prompts from the NICSP 161 through to the WCD 157. For example, when the NICSP 161 has a low battery, an audio message or alert may be delivered by the WCD 157 to alert the EMS technician that the battery is low, according to embodiments of the present invention.

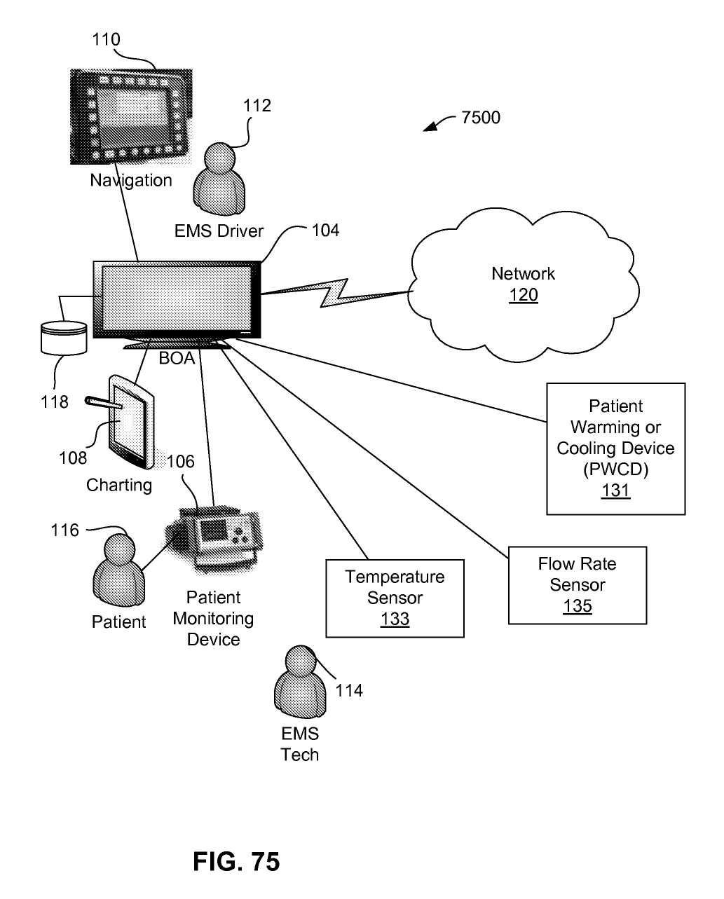

FIG. 75 illustrates a system 7500 similar to system 100, including a patient warming and/or cooling device (“PWCD”) 131 and a temperature sensing device 133, according to embodiments of the present invention. The PWCD 131 may be, for example, ZOLL® Power Infuser®, and/or an intravenous application of cooled fluid, such as saline. The temperature sensing device 133 may be a thermometer, digital thermometer, thermocouple, or other absolute or relative temperature sensing or measurement device, and may be external to the patient 116 or internal to the patient 116, according to embodiments of the present invention.

The PWCD 131 and temperature sensing device 133 are communicably coupled with the BOA device 104, according to embodiments of the present invention. The temperature sensing device 133 is configured to make temperature measurements of the patient 116 and convey them to the BOA system 104 and/or a device associated with the BOA system 104. Although one temperature device 133 is shown, multiple temperature devices 133, of the same or different kinds, may be used. For example, one temperature device 133 may be placed on the patient's head, and another temperature device 133 may be placed on an extremity of the patient, for example the patient's leg. One or more temperature devices may be placed in or near a patient's esophagus, and/or rectally, according to embodiments of the present invention. One or more temperature devices 133 may also be used to monitor non-patient temperatures. For example, a temperature sensing device may be located in a fluid supply reservoir or fluid supply line to measure a temperature of a fluid entering or exiting a patient, according to embodiments of the present invention. This information may be observed by the BOA system 104 and placed into the patient's encounter record, for example for use by a reviewer in looking at the procedures followed by the emergency medical response crew. Each temperature recorded may be associated with a particular time, to enable the patient record to indicate temperature profiles over the course of the encounter, and to display and/or compare the temperature information with other clinical and non-clinical information from the encounter. According to some embodiments of the present invention, the temperature device 133 is a simple sensor communicably coupled with the BOA system 104 or other device, which is configured to provide a basic signal from which the BOA 104 or other device then calculates or derives the temperature or relative temperature. According to other embodiments of the present invention, the temperature device 133 determines the temperature or relative temperature and sends a signal to the BOA 104 or other device representative of the temperature reading. According to some embodiments of the present invention, the BOA system 104 or other device receives the temperature readings and from the patient temperature readings estimates or derives or calculates a core temperature for the patient, which is also integrates into the patient encounter record.

For patients experiencing acute myocardial infarction (“AMI”), cooling of the patient's core temperature can provide numerous patient benefits. In an EMS setting, a patient who exhibits AMI may benefit from pre-hospital cooling, as it may be desirable to lower the patient's core temperature as early and rapidly as possible after the patient has been diagnosed with AMI. In order to administer pre-hospital cooling, an EMS technician 114 may apply a cooling system to the patient, for example a PWCD 131. As one example, a cooled or chilled bag of saline solution may be administered to the patient intravenously, and/or infused using a fluid resuscitation pump, in order to lower the patient's core temperature.

The BOA system 104 may be configured to track certain parameters related to the delivery of chilled solution to the patient, for example the time when the infusion began, the rate of infusion (for example, the volume per unit of time), and the core temperature of the patient over time and/or at particular points in time. These parameters may typically be manually downloaded from the PWCD 131 device to a computer after the encounter or after a group of encounters, but when the PWCD 131 is communicably coupled with the BOA system 104, these parameters may be downloaded and/or tracked in real-time, near real-time, and/or clinical time, and in any case during the EMS encounter, according to embodiments of the present invention. The relevant parameters may be monitored by the PWCD 131 and communicated to the BOA system 104, may be monitored by the BOA system 104 and optionally communicated to the PWCD 131, or a combination of both may be achieved. According to embodiments of the present invention, the BOA system 104 and/or PWCD 131 communicably coupled thereto monitor one or more of: a patient's core temperature, the power delivered to or removed from the patient and/or the patient cooling fluid, the rate at which the patient is cooled and/or warmed, and the mode of the patient cooling protocol (for example. warming, cooling, maintenance protocol). One or more of these factors may be programmed directly into the PWCD 131, for example by pressing buttons on the PWCD 131; alternatively, one or more of these factors may also or instead be input or selected using the BOA system 104, according to embodiments of the present invention.

The BOA system 104, and other devices communicably coupled thereto, for example the patient charting system 108, may also be used to receive data inputs, either automatically or manually, for integration into the patient's record. For example, a user may push a button or select an input on the BOA system 104 and/or patient charting system 108 to indicate that adjunctive surface cooling or warming has been applied and the time when such treatment was applied, for example the application of a warming blanket to warm the patient or a cooling blanket to cool the patient. According to some embodiments of the present invention which use a catheter for applying fluid to the body, the EMS technician 114 inputs the type and/or size of catheter used into the PWCD 131. This information may also help the PWCD 131 to calculate flow rate based on pressures, and also permits the BOA system 104 to note the catheter type in the encounter record for billing or code review, according to embodiments of the present invention. The type of cooling fluid may also be indicated, for example saline or other biocompatible fluid.

When the PWCD 131 (such as a fluid resuscitation pump) is in maintenance mode, the amount of power applied to the patient (for example the amount of power used to heat or cool the solution which is injected or circulated through the patient) is monitored over time. For example, in the case of therapeutic hypothermia, a higher power applied to the solution means that the patient is doing more to warm themselves, and a lower power applied to the solution means that the patient is doing less to warm themselves. This information may be displayed graphically in the BOA system 104 and/or noted in the patient record, in order to reflect the patient's responsiveness to the treatment, according to embodiments of the present invention.

The data from the patient's EMS encounter record related to a temperature management procedure may be compiled, along with relevant time stamps and device indicators and personnel indicators, into an EMS encounter record which may be reviewed at a later time to more closely evaluate how the patient was treated, how the EMS technicians 114 performed, and/or how the relevant equipment systems performed. According to some embodiments of the present invention, the BOA system 104 also notes the time at which the patient was picked up, and the time when a thermal marker was entered, or the time when a prehospital cooling or other temperature management procedure was commenced for the patient. This permits a person later reviewing the patient encounter record to see the length of time between patient contact and commencement of temperature management procedures. Information about a patient's EMS encounter record may be stored remotely, for example at enterprise database 130, and may be provided to users in one or more different formats, for example Microsoft® Excel® format, or in a format that is viewable by ZOLL® CodeNet®. According to some embodiments of the present invention, the EMS encounter record including temperature management data from the PWCD 131, the temperature sensing device(s) 133, and other clinical and non-clinical devices is transmitted to the hospital to which the patient has been transported, so that the health professional at the hospital can see the patient's core temperature history and the relevant time frames at which certain cooling or warming treatments were applied. The patient's EMS encounter record containing prehospital cooling data may also be combined or merged with the patient's hospital record containing hospital-based cooling data for a more comprehensive code review scenario, according to embodiments of the present invention. Because the BOA system 104 is communicably coupled with a variety of other clinical and nonclinical devices, the patient's EMS encounter record may also include data, over the same time frames, about navigation/location, and other information.

Although a fluid resuscitation pump and other patient warming and cooling devices are described, embodiments of the present invention may also include a nasal cooling system which may also track core temperature and other similar factors, for example a RhinoChill® system available from Benechill which includes a non-invasive nasal catheter that sprays a rapidly evaporating coolant liquid into the nasal cavity. Such a system may also be communicably coupled with the BOA system 104 in a similar fashion, permitting data collection, display, and/or exchange.

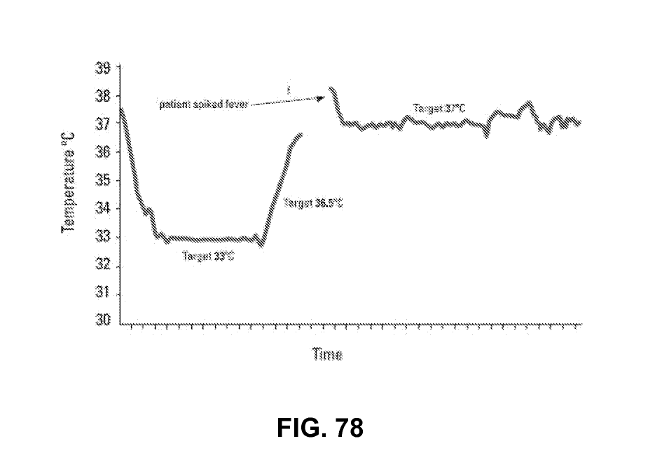

Data collected from other devices may also be incorporated into the patient's EMS encounter record, in particular the temperature management encounter record. For example, the time and dosage of anti-shivering or other medications administered to the patient may be entered and noted by the BOA system 104 and/or the patient charting system 108. Information in the patient's temperature management EMS encounter record may be plotted or graphed to indicate whether and how the various factors influenced one another, for example as shown in FIG. 78. FIG. 78 illustrates a graph of patient temperature over time, for a procedure in which the patient is warmed from a hypothermic state. The BOA system 104 may include predefined information that describes an ideal or target situation, for example a desired temperature profile for optimal therapeutic benefit. The desired temperature profile may also be referred to as a target temperature profile. During the EMS encounter, the BOA system 104 may display the desired core temperature profile along with the actual core temperature profile, for example side-by-side or superimposed one on the other, in order to give the EMS technicians 114 a better sense for how close the patient is to the desired therapeutic range, and to permit the EMS technician 114 to alter treatments as necessary to steer the patient closer to the desired temperature performance.

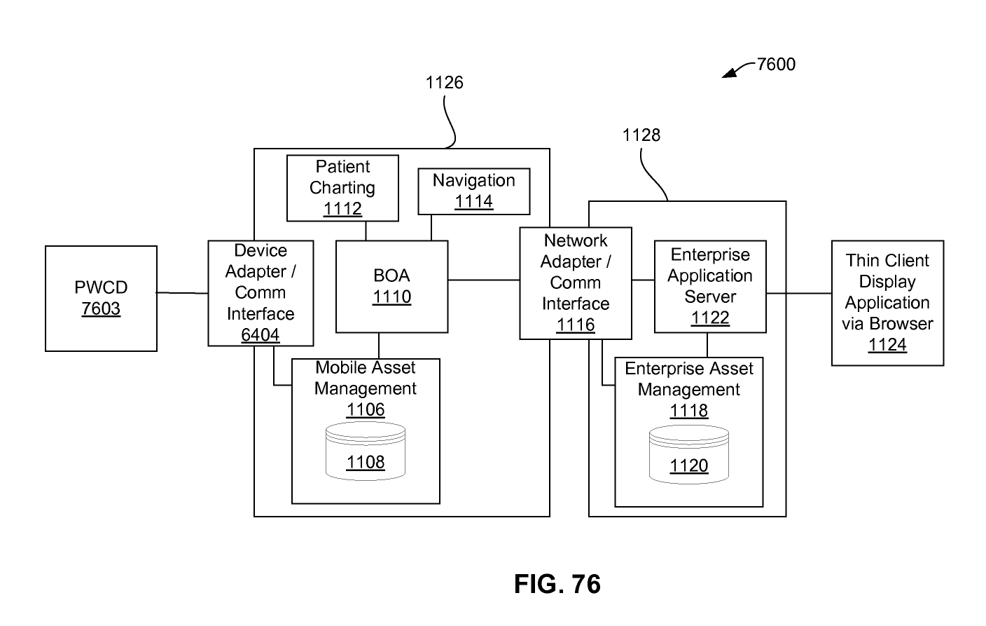

FIG. 76 illustrates a treatment domain system 7600 overview for real-time display of medical information collected from multiple different EMS devices, including an PWCD, according to embodiments of the present invention. Other examples of PWCDs which may be communicably coupled with the BOA system 104 include warming blankets with ability to transmit power settings, according to embodiments of the present invention. The various modules shown in FIG. 76 function or perform the same as or similarly to the corresponding modules of FIG. 11; specifically, FIG. 76 illustrates how such modules may perform in the context of a connection with a PWCD. The software or firmware operating on the PWCD 7603 captures and sends patient data via a communicable coupling with mobile domain module 1126. The device adapter/communications interface module 6404 receives the data and arranges it into XML documents according to schemas based on the particular data type. The BOA module 1110 and/or mobile asset management module 1106 and/or patient charting module 1112, which may be subscribed to the particular communication interface 6404 or otherwise able to receive events or notifications based on the creation of particular patient data XML documents by the communications interface 6404, may receive the patient data XML documents and update patient records, system status, inventory records, intervention records, or otherwise store or transmit the patient data.

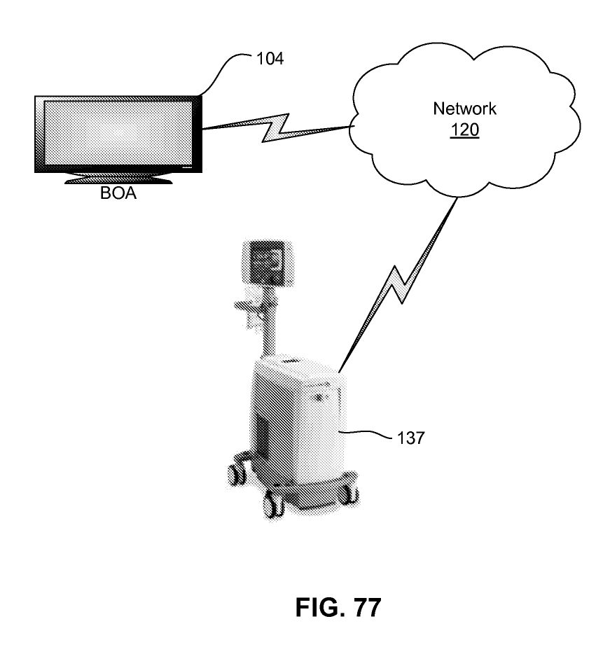

FIG. 77 illustrates the BOA system 104 communicably coupled, via network 120, with a hospital-based patient temperature management system 137. System 137 may be, for example a ZOLL® ThermoGard XP® system. System 137 may include characteristics of a patient temperature management system typically found in a catheter lab at a hospital, according to embodiments of the present invention. Hence, while system 137 may be able to better monitor the patient, cool or warm the patient, and gather additional patient data points in the temperature management process, system 137 may be too large to practically fit into the back of an ambulance.

Systems such as system 137 typically take time to initialize and to come to the correct temperature for treatment. And time is typically of the essence. According to some embodiments of the present invention, when a particular condition is diagnosed or predicted in the EMS setting, for example using BOA system 104 in the back of an ambulance, the BOA system 104 sends a notification to the remote temperature management system 137 at the destination so that the remote operators know to turn on the system 137. This notification may be in the form of an alarm, for example a visual and/or auditory alarm. This notification may alternatively or additionally be sent via the enterprise workstation 122, according to embodiments of the present invention. According to other embodiments of the present invention, the BOA system 104, based on a diagnosis or prediction of a particular condition that may benefit from hospital-based cooling, sends a command to the system 137 causing the system 137 to automatically begin its startup process. According to some embodiments of the present invention, the BOA system 104 identifies two or more possible destinations based on the navigation system 110, and sends the notification or startup command to systems 137 in two or more different destinations. When one of the two or more destinations is identified as the actual destination, the BOA system 104 may send a notification or command to the other systems 137 causing them to power down.

According to some embodiments of the present invention, setting up the system 137 for use involves not only turning it on, but also connecting various tubing and/or catheters, plugging in various sensors, and/or preparing other patient interface hardware. The BOA system 104 may also be configured to send a message or create an alert or alarm for the nurses at the hospital who typically set up and initialize system 137, to let them know to begin the system setup, and/or to give them a future time at which to begin system setup, according to embodiments of the present invention. According to some embodiments of the present invention, the particular system 137 which is intended to be activated is caused by a message from BOA 104 to emit an audible and/or visual signal to alert the hospital staff that a patient is soon arriving who will need the system 137, according to embodiments of the present invention.

According to some embodiments of the present invention, patients who have undergone trauma may be subjected to warming procedures, for example before, during, and/or after their emergency vehicle transport. Such warming may help to prevent hypothermia. If the patient exhibits Acute Myocardial Infarction (AMI) or cardiac arrest symptoms, the patient may benefit from cooling. If the patient has had a heart attack, then the patient may benefit from cooling as soon and as rapidly as possible. Other physiological indicators (e.g. blood pressure) may be interpreted, for example by BOA device 104, to help indicate that a patient is ready for cooling or maximum cooling, even during the transport, according to embodiments of the present invention. When a prehospital cooling or warming protocol is followed before or during patient transport, the BOA system 104 stores the information about the prehospital cooling or warming procedure and transmits it to the larger scale and more sophisticated system 137 in the hospital, according to embodiments of the present invention.

According to some embodiments of the present invention, the BOA system 104 determines, for example using the information from navigation system 110, the expected arrival time at the hospital. The BOA 104 then sends the command to the hospital cooling system 137 to begin its initialization and initial cool down procedures. This command may also include a timer, for example an electronic or software-based timer, to delay the initialization and startup of system 137 until a time for which the system 137 is fully ready to go at a time closer to when the patient is scheduled to arrive. This may help prevent energy waste, according to embodiments of the present invention. Such timer may also be remote, for example provided by BOA device 104 and/or a remote administration server.

The particular conditions that may trigger such a notification and/or startup command for a remote cooling device may be, without limitation, a traumatic brain injury, stroke, AMI, spinal injury, and/or cardiac arrest. The particular conditions that may trigger such a notification and/or startup command for a remote warming device may be, without limitation, severe trauma and/or burning. If prehospital cooling or warming is performed on the patient 116, then the patient's EMS encounter record including temperature management information may be loaded directly onto a particular system 137 at the hospital, so that the treating physician or other clinician may view the patient's core temperature history directly on the system 137, and/or so that the patient's encounter record is integrated to include prehospital and in-hospital cooling and subsequent warming data.

According to some embodiments of the present invention, the BOA system 104 sends to remote cooling system 137 an identification of the type of catheter placed into the patient, and receives from system 137 an indication regarding whether the particular catheter is compatible with the system 137. Upon a positive indication, then the BOA system 104 may alert the EMS technicians 114 to leave the catheter in the patient for subsequent hookup to the system 137. Based on information entered into and/or observed by BOA 104, for example the particular diagnosis or event in the field, BOA 104 may recommend the catheter for use with the patient when the patient arrives at the hospital, according to embodiments of the present invention. For example, in the case of patient with acute myocardial infarction, the BOA system 104 may recommend a Quattro® catheter available from ZOLL Medical Corporation. As another example, in the case of a burn victim, the BOA system 104 may recommend a Cool Line® available from ZOLL Medical Corporation. Such a recommendation may also be communicated from BOA 104 to the remote warming or cooling system 137.

According to embodiments of the present invention, when the PWCD 131 is a fluid resuscitation pump, such as a ZOLL® Power Infuser®, or any other device which moves fluid into and/or out of the body or cooling or warming blanket or other device, the BOA 104 may also be communicably coupled to one or more flow rate sensors 135, as shown in FIG. 75. The one or more flow rate sensors may measure an input flow rate (e.g. to the body or to a device), and/or an output flow rate (e.g. out of the body or the device). Similarly, multiple temperature sensors may be employed by BOA 104 to sense and record the temperature of the patient or various body areas of the patient or the patient's bodily fluids, and/or of fluids or heat transfer elements of cooling or warming devices, according to embodiments of the present invention. According to embodiments of the present invention, the BOA 104 measures some or all performance characteristics of PWCD 131 or of multiple PWCDs 131, including but not limited to temperatures, flow rates, power consumption, operation time, and other parameters. Temperature sensing devices 133 may be placed internally, externally, or both internally and externally to the patient 116, according to embodiments of the present invention.

As described above, PWCD 131 may be an intravenous temperature management device; as such, PWCD 131 may be a intravenous injection of cold or chilled saline solution or other biocompatible fluid, or PWCD 131 may be a portable intravenous temperature management device such as a closed loop system which circulates temperature controlled solution through the body, for example through or near a blood vessel, or PWCD 131 may be a device that infuses cooled saline into the body, for example at a higher infusion rate than normally possible with a simple saline intravenous drip, according to embodiments of the present invention. PWCD 131 may also be an external cooling or warming device, for example a warming blanket or pad or cooling blanket or pad for adjunctive surface warming. For all such PWCDs 131, BOA 104 is configured to monitor their performance characteristics and relate those performance characteristics to other patient clinical and non-clinical data, to improve patient treatment and data management, according to embodiments of the present invention.

Various features and/or characteristics are described herein. Even if not expressly described herein, an embodiment of the present invention may include one or a combination of two or more such features and/or characteristics, in any such combination and/or configuration as would be apparent to one of ordinary skill in the art, based on the present disclosure. For example, elements which are shown or described as being able to communicably couple with other elements may also exchange data and/or control signals with other elements which are also able to communicably couple, even if such particular communicable coupling is not expressly discussed herein, as would be apparent to one of ordinary skill in the art based on the present disclosure. For example, a scanner 117 and a WCD 157 may both be communicably coupled to the BOA 104 at the same time, and the BOA 104 may correlate and store data from both devices 117, 157 in the same patient or encounter record, for example to receive an identification of a patient from scanner 117 and correlate it with a patient's heart rate from the WCD 157 according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for collecting and displaying emergency medical services information, the system comprising:
an information system located in an emergency response vehicle, the information system comprising at least one display device, at least one processor, and at least one database, wherein the information system is configured to maintain an encounter record for a particular patient transported by the emergency response vehicle;
a bar code scanner communicably coupled to the information system;
wherein the processor is configured to receive bar code information from the bar code scanner, and update the encounter record based on the bar code information.

2. The system of claim 1, wherein the bar code information is driver's license bar code information from a driver's license of the patient, and wherein the processor is configured to update the encounter record with an identification of the patient based on the driver's license bar code information.

3. The system of claim 1, wherein the bar code information is crew identification bar code information, and wherein the processor is configured to update the encounter record with an identification of a crew member based on the crew identification bar code information.

4. The system of claim 1, wherein information system is further configured to maintain an active crew list for the emergency response vehicle, wherein the bar code information is crew identification bar code information, and wherein the processor is further configured to update the active crew list by adding a new crew member to the active crew list based on the crew identification bar code information.

5. The system of claim 4, wherein the processor is further configured to set the new crew member as the currently active crew member for future interventions recorded by the information system for the encounter record.

6. The system of claim 1, wherein the bar code information is medication identification bar code information, and wherein the processor is configured to update the encounter record with an identification of a medication based on the crew identification bar code information.

7. The system of claim 6, wherein the information system is further configured to maintain a medication inventory record, and wherein the processor is further configured to update the medication inventory record based on the medication identification bar code information.

8. The system of claim 1, wherein the bar code information is intervention identification bar code information, and wherein the processor is configured to update the encounter record with an identification of an intervention based on the intervention identification bar code information.

9. The system of claim 1, wherein the bar code scanner is a two-dimensional bar code scanner.

10. The system of claim 9, wherein the bar code scanner is configured to capture and transmit to the processor an image of a signature on a document, and wherein the processor is further configured to add the image of the signature to the encounter record.

11. The system of claim 10, wherein the processor is further configured to add an identification of the document to the encounter record along with the image of the signature that is associated with the document.

12. The system of claim 9, wherein the bar code scanner is configured to capture and transmit to the processor an image of an insurance card of a patient, and wherein the processor is further configured to add the image of the insurance card of the patient to the encounter record.

13. The system of claim 1, wherein some or all of the encounter record is stored on a stationary server remote from the emergency response vehicle.

14. A method for collecting and displaying emergency medical services information, the method comprising:
mounting an information system in an emergency response vehicle, the information system comprising at least one display device, at least one processor, and at least one database;
maintaining an encounter record for a particular patient transported by the emergency response vehicle;
communicably coupling a bar code scanner to the information system;
receiving bar code information from the bar code scanner; and
updating the encounter record based on the bar code information.

15. The method of claim 14, wherein the bar code information is driver's license bar code information from a driver's license of the patient, and wherein updating the encounter record comprises updating the encounter record with an identification of the patient based on the driver's license bar code information.

16. The method of claim 14, wherein the bar code information is crew identification bar code information, and wherein updating the encounter record comprises updating the encounter record with an identification of a crew member based on the crew identification bar code information.

17. The method of claim 14, further comprising maintaining an active crew list for the emergency response vehicle, wherein the bar code information is crew identification bar code information, the method further comprising updating the active crew list by adding a new crew member to the active crew list based on the crew identification bar code information.

18. The method of claim 17, further comprising setting the new crew member as the currently active crew member for future interventions recorded by the information system for the encounter record.

19. The method of claim 14, wherein the bar code information is medication identification bar code information, and wherein updating the encounter record comprises updating the encounter record with an identification of a medication based on the crew identification bar code information.

20. The system of claim 19, further comprising maintaining a medication inventory record, the method further comprising updating the medication inventory record based on the medication identification bar code information.

21. The method of claim 14, wherein the bar code information is intervention identification bar code information, and updating the encounter record comprises updating the encounter record with an identification of an intervention based on the intervention identification bar code information.

22. The method of claim 14, wherein the bar code scanner is a two-dimensional bar code scanner.

23. The method of claim 22, further comprising capturing and transmitting to the processor an image of a signature on a document, and wherein updating the encounter record comprises adding the image of the signature to the encounter record.

24. The method of claim 23, further comprising adding an identification of the document to the encounter record along with the image of the signature that is associated with the document.

25. The method of claim 14, further comprising capturing and transmitting to the processor an image of an insurance card of a patient, and wherein updating the encounter record comprises adding the image of the insurance card of the patient to the encounter record.

26. The method of claim 14, further comprising storing some or all of the encounter record on a stationary server remote from the emergency response vehicle.

27. A system for collecting and displaying emergency medical services information, the system comprising:
an information system located in an emergency response vehicle, the information system comprising at least one display device, at least one processor, and at least one database, wherein the information system is configured to maintain an active crew list for a particular emergency response vehicle;
an identification reader communicably coupled to the information system, wherein the identification reader is configured to automatically sense the presence of a crew identification device;
wherein the processor is configured to receive crew identification information from the identification reader in the presence of the crew identification device, and automatically update the active crew list based on the crew identification information.

28. The system of claim 27, wherein the identification reader is an RFID reader.

29. The system of claim 28, further comprising an RFID tag worn by a potential crew member, wherein the RFID tag is the crew identification device.

30. The system of claim 27, wherein the processor is further configured to prompt a user for confirmation to proceed with automatically updating the active crew list based on the crew identification information.
